(19) United States
(12) Patent Application Publication
(10) Pub. No.: US 2015/0114257 A1
(43) Pub. Date: Apr. 30, 2015

(54) METHOD OF PREPARING RETARDATION FILM, POLARIZING PLATE, AND LIQUID CRYSTAL DISPLAY

(71) Applicant: Konica Minolta, Inc., Tokyo (JP)

(72) Inventor: Takahiro Takagi, Kanagawa (JP)

(21) Appl. No.: 14/398,311

(22) PCT Filed: Apr. 26, 2013
(86) PCT No.: PCT/JP2013/062334

§ 371 Date: Oct. 31, 2014

(30) Foreign Application Priority Data
May 1, 2012 (JP) 2012-104351

(51) Int. Cl. G02F 1/13363; C08K 5/13; C08K 5/3492; C08K 5/132; B29D 11/00; C08K 5/45

(52) U.S. Cl. CPC G02F 1/13363; B29D 11/00788; C08K 5/45; C08K 5/3492; C08K 5/132; C08K 5/13; B29K 2001/12
USPC 106/170.1; 264/1.34; 106/170.14; 106/170.48; 106/171.1

(57) ABSTRACT

A method of preparing a retardation film includes cellulose acetate having an average degree of acetylation of 2.0 to 2.5 and having a moisture content of 1.0 mass % or less, where the retardation film includes a compound having a Van der Waals volume of 450 to 1000 Å3. The retardation film is prepared by a dope preparing step of dissolving cellulose acetate having an average degree of acetylation within the range of 2.0 to 2.5 to prepare a dope; a film product forming step of casting the dope onto a metal belt to form a film product; a film product peeling step of peeling off the film product from the metal belt; a drawing step of drawing the peeled film product; and a drying step at a drying temperature of 140° C. or more.

### TECHNICAL FIELD

Embodiments of the invention relate to a method of preparing a retardation film, and a polarizing plate and a liquid crystal display, each including a retardation film prepared by the method.

### BACKGROUND

Presently, liquid crystal displays, such as TV sets and personal computer monitors, are each provided with a retardation film having a specific retardation value (hereinafter also referred to as an R value) and a combination of retardation films to improve angular dependency of hue and front contrast.

Retardation films are, as known, prepared from synthetic polymers or cellulose ester. Among these, the surfaces of films prepared from cellulose ester can be saponified and hydrophilicized by immersing the surface of the film in an alkaline aqueous solution. Such hydrophilicized films can be directly bonded to a polarizer mainly composed of poly(vinyl alcohol). For this advantage, the films prepared from cellulose ester are extensively used as a film for a polarizer having retardation compensation function (hereinafter referred to as a retardation film).

When such a retardation film prepared from cellulose ester contains cellulose acetate as a main raw material, it is known that the optical characteristics of the film depend on the degree of acetylation of cellulose acetate. Especially, cellulose acetate having a low degree of acetylation has high natural birefringence, which leads to an idea that a reduction in the degree of acetylation can attain superior optical characteristics appropriate to a retardation film of a vertical alignment (VA) type.

A polarizer including the retardation film bonded thereto is incorporated into a liquid crystal display together with a liquid crystal cell. The retardation film is disposed between the polarizer and the liquid crystal cell. In such an arrangement, the optical characteristics of the film give significant influences on angular dependency of hue (color shift) and front and angular contrasts of the liquid crystal display. Lately, a wider viewing angle and higher resolution of liquid crystal displays require further improvements in retardation compensation characteristics of the retardation film.

The retardation film also must have optical characteristics stable in various environmental changes. For example, the retardation value undesirably reduces due to various environmental changes after production of the retardation films. Patent Document 1 discloses a transparent protective film, an optical compensation film, and a polarizing plate comprising a compound having a plurality of specific functional groups to reduce a fluctuation in retardation due to changes in humidity in environments for usage.

A retardation film having further enhanced retardation compensation characteristics and stability to environmental changes has been desired because of requirements for higher quality of the retardation film.

### PRIOR ART DOCUMENT

### Patent Document

### Patent Document 1: Japanese Patent Application Laid-Open Publication No. 2008-89860

### SUMMARY OF INVENTION

Embodiments of the claimed invention provide a method of preparing a retardation film having superior retardation characteristics and high moisture resistance. One or more embodiments of the invention may provide a polarizing plate comprising the retardation film, and a liquid crystal display comprising the retardation film and having small color shift and high contrast.

The inventor has found a significant reduction in the retardation value of a retardation film prepared from cellulose acetate having a low degree of acetylation after production of the retardation film, has discovered that a retardation film having a moisture content of 1.0 mass % or less, comprising a compound having a Van der Waals volume of 450 to 1000 Å³, and prepared by solution casting cellulose acetate having a high moisture content, and then drying the product at 140° C. or more in a drying step may result in a retardation film having superior retardation characteristics and high moisture resistance.

The advantages of one or more embodiments of the invention may be achieved by the following aspects.

In one aspect, embodiments of the invention relate to a method of preparing a retardation film that includes cellulose acetate having an average degree of acetylation of 2.0 to 2.5 and having a moisture content of 1.0 mass % or less, where the retardation film further includes a compound having a Van der Waals volume of 450 to 1000 Å³. The retardation film is prepared through at least the following five steps.

The first step is a dope preparing step of dissolving cellulose acetate having an average degree of acetylation within the range of 2.0 to 2.5 to prepare a dope and having a moisture content of 3.0% or more in an organic solvent containing 90 mass % or more halogen organic solvent.

The second step is a film product forming step of casting the dope onto a metal belt to form a film product.

The third step is a film product peeling step of peeling off the film product from the metal belt.

The fourth step is a drawing step of drawing the peeled film product.

The fifth step is a drying step at a drying temperature of 140° C. or more.

In one or more embodiments of the invention, the retardation film has a ratio Rt(b)/Rt(a) within the range of 0.3 to 0.8, where Rt(a) is the absolute value of a difference between a retardation value Rt₁ across the thickness of the film product after the film product is left at 23° C. and 55% RH for 24 hours after termination of the fifth step and a retardation value Rt₂ across the thickness of the film product after the film product is subsequently left at 60° C. and 90% RH for 500 hours, and Rt(b) is the absolute value of a difference between the retardation value Rt₁ across the thickness of the film product after the film product is left at 23° C. and 55% RH for 24 hours after termination of the fifth step and a retardation value Rt₃ across the thickness of the film product after the film product is subsequently left at 23° C. and 55% RH for 500 hours.

In one or more embodiments of the invention, the retardation film contains 5 to 10 mass % compound having a Van der Waals volume of 450 to 1000 Å³ relative to the cellulose acetate.

In one or more embodiments of the invention, the compound having a Van der Waals volume of 450 to 1000 Å³ is at least one compound represented by Formulae (I) to (IV):

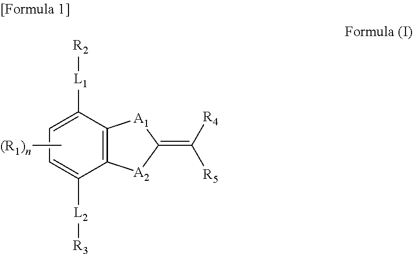

where L₁ and L₂ each represent a single bond or a divalent linking group; A₁ and A₂ represent a group each independently selected from —O—, —NR— (where R represents a hydrogen atom or a substituent), —S—, and —CO—; R₁, R₂, R₃, R₄, and R₅ each represent a substituent; n represents an integer of 0 to 2;

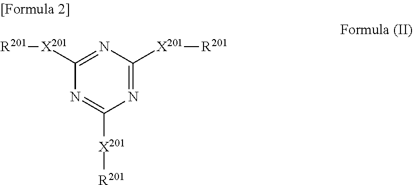

where three R²⁰¹'s each independently represent an aromatic ring or heterocycle having a substituent at at least one of ortho-, meta-, and para-positions; three X²⁰¹'s each independently represent a single bond or NR²⁰²—; three R²⁰²'s each independently represent a hydrogen atom or a substituted or =substituted alkyl, alkenyl, aryl, or heterocyclic group;

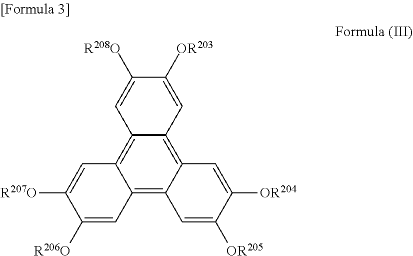

where R²⁰³ to R²⁰⁸ each independently represent a hydrogen atom or a substituent; and

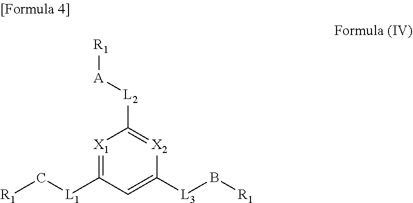

where A, B, and C represent an aryl or heteroaryl ring; L₁, L₂, and L₃ represent a bond or a divalent linking group selected from an alkylene group, —COO—, —NR₂—, —OCO—, —OCOO—, —O—, —S—, —NHCO—, and —CONH—; X₁ and X₂ represent a carbon atom or a nitrogen atom; R₁ represents a substituent; R₂ represents a hydrogen atom or a substituent.

In one or more embodiments of the invention, the retardation film is a long retardation film having a width of 700 to 3000 mm.

Embodiments of the invention may include a polarizing plate comprising a retardation film prepared in accordance with one or more embodiments of the invention.

Embodiments of the invention may include a liquid crystal display comprising a retardation film prepared in accordance with one or more embodiments of the invention.

A method of preparing a retardation film having superior retardation characteristics and high moisture resistance can be attained. A polarizing plate comprising the retardation film, and a liquid crystal display comprising the retardation film and having small color shift and high contrast can also be attained.

A mechanism to demonstrate the effect of embodiments of the invention or act according to one or more embodiments of the invention, although unclear, is presumed as follows. Cellulose acetate having a lower degree of acetylation has a stronger hydrogen bond and a shorter intermolecular distance to fix the orientation of cellulose acetate molecules. This orientation is relaxed under high humidity conditions to reduce the retardation value significantly. Use of cellulose acetate having a high moisture content and a compound having a Van der Waals volume of 450 to 1000 Å³ precludes fixation of the orientation of cellulose acetate due to steric hindrance to relax or reduce the hydrogen bonding force. Drying of the cellulose acetate at high temperatures (140° C. or more) probably increases gaps between the molecules to reduce the fixed orientation of cellulose acetate molecules. For these reasons, the cellulose acetate has unfixed orientation, reducing changes in the orientation of cellulose acetate molecules due to environmental changes and changes in performance.

### DETAILED DESCRIPTION

The method of preparing a retardation film according to one or more embodiments of the invention is a method of preparing a retardation film comprising cellulose acetate having an average degree of acetylation of 2.0 to 2.5 and having a moisture content of 1.0 mass % or less, wherein the retardation film further comprises a compound having a Van der Waals volume of 450 to 1000 Å³, and the retardation film is prepared through at least five steps:

first step: a dope preparing step of dissolving cellulose acetate having an average degree of acetylation within the range of 2.0 to 2.5 to prepare a dope and having a moisture content of 3.0% or more in an organic solvent containing 90 mass % or more halogen organic solvent;

second step: a film product forming step of casting the dope onto a metal belt to form a film product;

third step: a film product peeling step of peeling off the film product from the metal belt;

fourth step: a drawing step of drawing the peeled film product; and

fifth step: a drying step at a drying temperature of 140° C. or more.

According to one or more embodiments of the invention, the retardation film has a ratio Rt(b)/Rt(a) within range of 0.3 to 0.8, where Rt(a) is the absolute value of a difference between a retardation value Rt₁ across the thickness of the film product after the film product is left at 23° C. and 55% RH for 24 hours after termination of the fifth step and a retardation value Rt₂ across the thickness of the film product after the film product is subsequently left at 60° C. and 90% RH for 500 hours, and Rt(b) is the absolute value of a difference between the retardation value Rt₁ across the thickness of the film product after the film product is left at 23° C. and 55% RH for 24 hours after termination of the fifth step and a retardation value Rt₃ across the thickness of the film product after the film product is subsequently left at 23° C. and 55% RH for 500 hours. The retardation film may contain 5 to 10 mass % compound having a Van der Waals volume of 450 to 1000 Å³ relative to the cellulose acetate to increase the intermolecular distance and reduce hydrogen bond characteristics.

In one or more embodiments of the invention, the compound having a Van der Waals volume of 450 to 1000 Å³ may be represented by at least one of Formulae (I) to (IV) from the viewpoint of desired retardation suitable for the retardation film.

The retardation film may be a long retardation film having a width of 700 to 3000 mm from the viewpoint of cost reduction, specifically high punching efficiency during production of panels in one or more embodiments of the invention.

The retardation film prepared by the method according to one or more embodiments of the invention can be suitably disposed in polarizing plates and liquid crystal displays.

The components in one or more embodiments of the invention and embodiments and examples for implementing one or more aspects of the invention will now be described in detail. In this application, the term “to” indicating the numerical range is meant to be inclusive of the boundary values as the minimum value and the maximum value.

### <<Compound Having Van Der Waals Volume of 450 to 1000 Å³>>

The retardation film according to one or more embodiments of the invention comprises a compound having a Van der Waals volume of 450 Å³ or more and 1000 Å³ or less.

In preparation of the retardation film according to one or more embodiments of the invention, a reduction in fluctuation in the retardation value of the retardation film due to changes in the residual solvent content in a film during drawing of the film is required. Reductions in intermolecular hydrogen bond of cellulose acetate in the film is effective for suppressing fluctuations in the retardation value of the retardation film due to changes in the residual solvent content in a film during drawing of the film. The action of hydrogen bond may be reduced by increasing the degree of acetylation. A desired retardation value, however, is difficult to attain at a higher degree of acetylation. Namely, to attain a desired retardation value stably, a reduction in the degree of acetylation of cellulose acetate and suppressing action of hydrogen bond of cellulose acetate, which appear contradictory, should be satisfied at the same time.

To suppress action of hydrogen bond of cellulose acetate contained in the retardation film, a compound having a Van der Waals volume of 450 Å³ or more and 1000 Å³ or less is added. At a Van der Waals volume outside of this range, the retardation film has insufficient optical compensation performance.

Although the cause is unclear, this insufficient optical compensation performance is probably caused for the following reasons. A Van der Waals volume of less than 450 Å³ cannot suppress the action of hydrogen bond of cellulose acetate, and a Van der Waals volume of more than 1000 Å³ restricts the rotation angle of the molecule of the compound to reduce the freedom of molecular motion. This restriction increases crystallinity of the compound itself or reduces the amorphousness. As described above, a retardation film having superior retardation characteristics and a suppressed fluctuation in the retardation value due to changes in the residual solvent content in the film during drawing of the film can be attained if a compound having a suitable steric feature is added to cellulose acetate that forms the retardation film, and the moisture content of the retardation film prepared from cellulose acetate having a high moisture content by solution casting is controlled to be 1.0 mass % or less by drying at a high temperature.

The Van der Waals volume can be determined, for example, by calculation from Van der Waals radii of atoms and the bonding distance between the atoms. The Van der Waals volume can also be determined by any method, such as molecular orbital calculation and molecular force field calculation. The present invention uses parameters determined with Molecular Simulation Software Cerius 2 (available from Accelrys, Inc.). The molecule structure is optimized with Dreiding Force Field by molecular mechanics (MM) calculation, and the volume is determined with Connoly Surface. The volume is used as the Van der Waals volume.

In one or more embodiments of the invention, the compound having a Van der Waals volume of 450 to 1000 Å³ may be represented by at least one of Formulae (I) to (IV).

The retardation film according to one or more embodiments of the invention contains 5 to 10 mass % compound having a Van der Waals volume of 450 to 1000 Å³, relative to the cellulose acetate. The compound having a Van der Waals volume of 450 to 1000 Å³ may be at least one compound represented by Formulae (I) to (IV).

The compound having a Van der Waals volume of 450 to 1000 Å³ may be contained in an amount of 5 to 10 mass % relative to the cellulose acetate to increase the intermolecular distance and reduce the ease of hydrogen bond formation.

A compound represented by Formula (I) will now be described. The compound having a structure represented by Formula (I) can have the Van der Waals volume set within the range defined in the present invention by introducing long and bulk groups into both sides of a benzene ring through a fused-ring structure including the benzene ring.

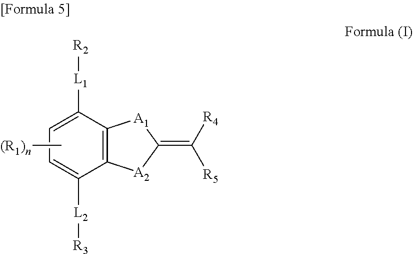

wherein L₁ and L₂ each represent a single bond or a divalent linking group; A₁ and A₂ represent a group each independently selected from —O—, —NR— (where R represents a hydrogen atom or a substituent), —S—, and —CO—; R₁, R₂, R₃, R₄, and R₅ each represent a substituent; n represents an integer of 0 to 2.

Examples of L₁ and L₂ include:

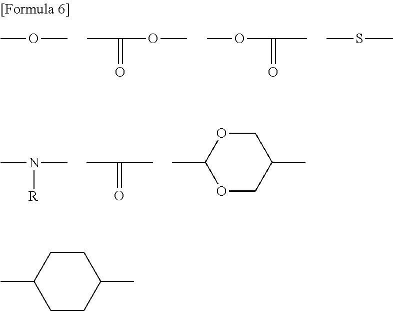

Also, —O—, —COO—, and —OCO— may be used.

R₁ is a substituent. A plurality of R₁'s if exists, may be identical or different or may form a ring. Examples of the substituent are listed in the following paragraph. Selection of a bulky group suitable for R₁ and R₂ to R₅ described later can readily control the Van der Waals volume of the compound according to one or more aspects of the invention within the range defined in accordance with the one or more embodiments of the invention.

R₁ represents a halogen atom (such as a fluorine, chlorine, bromine, or iodine atom), an alkyl group (an alkyl group having 1 to 30 carbon atoms, such as methyl, ethyl, n-propyl, isopropyl, tert-butyl, n-octyl, or 2-ethylhexyl), a cycloalkyl group (a substituted or unsubstituted cycloalkyl group having 3 to 30 carbon atoms, such as cyclohexyl, cyclopentyl, or 4-n-dodecylcyclohexyl), a bicycloalkyl group (a substituted or unsubstituted bicycloalkyl group having 5 to 30 carbon atoms, i.e., a monovalent group obtained by removing one hydrogen atom from a bicycloalkane molecule having 5 to 30 carbon atoms, such as bicyclo[1,2,2]heptan-2-yl or bicyclo[2,2,2]octan-3-yl), an alkenyl group (a substituted or unsubstituted alkenyl group having 2 to 30 carbon atoms, such as vinyl or allyl), a cycloalkenyl group (a substituted or unsubstituted cycloalkenyl group having 3 to 30 carbon atoms, i.e., a monovalent group obtained by removing one hydrogen atom from a cycloalkene molecule having 3 to 30 carbon atoms, such as 2-cyclopenten-1-yl or 2-cyclohexen-1-yl), a bicycloalkenyl group (a substituted or unsubstituted bicycloalkenyl group, a substituted or unsubstituted bicycloalkenyl group having 5 to 30 carbon atoms, i.e., a monovalent group having one double bond and obtained by removing one hydrogen atom from a bicycloalkene molecule, such as bicyclo[2,2,1]hept-2-en-1-yl or bicyclo[2,2,2]oct-2-en-4-yl), an alkynyl group (a substituted or unsubstituted alkynyl group having 2 to 30 carbon atoms, such as ethynyl or propargyl), an aryl group (a substituted or unsubstituted aryl group having 6 to 30 carbon atoms, such as phenyl, p-tolyl, or naphthyl), a heterocyclic group (a monovalent group obtained by removing one hydrogen atom from a 5- or 6-membered, substituted or unsubstituted, aromatic or nonaromatic heterocyclic compound, a 5- or 6-membered aromatic heterocyclic group having 3 to 30 carbon atoms, such as 2-furyl, 2-thienyl, 2-pyrimidinyl, or 2-benzothiazolyl), a cyano group, a hydroxy group, a nitro group, a carboxy group, an alkoxy group (a substituted or unsubstituted alkoxy group having 1 to 30 carbon atoms, such as methoxy, ethoxy, isopropoxy, tert-butoxy, n-octyloxy, or 2-methoxyethoxy), an aryloxy group (a substituted or unsubstituted aryloxy group having 6 to 30 carbon atoms, such as phenoxy, 2-methylphenoxy, 4-tert-butylphenoxy, 3-nitrophenoxy, or 2-tetradecanoylaminophenoxy), a silyloxy group (a silyloxy group having 3 to 20 carbon atoms, such as trimethylsilyloxy or tert-butyldimethylsilyloxy), a heterocyclic oxy group (a substituted or unsubstituted heterocyclic oxy group having 2 to 30 carbon atoms, such as 1-phenyltetrazole-5-oxy or 2-tetrahydropyranyloxy), an acyloxy group (formyloxy, a substituted or unsubstituted alkylcarbonyloxy group having 2 to 30 carbon atoms, a substituted or unsubstituted arylcarbonyloxy group having 6 to 30 carbon atoms, such as formyloxy, acetyloxy, pivaloyloxy, stearoyloxy, benzoyloxy, or p-methoxyphenylcarbonyloxy), a carbamoyloxy group (a substituted or unsubstituted carbamoyloxy group having 1 to 30 carbon atoms, such as N,N-dimethylcarbamoyloxy, N,N-diethylcarbamoyloxy, morpholinocarbonyloxy, N,N-di-n-octylaminocarbonyloxy, or N-n-octylcarbamoyloxy), an alkoxycarbonyloxy group (a substituted or unsubstituted alkoxycarbonyloxy group having 2 to 30 carbon atoms, such as methoxycarbonyloxy, ethoxycarbonyloxy, tert-butoxycarbonyloxy, or n-octylcarbonyloxy), an aryloxycarbonyloxy group (a substituted or unsubstituted aryloxycarbonyloxy group having 7 to 30 carbon atoms, such as phenoxycarbonyloxy, p-methoxyphenoxycarbonyloxy or p-n-hexadecyloxyphenoxycarbonyloxy), an amino group (amino, a substituted or unsubstituted alkylamino group having 1 to 30 carbon atoms, a substituted or unsubstituted anilino group having 6 to 30 carbon atoms, such as amino, methylamino, dimethylamino, anilino, N-methyl-anilino, or diphenylamino), an acylamino group (a formylamino group, a substituted or unsubstituted alkylcarbonylamino group having 1 to 30 carbon atoms, a substituted or unsubstituted arylcarbonylamino group having 6 to 30 carbon atoms, such as formylamino, acetylamino, pivaloylamino, lauroylamino, or benzoylamino), an aminocarbonylamino group (a substituted or unsubstituted aminocarbonylamino group having 1 to 30 carbon atoms, such as carbamoylamino, N,N-dimethylaminocarbonylamino, N,N-diethylaminocarbonylamino, or morpholinocarbonylamino), an alkoxycarbonylamino group (a substituted or unsubstituted alkoxycarbonylamino group having 2 to 30 carbon atoms, such as methoxycarbonylamino, ethoxycarbonylamino, tert-butoxycarbonylamino, n-octadecyloxycarbonylamino, or N-methyl-methoxycarbonylamino), an aryloxycarbonylamino group (a substituted or unsubstituted aryloxycarbonylamino group having 7 to 30 carbon atoms, such as phenoxycarbonylamino, p-chlorophenoxycarbonylamino, or m-n-octyloxyphenoxycarbonylamino), a sulfamoylamino group (a substituted or unsubstituted sulfamoylamino group having 0 to 30 carbon atoms, such as sulfamoylamino, N,N-dimethylaminosulfonylamino, or N-n-octylaminosulfonylamino), an alkyl- or arylsulfonylamino group (a substituted or unsubstituted alkylsulfonylamino group having 1 to 30 carbon atoms, a substituted or unsubstituted arylsulfonylamino group having 6 to 30 carbon atoms, such as methylsulfonylamino, butylsulfonylamino, phenylsulfonylamino, 2,3,5-trichlorophenylsulfonylamino, or p-methylphenylsulfonylamino), a mercapto group, an alkylthio group (a substituted or unsubstituted alkylthio group having 1 to 30 carbon atoms, such as methylthio, ethylthio, or n-hexadecylthio), an arylthio group (a substituted or unsubstituted arylthio group having 6 to 30 carbon atoms, such as phenylthio, p-chlorophenylthio, or m-methoxyphenylthio), a heterocyclic thio group (a substituted or unsubstituted heterocyclic thio group having 2 to 30 carbon atoms, such as 2-benzothiazolylthio or 1-phenyltetrazol-5-yl-thio), a sulfamoyl group (substituted or unsubstituted sulfamoyl group having 0 to 30 carbon atoms, such as N-ethylsulfamoyl, N-(3-dodecyloxypropyl)sulfamoyl, N,N-dimethylsulfamoyl, N-acetylsulfamoyl, N-benzoylsulfamoyl, or N—(N′-phenylcarbamoyl)sulfamoyl), a sulfo group, an alkyl- or arylsulfinyl group (a substituted or unsubstituted alkylsulfinyl group having 1 to 30 carbon atoms, a substituted or unsubstituted arylsulfinyl group having 6 to 30 carbon atoms, such as methylsulfinyl, ethylsulfinyl, phenylsulfinyl, or p-methylphenylsulfinyl), an alkyl- or arylsulfonyl group (a substituted or unsubstituted alkylsulfonyl group having 1 to 30 carbon atoms, a substituted or unsubstituted arylsulfonyl group having 6 to 30 carbon atoms, such as methylsulfonyl, ethylsulfonyl, phenylsulfonyl, or p-methylphenylsulfonyl), an acyl group (a formyl group, a substituted or unsubstituted alkylcarbonyl group having 2 to 30 carbon atoms, a substituted or unsubstituted arylcarbonyl group having 7 to 30 carbon atoms, such as acetyl or pivaloylbenzoyl), an aryloxycarbonyl group (a substituted or unsubstituted aryloxycarbonyl group having 7 to 30 carbon atoms, such as phenoxycarbonyl, o-chlorophenoxycarbonyl, m-nitrophenoxycarbonyl, or p-tert-butylphenoxycarbonyl), an alkoxycarbonyl group (a substituted or unsubstituted alkoxycarbonyl group having 2 to 30 carbon atoms, such as methoxycarbonyl, ethoxycarbonyl, tert-butoxycarbonyl, or n-octadecyloxycarbonyl), a carbamoyl group (a substituted or unsubstituted carbamoyl group having 1 to 30 carbon atoms, such as carbamoyl, N-methylcarbamoyl, N,N-dimethylcarbamoyl, N,N-di-n-octylcarbamoyl, or N-(methylsulfonyl)carbamoyl), an aryl- or heterocyclic azo group (a substituted or unsubstituted arylazo group having 6 to 30 carbon atoms, a substituted or unsubstituted heterocyclic azo group having 3 to 30 carbon atoms, such as phenylazo, p-chlorophenylazo, or 5-ethylthio-1,3,4-thiadiazol-2-yl-azo), an imide group (N-succinimide or N-phthalimide), a phosphino group (a substituted or unsubstituted phosphino group having 2 to 30 carbon atoms, such as dimethylphosphino, diphenylphosphino, or methylphenoxyphosphino), a phosphinyl group (a substituted or unsubstituted phosphinyl group having 2 to 30 carbon atoms, such as phosphinyl, dioctyloxyphosphinyl, or diethoxyphosphinyl), a phosphinyloxy group (a substituted or unsubstituted phosphinyloxy group having 2 to 30 carbon atoms, such as diphenoxyphosphinyloxy or dioctyloxyphosphinyloxy), a phosphinylamino group (a substituted or unsubstituted phosphinylamino group having 2 to 30 carbon atoms, such as dimethoxyphosphinylamino or dimethylaminophosphinylamino), or a silyl group (a substituted or unsubstituted silyl groups each having 3 to 30 carbon atoms, such as trimethylsilyl, tert-butyldimethylsilyl, or phenyldimethylsilyl).

Any hydrogen atom, if present, contained in these substituents may optionally be replaced with one of the groups listed above. Examples of such functional groups include alkylcarbonylaminosulfonyl, arylcarbonylaminosulfonyl, alkylsulfonylaminocarbonyl, and arylsulfonylaminocarbonyl. Typical examples thereof include methylsulfonylaminocarbonyl, p-methylphenylsulfonylaminocarbonyl, acetylaminosulfonyl, and benzoylaminosulfonyl.

R₁ may be a halogen atom, an alkyl group, an alkenyl group, an aryl group, a heterocyclic group, a hydroxy group, a carboxy group, an alkoxy group, an aryloxy group, an acyloxy group, a cyano group, or an amino group, or a halogen atom, an alkyl group, a cyano group, or an alkoxy group.

R₂ and R₃ each independently represent a substituent. Examples thereof include the substituents listed for R₁. The substituent may be a substituted or unsubstituted benzene ring or a substituted or unsubstituted cyclohexane ring. The substituent may be a benzene or cyclohexane ring having a substituent, or a benzene or cyclohexane ring having a substituent at a 4th position.

R₄ and R₅ each independently represent a substituent. Examples thereof include the substituents listed for R₁. The substituent may be an electron-attractive substituent having a Hammett substituent constant σₚ of more than 0, or an electron-attractive substituent having a σₚ of 0 to 1.5. Examples of such a substituent include a trifluoromethyl group, a cyano group, a carbonyl group, and a nitro group. R₄ may bond to R₅ to form a ring.

The Hammett substituent constants σₚ and σₘ are explained in detail, for example, “Hamettosoku-Kouzoto Hannousei (Hammett equation: Structure and Reactivity)” (Maruzen Company, Limited), written by Naoki Inamoto; “Shin Jikkenkagaku Koza (New Experimental Chemisty) 14: Yuukikagoubutuno Gousei to Hannou (Synthesis and Reaction of Organic Compounds) V”, edited by The Chemical Society of Japan, p. 2605 (Maruzen Company, Limited); “Riron Yukikagaku Kaisetsu (Theoretical Organic Chemistry,” written by Tadao Nakatani, p. 217 (Tokyo Kagaku Doujin K. K.); and Chemical Review, vol. 91, pp. 165 to 195 (1991).

A₁ and A₂ are each independently selected from —O—, —NR— (where R represents a hydrogen atom or a substituent), —S—, and —CO—. A₁ and A₂ may be each independently selected from —O—, —NR— (where R represents a substituent), and —S—.

n may be 0 or 1.

Specific examples of a compound represented by Formula (I) according to one or more embodiments of the invention and the synthetic method are described in detail, for example, in Japanese Patent No. 4989984.

The compound represented by Formula (I) may demonstrate a liquid crystal phase at 100° C. to 300° C., or 120° C. to 200° C. A liquid crystal phase may be a nematic or smectic phase.

A compound represented by Formula (II) will now be described. In one or more embodiments of the invention, the compound having a Van der Waals volume of 450 to 1000 Å³ may be a triazine compound represented by Formula (II). The compound having a structure represented by Formula (II) includes three substituents in a triazine ring, and an aromatic ring or a heterocycle can be introduced into each of the three substituents to establish the Van der Waals volume within the range defined in accordance with embodiments of the invention. The aromatic ring or the heterocycle can have a substituent to control the Van der Waals volume.

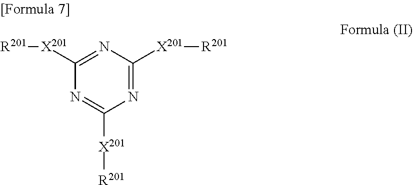

where three R²⁰¹'s each independently represent an aromatic ring or a heterocycle having a substituent at at least one of the ortho-, meta-, and para-positions; three X²⁰¹'s each independently represent a single bond or NR²⁰²—; three R²⁰²'s each independently represent a hydrogen atom, a substituted or unsubstituted alkyl, alkenyl, aryl, or heterocyclic group.

The aromatic ring represented by R²⁰¹ may be phenyl or naphthyl. The aromatic ring represented by R²⁰¹ may have at least one substituent at one of the substitution positions. Selection of a suitable bulky group as the substituent can readily control the Van der Waals volume of the compound according to aspects of the invention within the range defined in one or more embodiments of the invention.

Examples of the substituent include halogen atoms, and hydroxy, cyano, nitro, carboxy, alkyl, alkenyl, aryl, alkoxy, alkenyloxy, aryloxy, acyloxy, alkoxycarbonyl, alkenyloxycarbonyl, aryloxycarbonyl, sulfamoyl, alkyl-substituted sulfamoyl, alkenyl-substituted sulfamoyl, aryl-substituted sulfamoyl, sulfonamide, carbamoyl, alkyl-substituted carbamoyl, alkenyl-substituted carbamoyl, aryl-substituted carbamoyl, amide, alkylthio, alkenylthio, arylthio, and acyl groups.

The heterocycle represented by R²⁰¹ may a have aromatic characteristics. A heterocycle having aromatic characteristics is typically an unsaturated heterocycle, a heterocycle having a maximum number of double bonds. The heterocycle may be a 5-membered, 6-membered, or 7-membered ring; a 5-membered or 6-membered ring; or a 6-membered ring. The heteroatom of the heterocycle may be a nitrogen, sulfur, or oxygen atom. An example of a heterocycle having aromatic characteristics may be a pyridine ring (2-pyridyl or 4-pyridyl as the heterocyclic group). The heterocyclic group may optionally have a substituent. Examples of the substituent for the heterocyclic group are the same as those listed for aryl.

Where X²⁰¹ is a single bond, the heterocyclic group may be a heterocyclic group having a free valence in a nitrogen atom. The heterocyclic group having a free valence in a nitrogen atom may be a 5-membered, 6-membered, or 7-membered ring; a 5-membered or 6-membered ring; or a 5-membered ring. The heterocyclic group may have a plurality of nitrogen atoms. The heterocyclic group may have any heteroatom (such as O and S) other than the nitrogen atom. Examples of the heterocyclic group having a free valence in a nitrogen atom are listed below wherein —C₄H₉ⁿ represents n-C₄H₉.

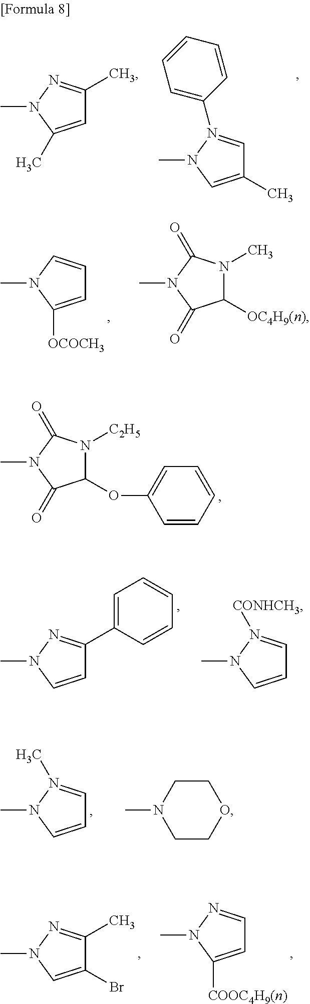

An alkyl group represented by R²⁰² may be a cyclic or acylcic alkyl group. An acylcic alkyl group may be preferred, and a linear alkyl group may be preferred to a branched alkyl group. The alkyl group may have 1 to 30, 1 to 20, 1 to 10, 1 to 8, or 1 to 6 carbon atoms. The alkyl group may optionally have a substituent. Examples of the substituent include halogen atoms, alkoxy groups (such as methoxy and ethoxy), and acyloxy groups (such as acryloyloxy and methacryloyloxy).

An alkenyl group represented by R²⁰² may be a cyclic or acylcic alkenyl group. An acylcic alkenyl group may be preferred, and a linear alkenyl group may be preferred to a branched alkenyl group. The alkenyl group may have 2 to 30, 2 to 20, 2 to 10, 2 to 8, or 2 to 6 carbon atoms. The alkenyl group may optionally have a substituent. Examples of the substituent are the same as those for the alkyl group described above.

The aromatic ring and heterocycle represented by R²⁰² and their examples may be the same as the aromatic ring and the heterocycle represented by R²⁰¹ and their examples. The aromatic ring and the heterocycle may further have a substituent. Examples of the substituent are the same as those for the aromatic ring and heterocycle represented by R²⁰¹.

Specific examples of the compound represented by Formula (II) are described, for example, in Japanese Patent Application Laid-Open Nos. 2008-52267 and 2008-89885. The compound represented by Formula (II) can be prepared by any well-known method, such as a method described in Japanese Patent Application Laid-Open No. 2003-344655.

A compound represented by Formula (III) will now be described in accordance with one or more embodiments of the invention.

In one or more embodiments of the invention, the compound having a Van der Waals volume of 450 to 1000 Å³ may be a triphenylene compound represented by Formula (III). The compound having a structure represented by Formula (III) includes a basic skeleton of triphenylene having a large Van der Waals volume, and an alkoxy group can be introduced to control the Van der Waals volume within the range defined in one or more embodiments of the invention.

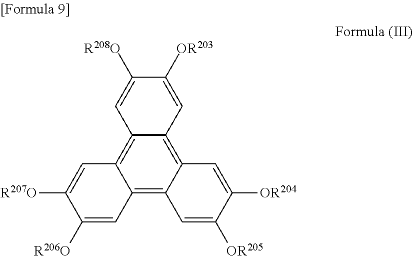

where R²⁰³ to R²⁰⁸ each independently represent a hydrogen atom or a substituent.

Selection of a bulky group suitable for R²⁰³ to R²⁰⁸ can readily control the Van der Waals volume of the compound according to aspects of the invention within the range defined in one or more embodiments of the invention.

Examples of the substituents represented by R²⁰³ to R²⁰⁸ include alkyl groups (alkyl groups each may have 1 to 40 carbon atoms, 1 to 30 carbon atoms, or 1 to 20 carbon atoms, such as methyl, ethyl, isopropyl, tert-butyl, n-octyl, n-decyl, n-hexadecyl, cyclopropyl, cyclopentyl, and cyclohexyl); alkenyl groups (alkenyl groups each having 2 to 40 carbon atoms, 2 to 30 carbon atoms, or 2 to 20 carbon atoms, such as vinyl, allyl, 2-butenyl, and 3-pentenyl); alkynyl groups (alkynyl groups each having 2 to 40 carbon atoms, 2 to 30 carbon atoms, or 2 to 20 carbon atoms, such as propargyl and 3-pentynyl); aryl groups (aryl groups each having 6 to 30 carbon atoms, 6 to 20 carbon atoms, or 6 to 12 carbon atoms, such as phenyl, p-methylphenyl, and naphthyl), substituted or unsubstituted amino groups (amino groups each having 0 to 40 carbon atoms, 0 to 30 carbon atoms, or 0 to 20 carbon atoms, such as unsubstituted amino, methylamino, dimethylamino, diethylamino, and anilino groups); alkoxy groups (alkoxy groups each having 1 to 40 carbon atoms, 1 to 30 carbon atoms, or 1 to 20 carbon atoms, such as methoxy, ethoxy, and butoxy); aryloxy groups (aryloxy groups each having 6 to 40 carbon atoms, 6 to 30 carbon atoms, or 6 to 20 carbon atoms, such as phenyloxy and 2-naphthyloxy); acyl groups (acyl groups each having 1 to 40 carbon atoms, 1 to 30 carbon atoms, or 1 to 20 carbon atoms, such as acetyl, benzoyl, formyl, and pivaloyl); alkoxycarbonyl groups (alkoxycarbonyl groups each having 2 to 40 carbon atoms, 2 to 30 carbon atoms, or 2 to 20 carbon atoms, such as methoxycarbonyl and ethoxycarbonyl); aryloxycarbonyl groups (aryloxycarbonyl groups each having 7 to 40 carbon atoms, 7 to 30 carbon atoms, or 7 to 20 carbon atoms, such as phenyloxycarbonyl); acyloxy groups (acyloxy groups each having 2 to 40 carbon atoms, 2 to 30 carbon atoms, or 2 to 20 carbon atoms, such as acetoxy and benzoyloxy); acylamino groups (acylamino groups each having 2 to 40 carbon atoms, 2 to 30 carbon atoms, or 2 to 20 carbon atoms, such as acetylamino and benzoylamino); alkoxycarbonylamino groups (alkoxycarbonylamino groups each having 2 to 40 carbon atoms, 2 to 30 carbon atoms, or 2 to 20 carbon atoms, such as methoxycarbonylamino); aryloxycarbonylamino groups (aryloxycarbonylamino groups each having 7 to 40 carbon atoms, 7 to 30 carbon atoms, or 7 to 20 carbon atoms, such as phenyloxycarbonylamino); sulfonylamino groups (sulfonylamino groups each having 1 to 40 carbon atoms, 1 to 30 carbon atoms, or 1 to 20 carbon atoms, such as methanesulfonylamino and benzenesulfonylamino); sulfamoyl groups (sulfamoyl groups each having 0 to 40 carbon atoms, 0 to 30 carbon atoms, or 0 to 20 carbon atoms, such as sulfamoyl, methylsulfamoyl, dimethylsulfamoyl, and phenylsulfamoyl); carbamoyl groups (carbamoyl groups each having 1 to 40 carbon atoms, 1 to 30 carbon atoms, or 1 to 20 carbon atoms, such as unsubstituted carbamoyl, methylcarbamoyl, diethylcarbamoyl, and phenylcarbamoyl groups); alkylthio groups (1 to 40 carbon atoms, 1 to 30 carbon atoms, or 1 to 20 carbon atoms, such as methylthio, ethylthio, propylthio, butylthio, pentylthio, hexylthio, heptylthio, and octylthio); arylthio groups (6 to 40 carbon atoms, 6 to 30 carbon atoms, or 1 to 20 carbon atoms, such as phenylthio); sulfonyl groups (sulfonyl groups each having 1 to 40 carbon atoms, 1 to 30 carbon atoms, or 1 to 20 carbon atoms, such as mesyl and tosyl); sulfinyl groups (sulfinyl groups each having 1 to 40 carbon atoms, 1 to 30 carbon atoms, or 1 to 20 carbon atoms, such as methanesulfinyl and benzenesulfinyl); ureido groups (ureido groups each having 1 to 40 carbon atoms, 1 to 30 carbon atoms, or 1 to 20 carbon atoms, such as unsubstituted ureido, methylureido, and phenylureido); amidophosphate groups (amidophosphate groups each having 1 to 40 carbon atoms, 1 to 30 carbon atoms, or 1 to 20 carbon atoms, such as diethyl amidophosphate and phenyl amidophosphate); a hydroxy group, a mercapto group, halogen atoms (such as fluorine, chlorine, bromine, and iodine atoms); a cyano group, a sulfo group, a carboxy group, a nitro group, a hydroxamate group, a sulfino group, a hydrazino group, an imino group, heterocyclic groups (heterocyclic groups each having 1 to 30, or 1 to 12 carbon atoms and having a heteroatom such as a nitrogen, oxygen, or sulfur atom, such as imidazolyl, pyridyl, quinolyl, furyl, piperidyl, morpholino, benzoxazolyl, benzimidazolyl, benzothiazolyl, and 1,3,5-triazyl); and silyl groups (silyl groups each having 3 to 40 carbon atoms, 3 to 30 carbon atoms, or 3 to 24 carbon atoms, such as trimethylsilyl and triphenylsilyl). These substituents for R²⁰³ to R²⁰⁸ may optionally be replaced with one of the substituents listed above. Two or more of the substituents, if exist, may be identical or different. The substituents may bond to each other, if possible, to form a ring.

The substituents each represented by R²⁰³ to R²⁰⁸ may be an alkyl group, an aryl group, a substituted or unsubstituted amino group, an alkoxy group, an alkylthio group, or a halogen atom.

A compound represented by Formula (III) is described in, for example, Japanese Patent Application Laid-Open Nos. 2008-52267 and 2008-89885. The compound represented by Formula (III) can be prepared by any well-known method, such as a method described in Japanese Patent Application Laid-Open No. 2005-134884.

A compound represented by Formula (IV) will now be described.

In the present invention, compounds having a Van der Waals volume of 450 to 1000 Å³ and represented by Formula (IV) may also be used. The compound having a structure represented by Formula (IV) has a benzene, pyridine, or pyrimidine ring as a basic skeleton, and includes three substituents. An aromatic ring or a heterocycle can be introduced into each of the three substituents to establish the Van der Waals volume within the range defined in one or more embodiments of the invention. The aromatic ring or the heterocycle each can have another substituent to control the Van der Waals volume.

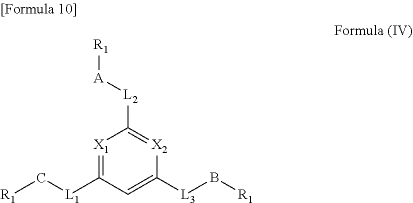

where A, B, and C each represent an aryl or heteroaryl ring; L₁, L₂, and L₃ each represent a bond or a divalent linking group selected from an alkylene group, —COO—, —NR₂—, —OCO—, —OCOO—, —O—, —S—, —NHCO—, and —CONH—; X₁ and X₂ represent a carbon atom or a nitrogen atom; R₁ represents a substituent; R₂ represents a hydrogen atom or a substituent.

In Formula (IV), A, B, and C each represent an aromatic or heteroaromatic ring. Examples of the aromatic ring may include phenyl and naphthyl. Examples of the heteroaromatic ring groups may can include pyridyl, pyrimidyl, oxazolyl, thiazolyl, oxadiazolyl, thiadiazolyl, imidazolyl, carbazolyl, and indolyl. From the viewpoint of retardation characteristics, phenyl, pyridyl, and oxadiazolyl may be used, and phenyl and oxadiazolyl may also be used.

In Formula (IV), L₁, L₂, and L₃ each represent a bond or a divalent linking group selected from an alkylene group, —COO—, —NR₂—, —OCO—, —OCOO—, —O—, —S—, —NHCO—, and —CONH—. Among these, a bond, —COO—, —NR₂—, —NHCO—, and —CONH— may be used, and a bond, —NR₂—, —NHCO—, and —CONH— may also be used.

In Formula (IV), R₁ represents a substituent. Selection of a bulky group suitable for the substituent can readily control the Van der Waals volume of the compound according to one or more embodiments of the invention.

In Formula (IV), R₁ represents a substituent, or represents an alkyl group (such as methyl, ethyl, propyl, isopropyl, t-butyl, pentyl, hexyl, octyl, dodecyl, or trifluoromethyl), a cycloalkyl group (such as cyclopropyl, cyclopentyl, cyclohexyl, or adamantyl), an aryl group (such as phenyl or naphthyl), a heterocyclic group (such as pyridyl, pyrimidyl, oxazolyl, thiazolyl, oxadiazolyl, thiadiazolyl, or imidazolyl), an acylamino group (such as acetylamino or benzoylamino), an alkylthio group (such as methylthio or ethylthio), an arylthio group (such as phenylthio or naphthylthio), an alkenyl group (such as vinyl, 2-propenyl, 3-butenyl, 1-methyl-3-propenyl, 3-pentenyl, 1-methyl-3-butenyl, 4-hexenyl, cyclohexenyl, or styryl), a halogen atom (such as a fluorine, chlorine, bromine, or iodine atom), an alkynyl group (such as propargyl), an alkylsulfonyl group (such as methylsulfonyl or ethylsulfonyl), an arylsulfonyl group (such as phenylsulfonyl or naphthylsulfonyl), an alkylsulfinyl group (such as methylsulfinyl), an arylsulfinyl group (such as phenylsulfinyl), a phosphono group, an acyl group (such as acetyl, pivaloyl, or benzoyl), a carbamoyl group (such as aminocarbonyl, methylaminocarbonyl, dimethylaminocarbonyl, butylaminocarbonyl, cyclohexylaminocarbonyl, or phenylaminocarbonyl), a sulfamoyl group (such as aminosulfonyl, methylaminosulfonyl, dimethylaminosulfonyl, butylaminosulfonyl, hexylaminosulfonyl, cyclohexylaminosulfonyl, octylaminosulfonyl, dodecylaminosulfonyl, phenylaminosulfonyl, naphthylaminosulfonyl, or 2-pyridylaminosulfonyl), a sulfoneamide group (such as methanesulfoneamide or benzenesulfoneamide), a cyano group, an alkyloxy group (such as methoxy, ethoxy, or propoxy), an aryloxy group (such as phenoxy or naphthyloxy), a siloxy group, an acyloxy group (such as acetyloxy or benzoyloxy), a sulfonate group, a salt of sulfonic acid, an aminocarbonyloxy group, an amino group (such as amino, ethylamino, dimethylamino, butylamino, cyclopentylamino, 2-ethylhexylamino, or dodecylamino), an anilino group (such as phenylamino, chlorophenylamino, toluidino, anisidino, naphthylamino, or 2-pyridylamino), an imide group, a ureido group (such as methylureido, ethylureido, pentylureido, cyclohexylureido, octylureido, dodecylureido, phenylureido, naphthylureido, or 2-pyridylaminoureido), an alkoxycarbonylamino group (such as methoxycarbonylamino or phenoxycarbonylamino), an alkoxycarbonyl group (such as methoxycarbonyl, ethoxycarbonyl, or phenoxycarbonyl), an aryloxycarbonyl group (such as phenoxycarbonyl), a carbamate group (such as methylcarbamate or phenylcarbamate), an alkyloxyphenyl group (such as methoxyphenyl), an acyloxyphenyl group (such as acetyloxyphenyl), a thioureido group, a carboxy group, a salt of carboxylic acid, a hydroxy group, a mercapto group, or a nitro group. These substituents may optionally be replaced with two or more of these substituents. Adjacent substituents may bond to each other to form a ring.

R₁ in Formula (IV) may be an alkyl group, an alkyloxy group having 4 or less carbon atoms, an aryloxy group, an acyl group, an alkoxycarbonyl group, an aryloxycarbonyl group, a carbamate group, a carbonate group, a hydroxy group, a cyano group, or an amino group; an alkyloxy group having 4 or less carbon atoms, an acyl group, an alkoxycarbonyl group, an aryloxycarbonyl group, a carbamate group, or an amino group; or an alkyloxy group having 4 or less carbon atoms, an acyl group, an alkoxycarbonyl group, an aryloxycarbonyl group, a carbamate group, or a carbonate group.

In Formula (IV), R₁ can reside at any substitution position. When A, B, and C are a 6-membered ring, R₁ may reside at the para-position and the meta-position with respect to L₁, L₂, and L₃.

Three R₁'s in Formula (IV) may optionally be replaced with substituents, which may be identical or different. The number of substituents may be 1 to 3.

When L₁, L₂, and L₃ in Formula (IV) each represent a bond, a substituent represented by R₁ may be an alkyl or alkyloxy group.

In Formula (IV), R₂ represents a hydrogen atom or a substituent, and examples of the substituent can include those listed for R₁.

R₂ in Formula (IV) may be a hydrogen atom or an alkyl group. In one or more embodiments, R₂ in Formula (IV) may be a hydrogen atom.

In Formula (IV), X₁ and X₂ represent a carbon atom or a nitrogen atom, and may be identical or different.

Non-limiting specific examples of the compound represented by Formula (IV) are listed below.

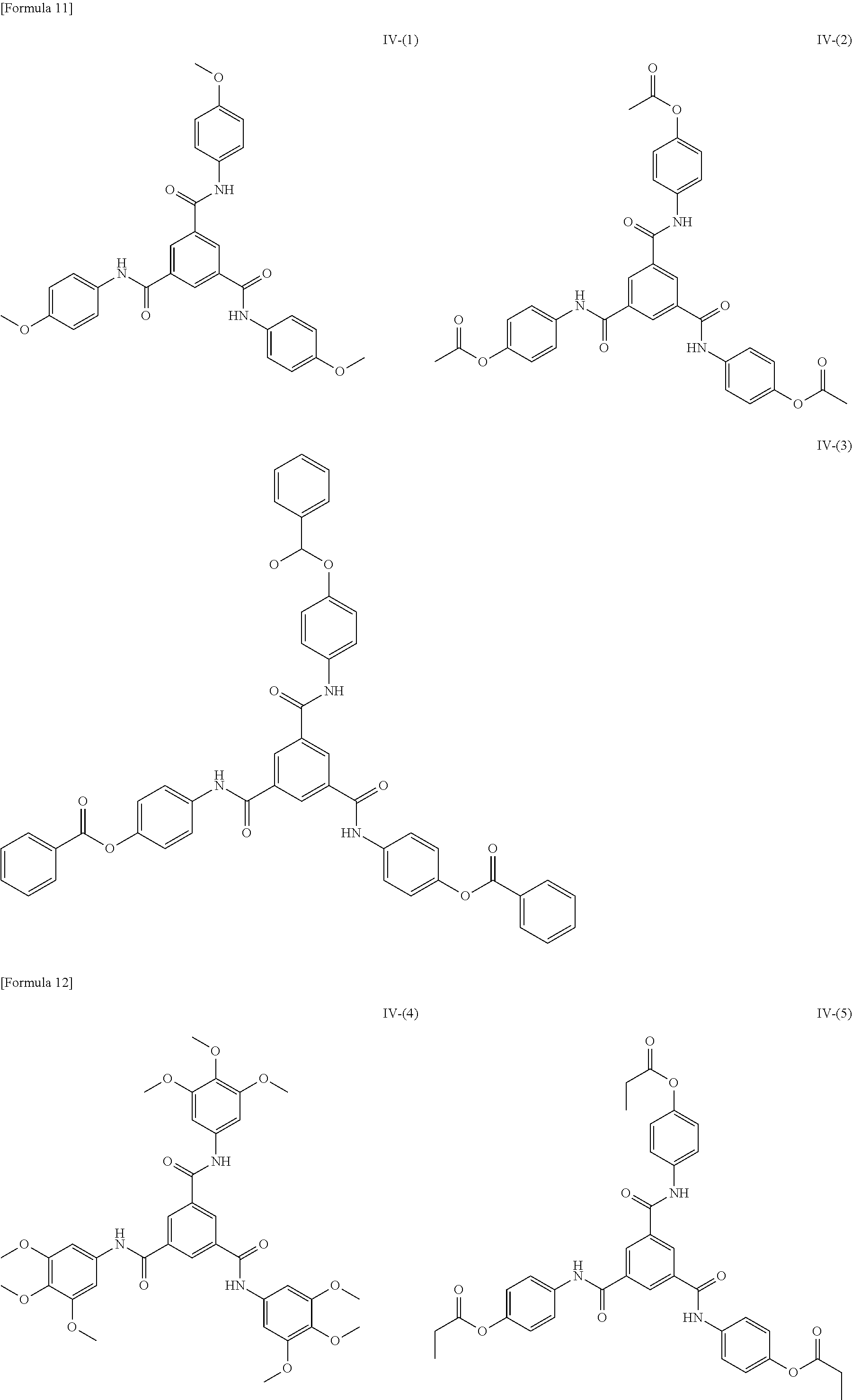

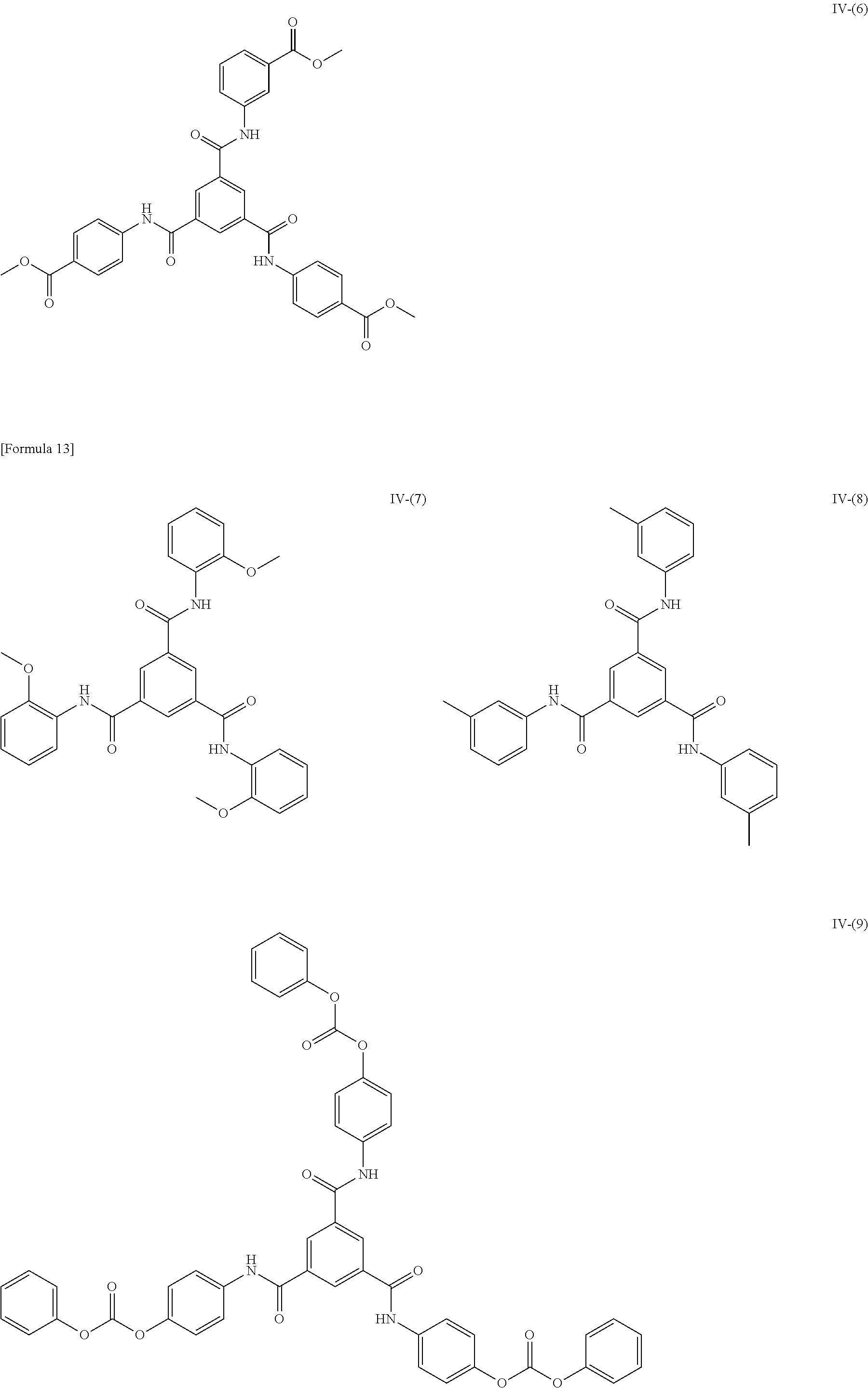

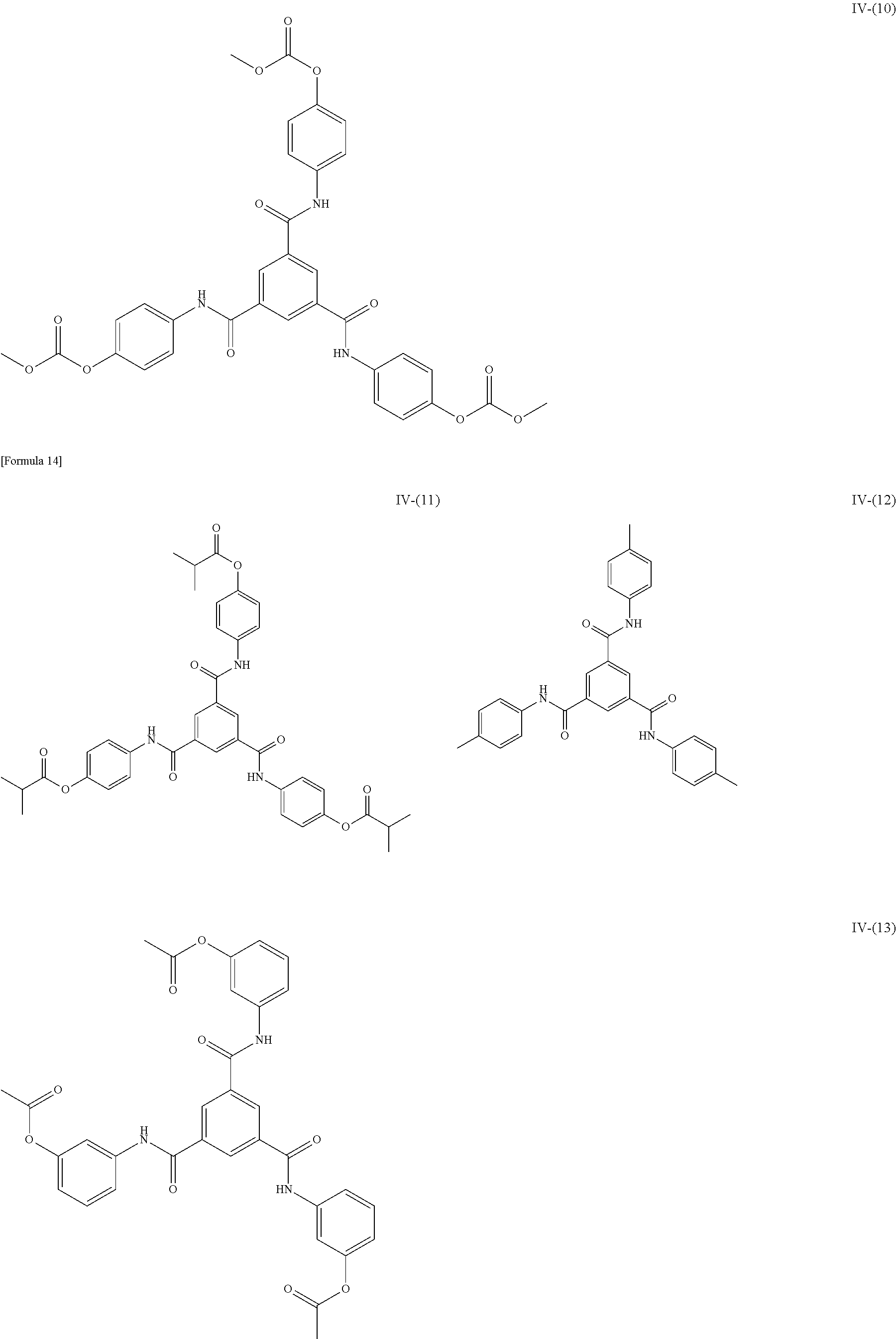

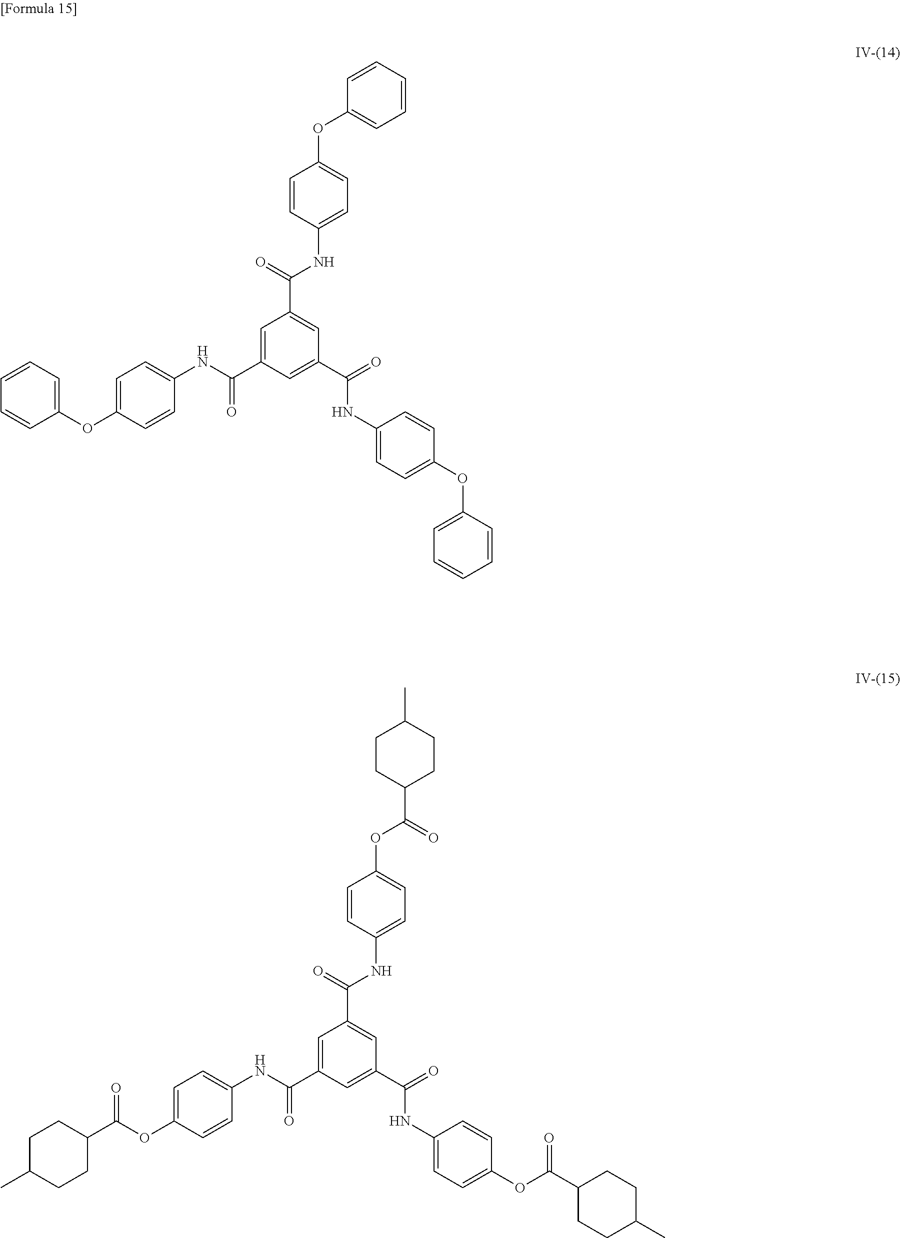

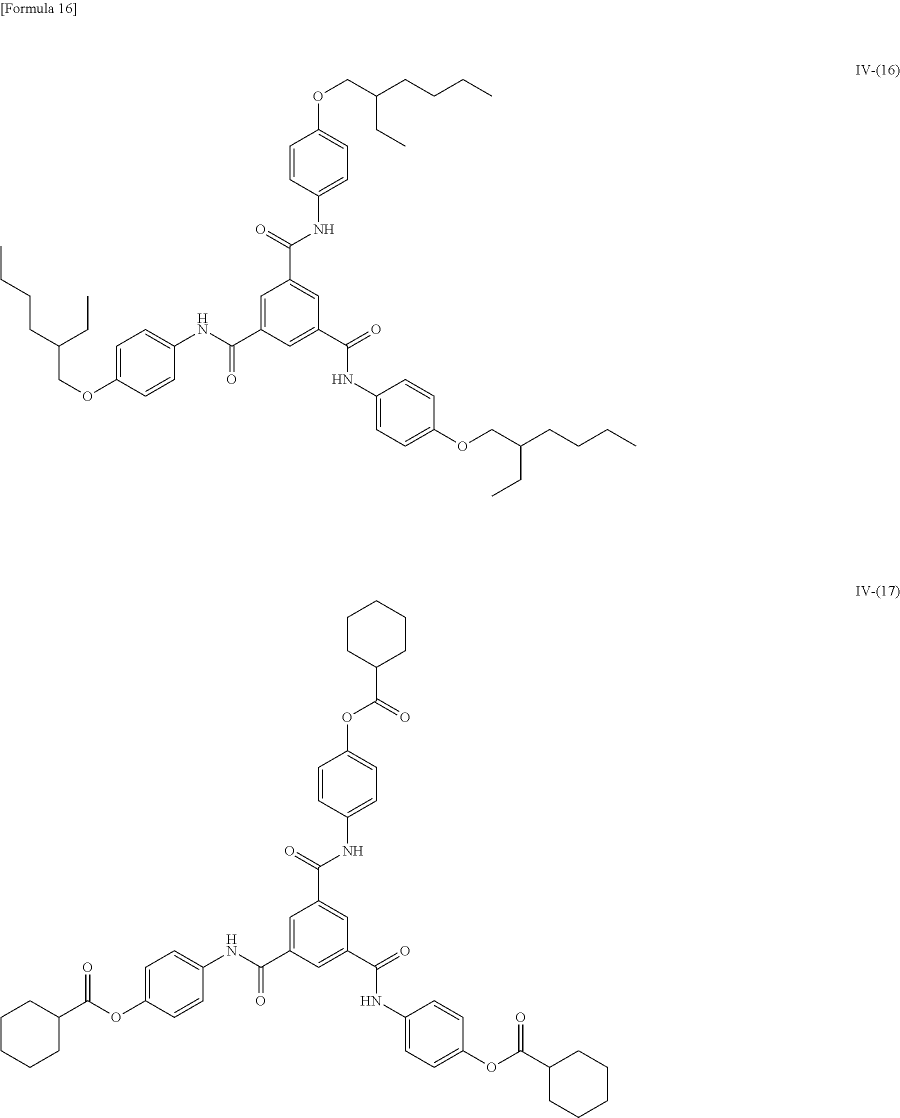 [SMILES: CCCCC(CC)COc1ccc(NC(=O)c2cc(C(=O)Nc3ccc(OCC(CC)CCCC)cc3)cc(C(=O)Nc3ccc(OCC(CC)CCCC)cc3)c2)cc1 ; O=C(Nc1ccc(OC(=O)C2CCCCC2)cc1)c1cc(C(=O)Nc2ccc(OC(=O)C3CCCCC3)cc2)cc(C(=O)Nc2ccc(OC(=O)C3CCCCC3)cc2)c1]

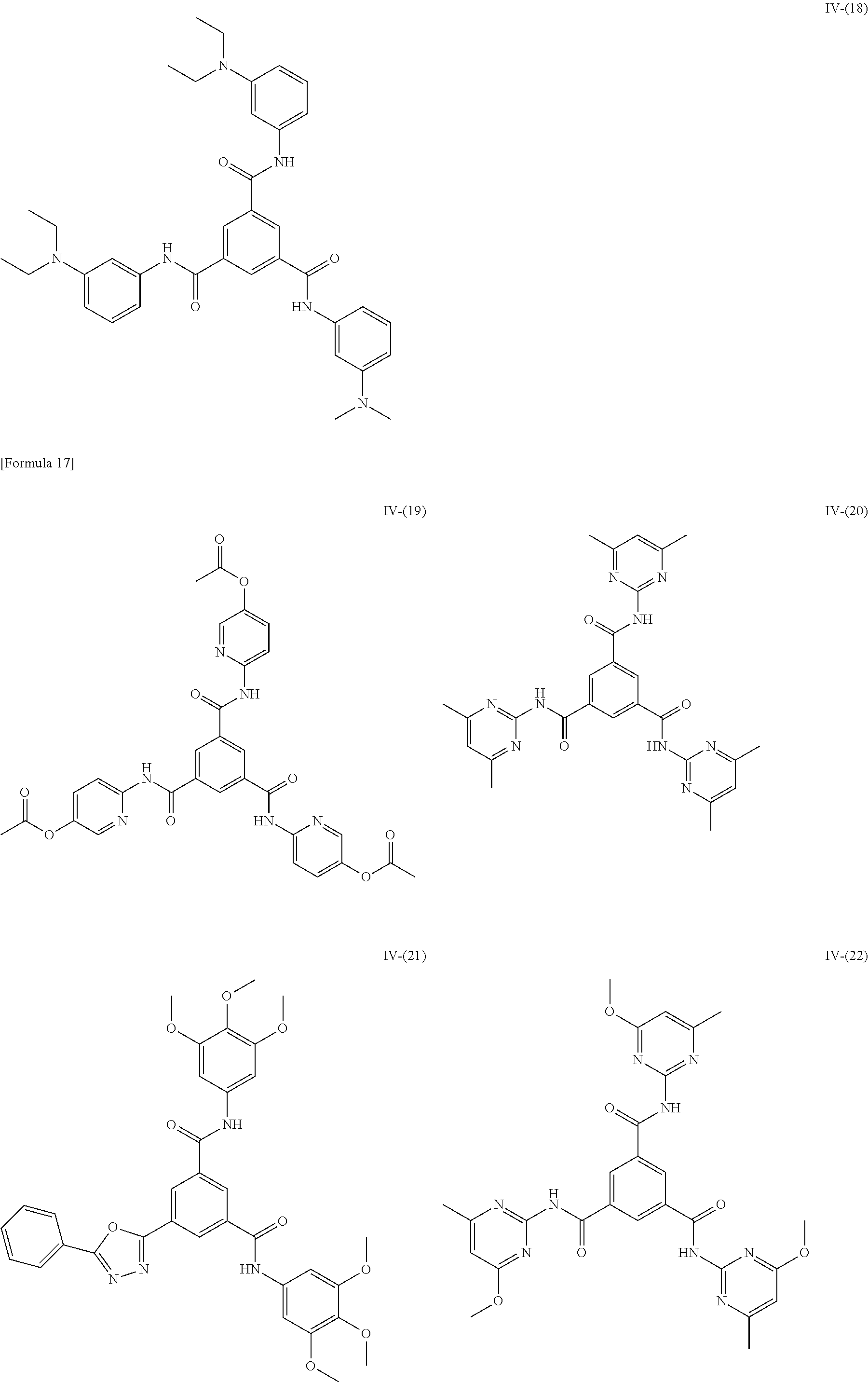

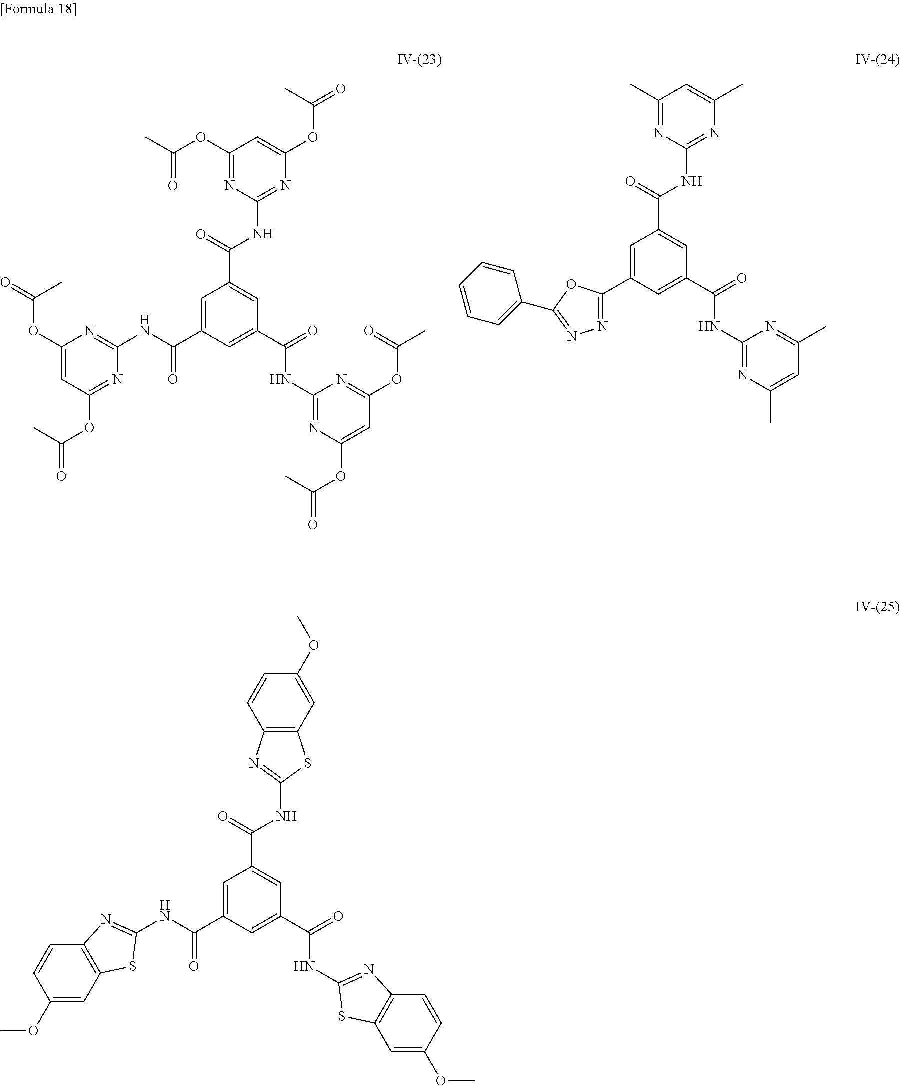

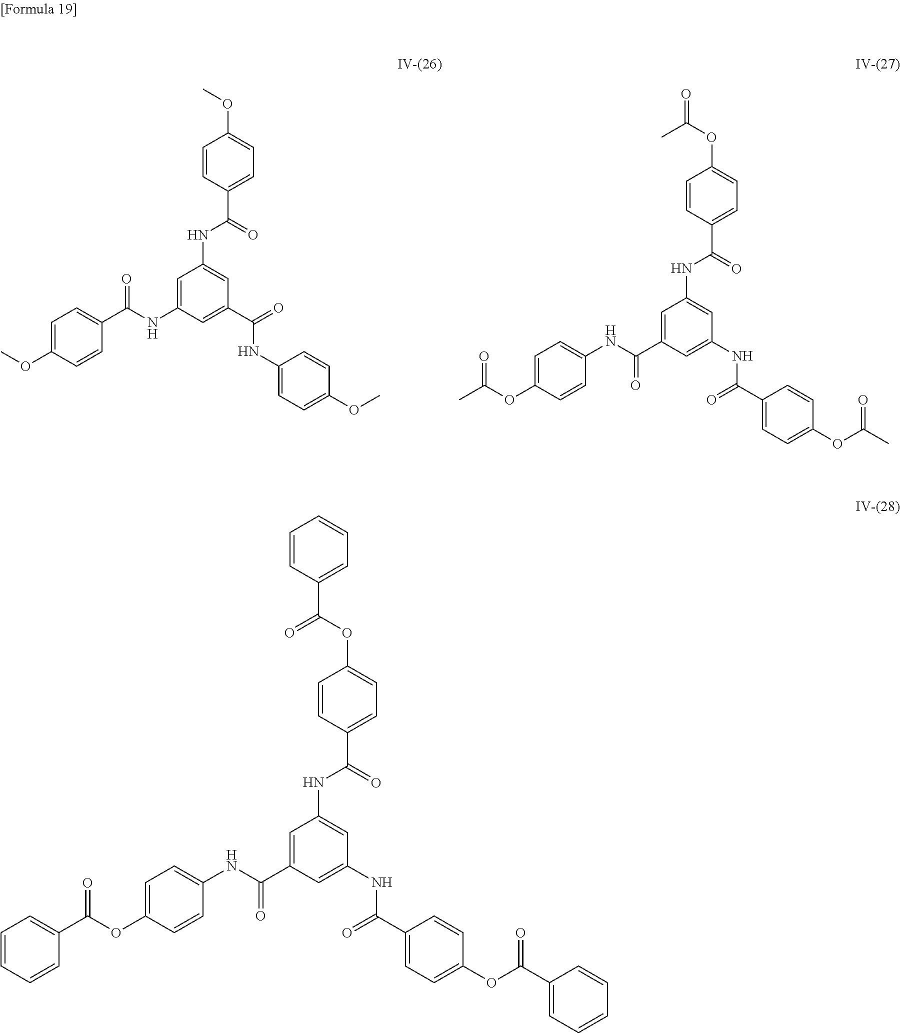

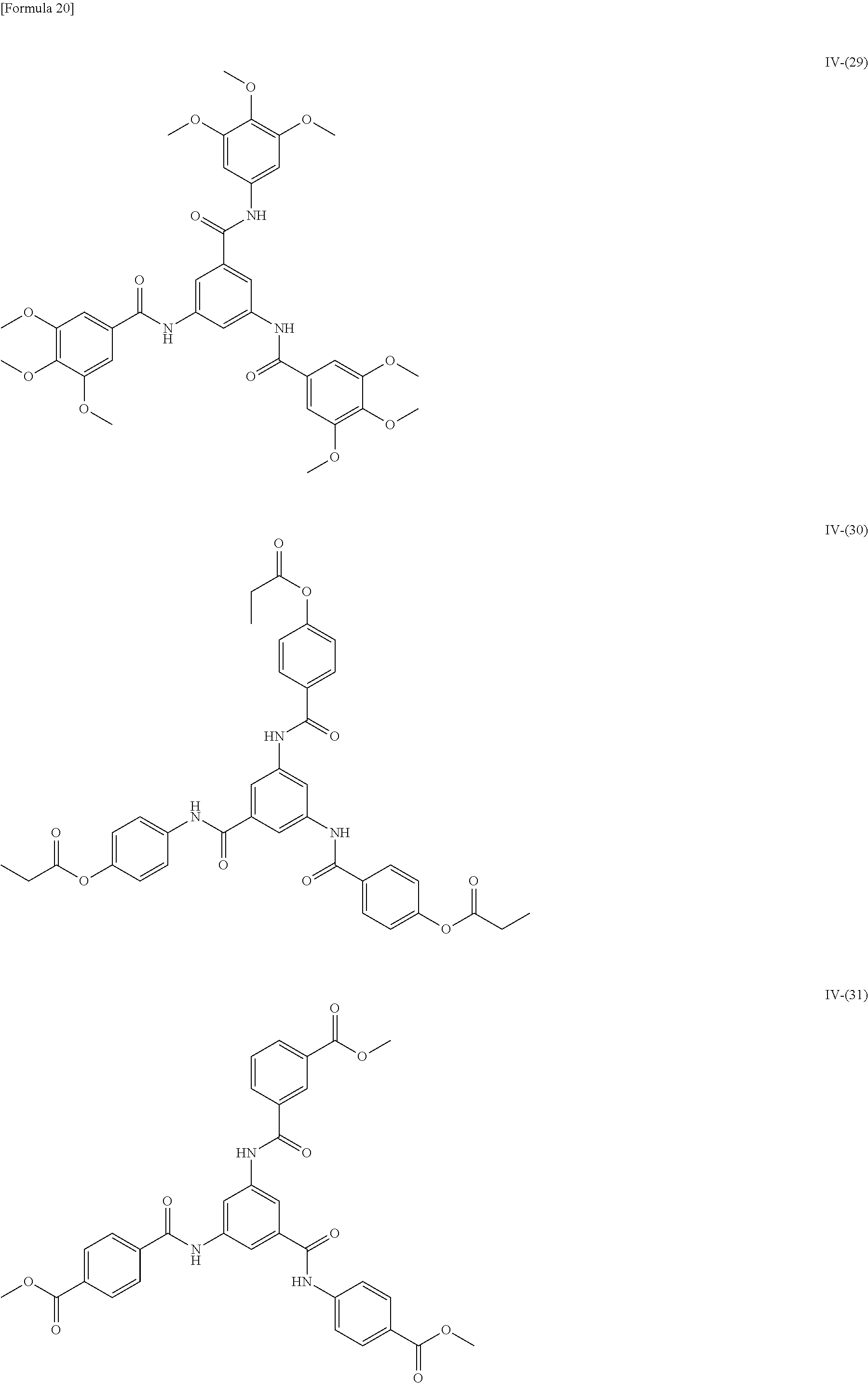

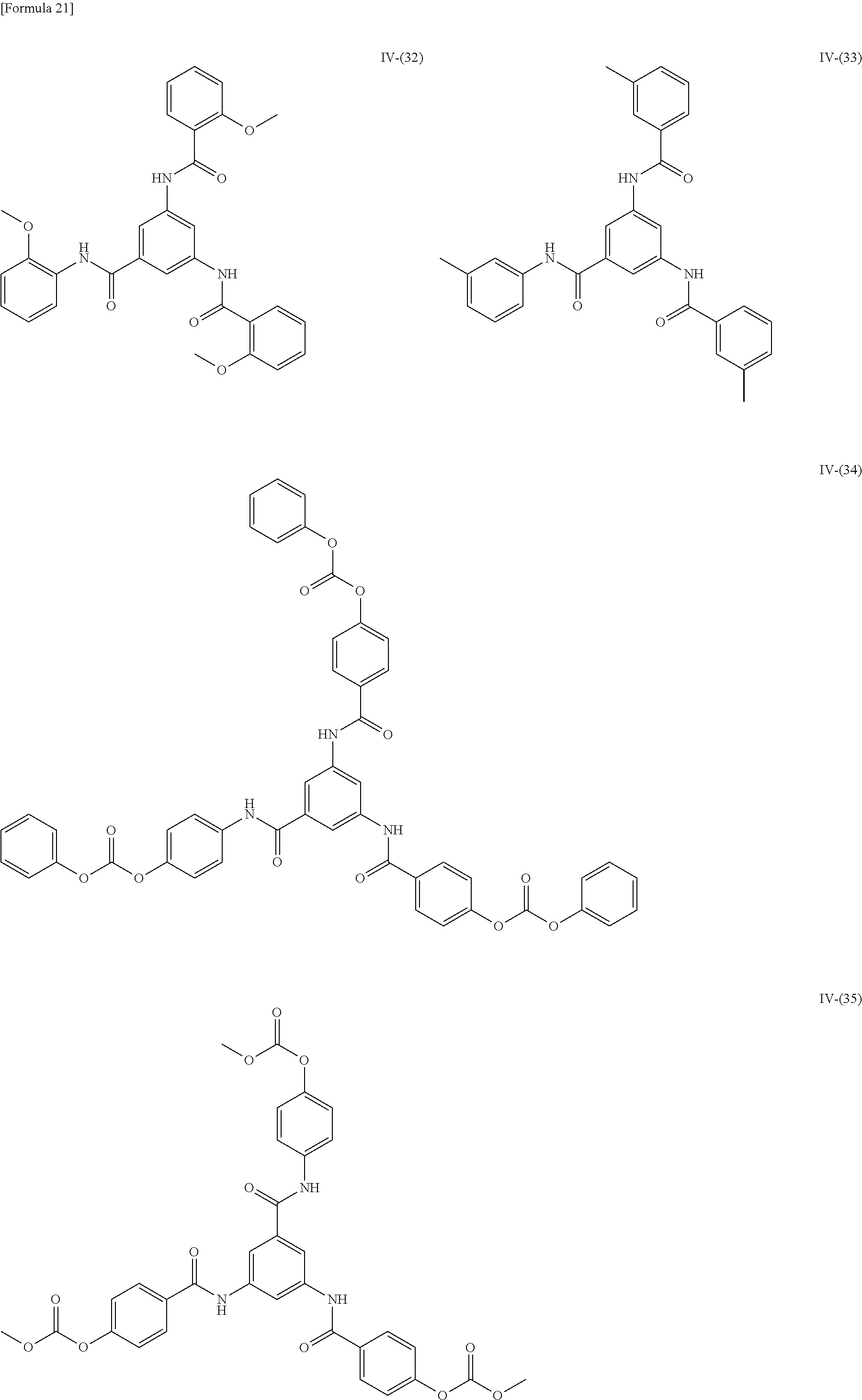

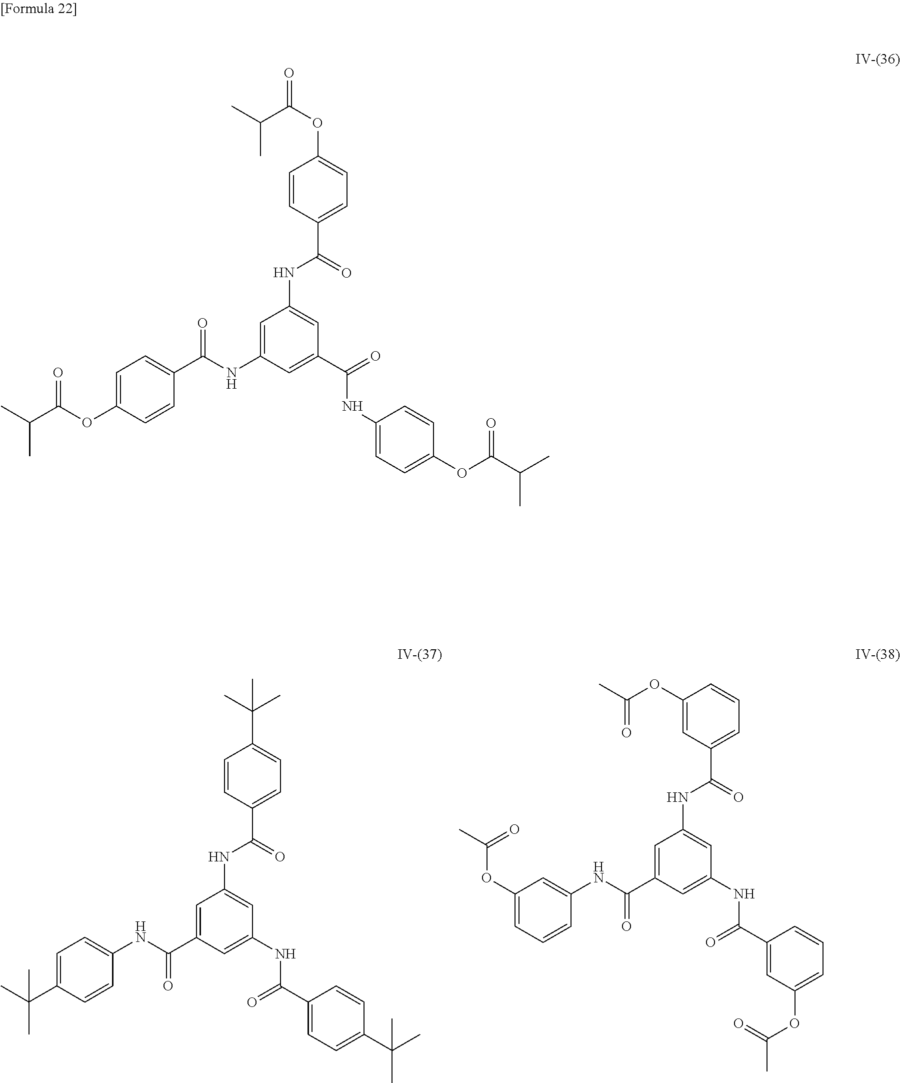

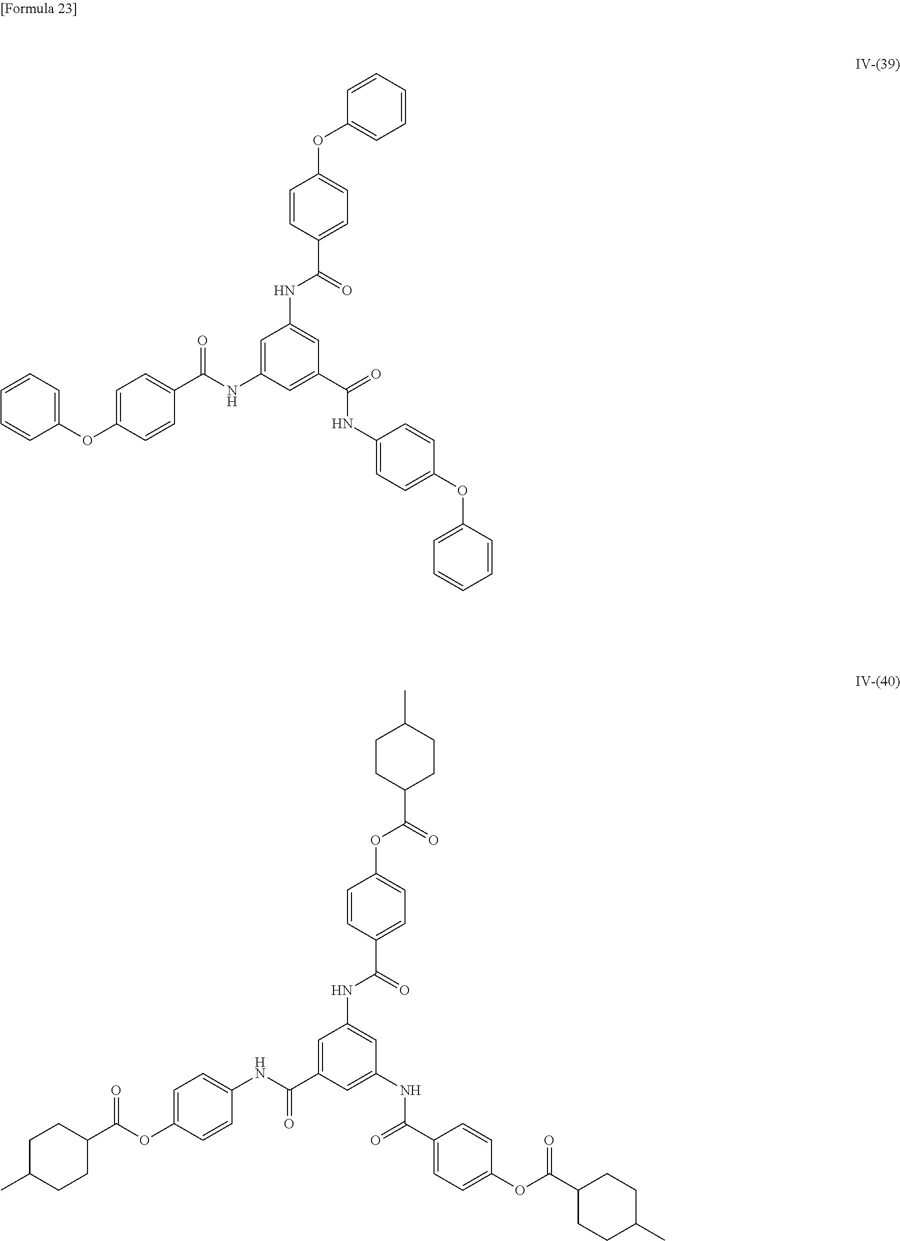

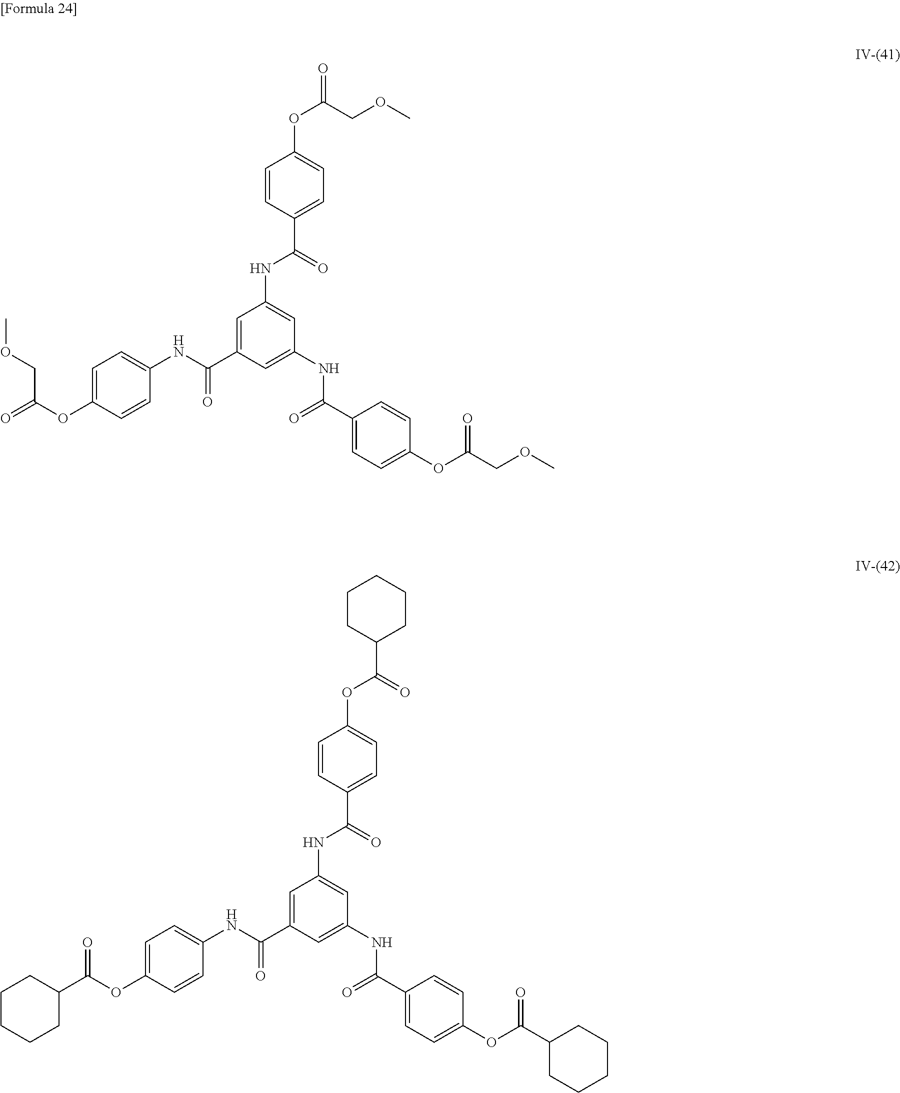 [SMILES: COCC(=O)Oc1ccc(NC(=O)c2cc(NC(=O)c3ccc(OC(=O)COC)cc3)cc(NC(=O)c3ccc(OC(=O)COC)cc3)c2)cc1 ; O=C(Nc1cc(NC(=O)c2ccc(OC(=O)C3CCCCC3)cc2)cc(C(=O)Nc2ccc(OC(=O)C3CCCCC3)cc2)c1)c1ccc(OC(=O)C2CCCCC2)cc1]

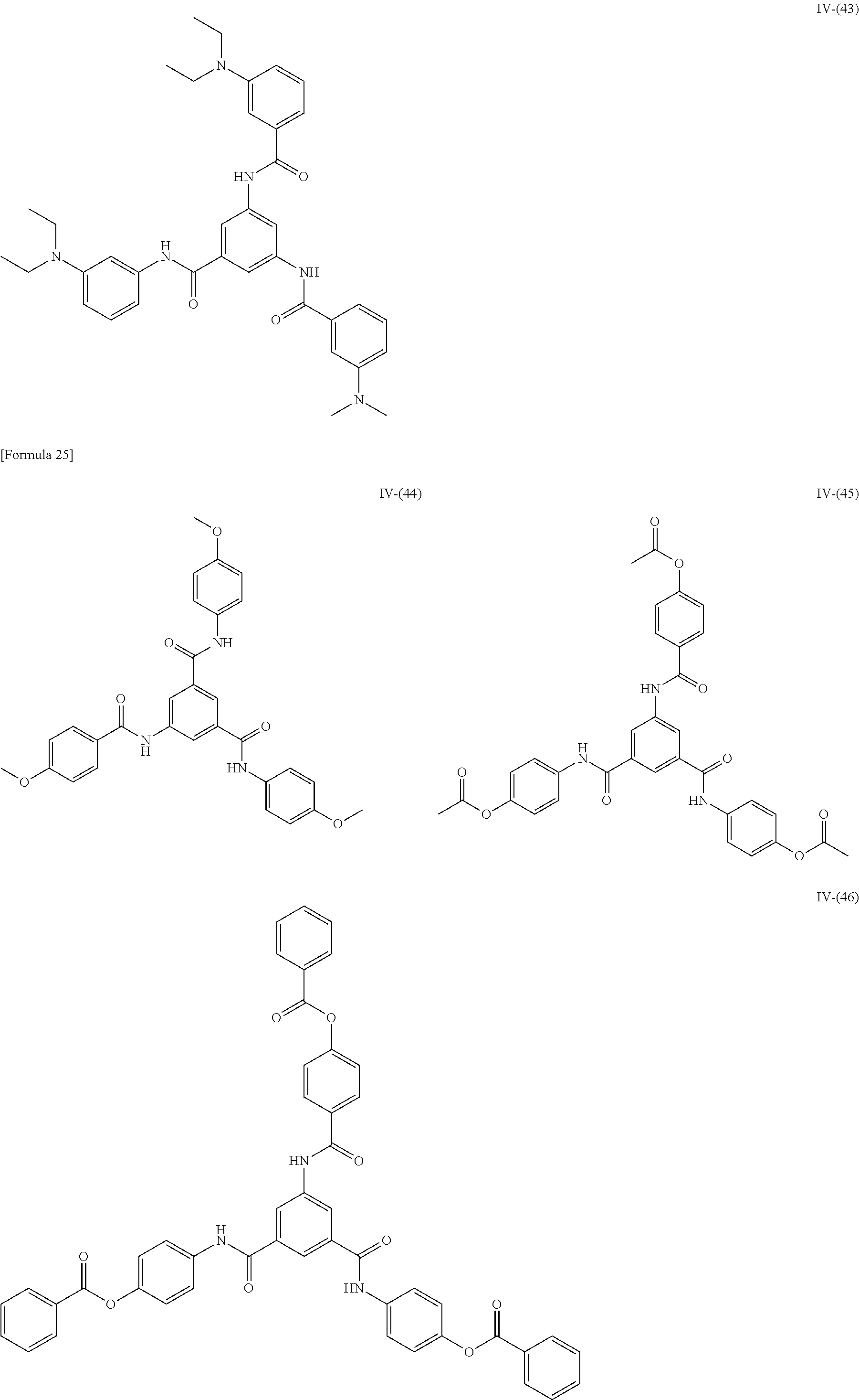

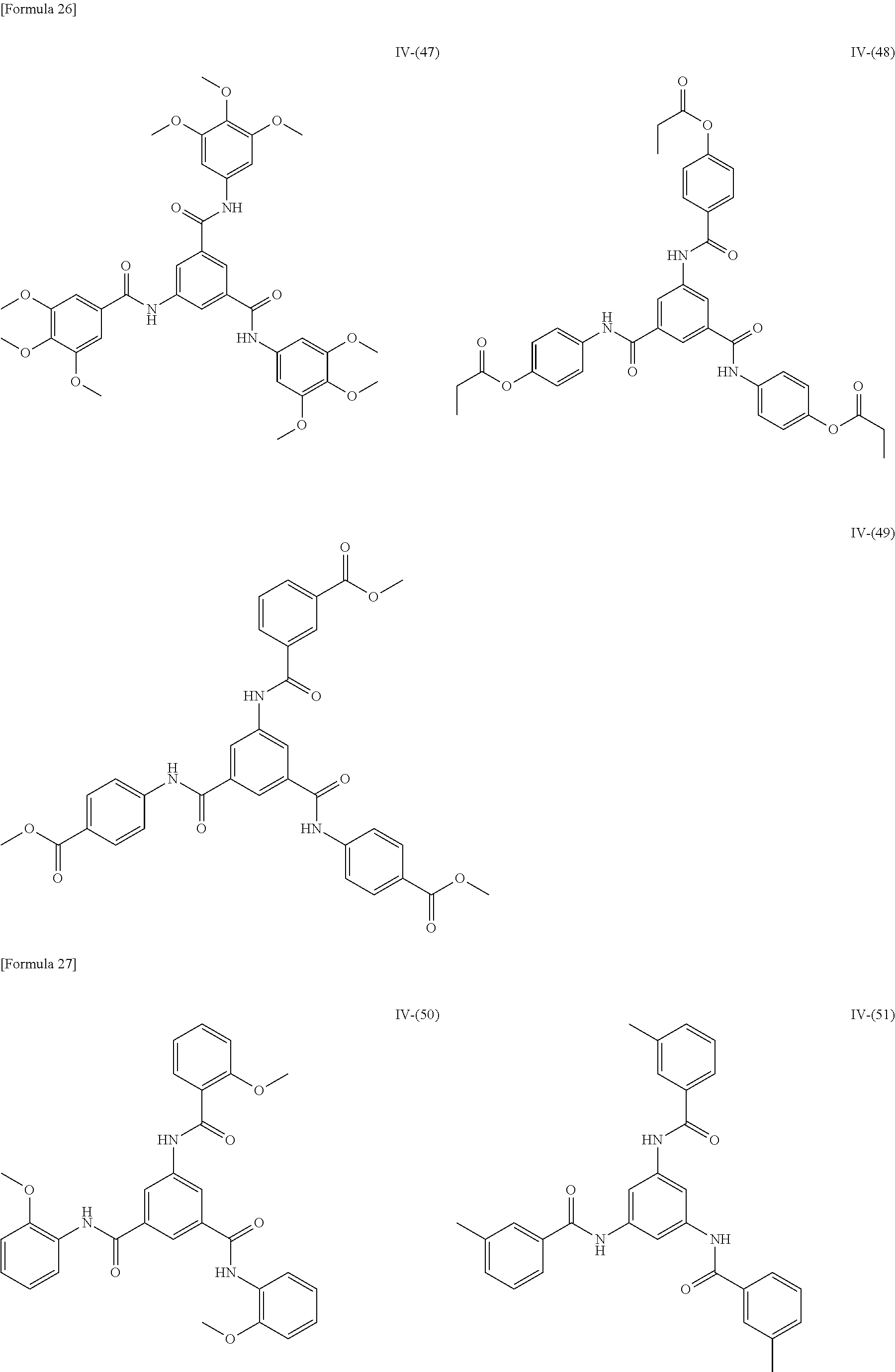

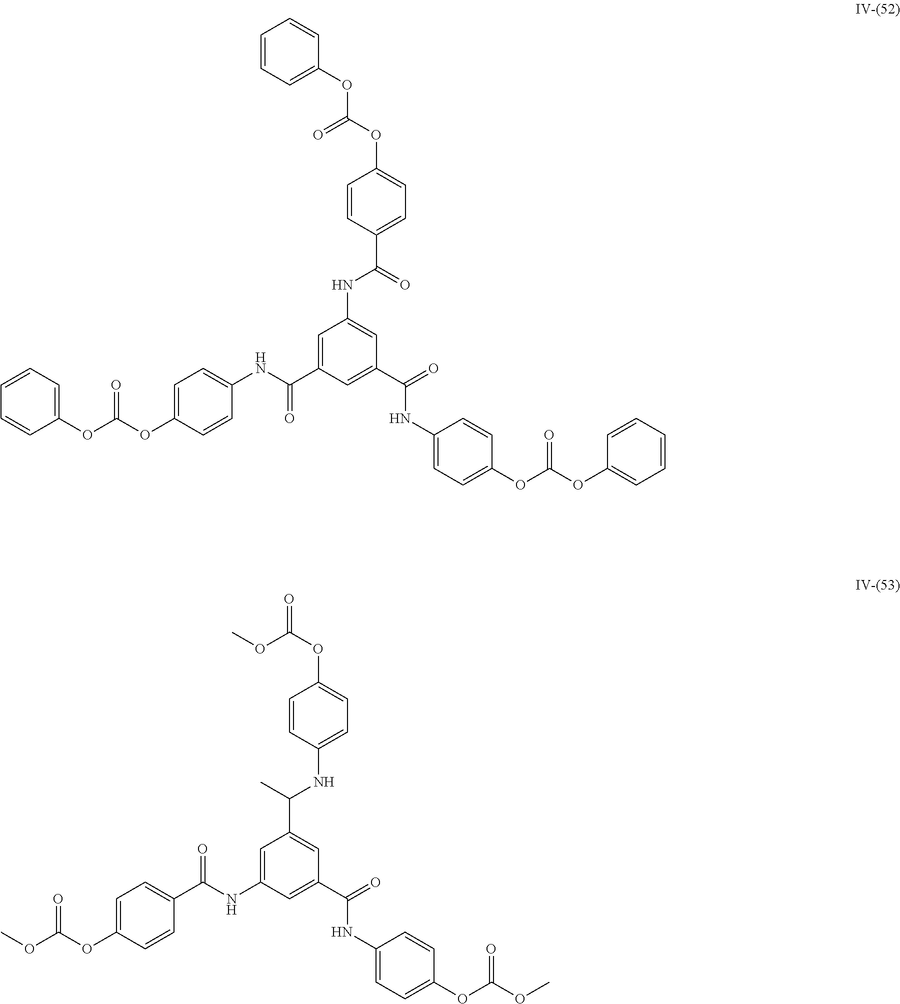

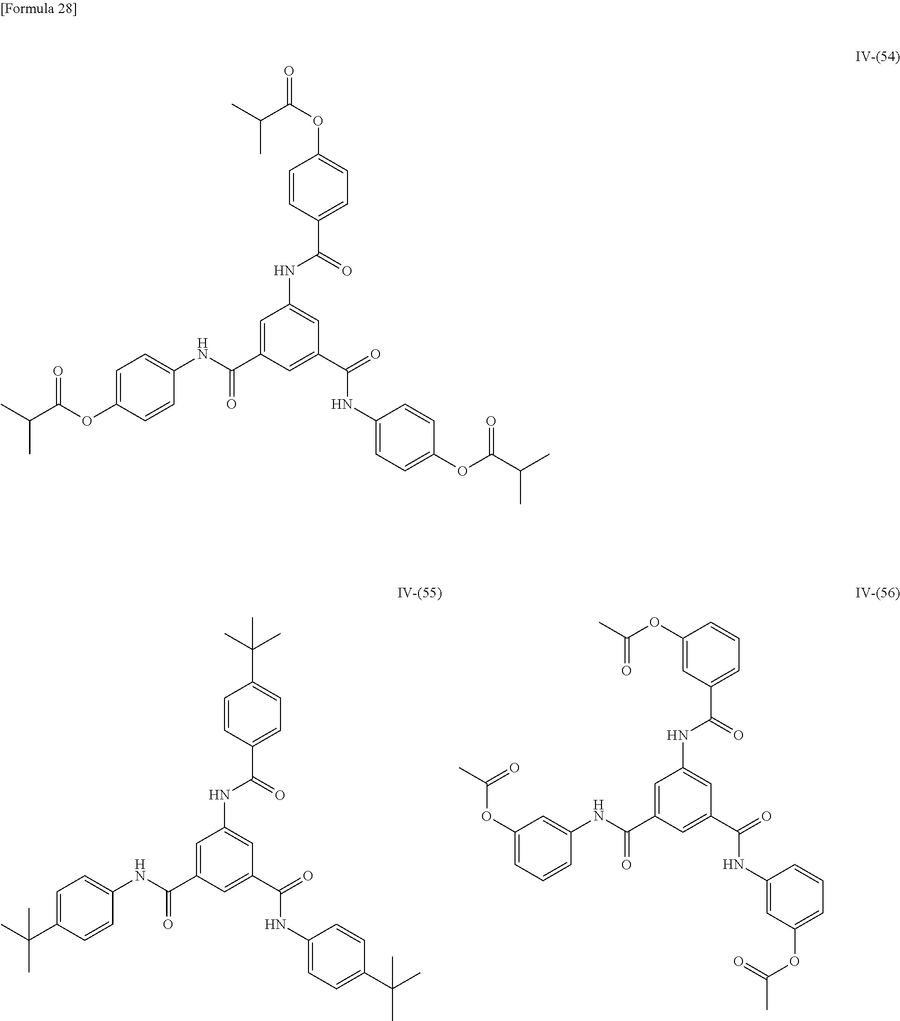

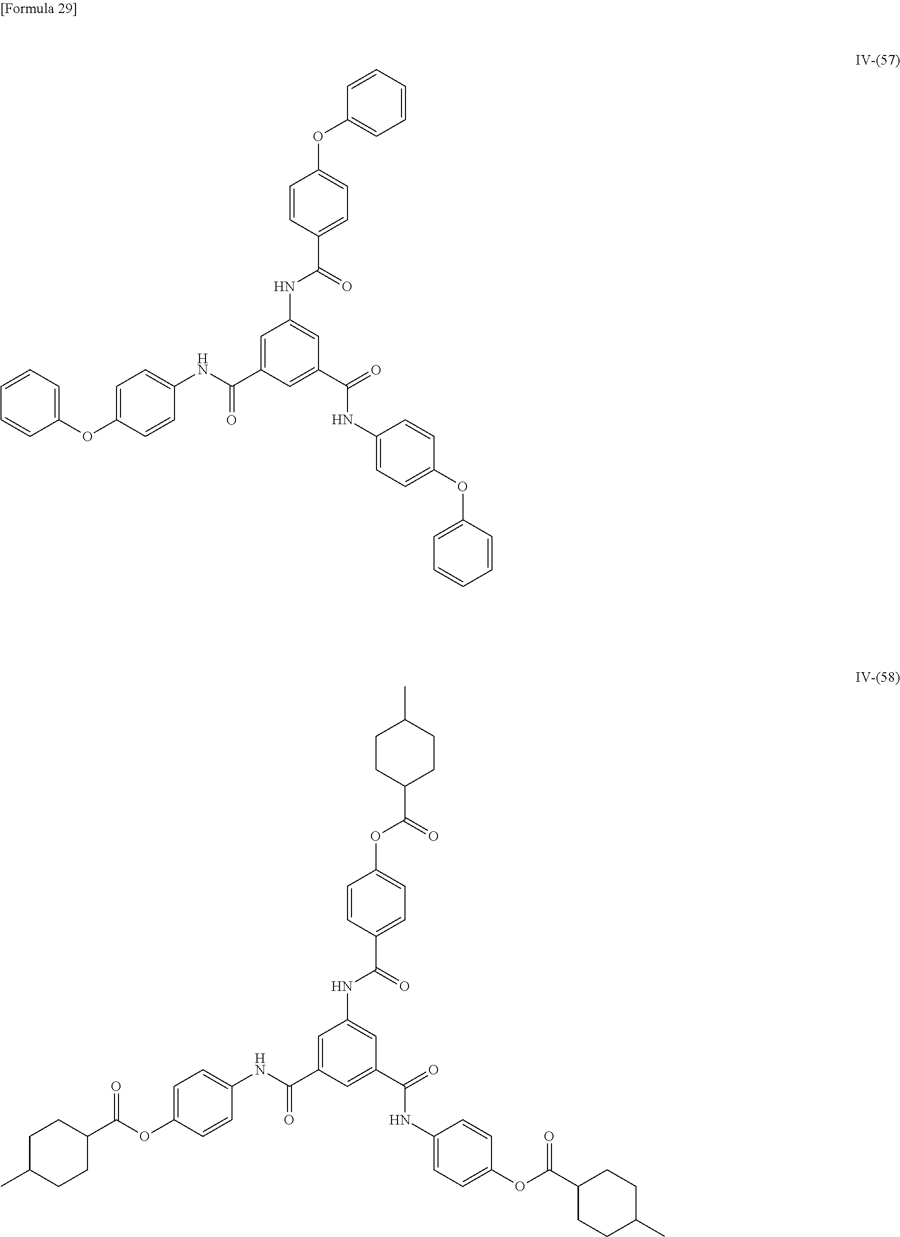

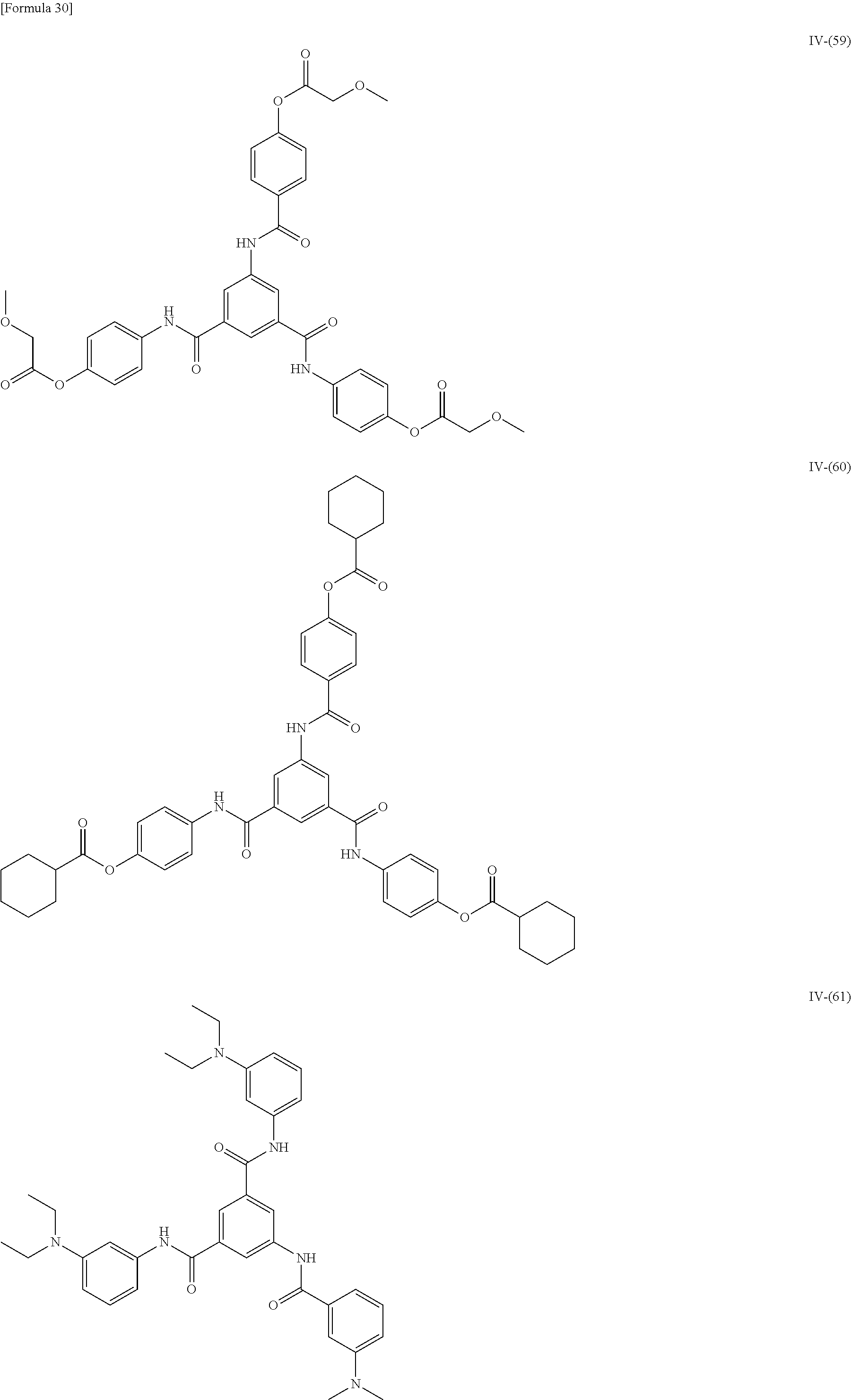

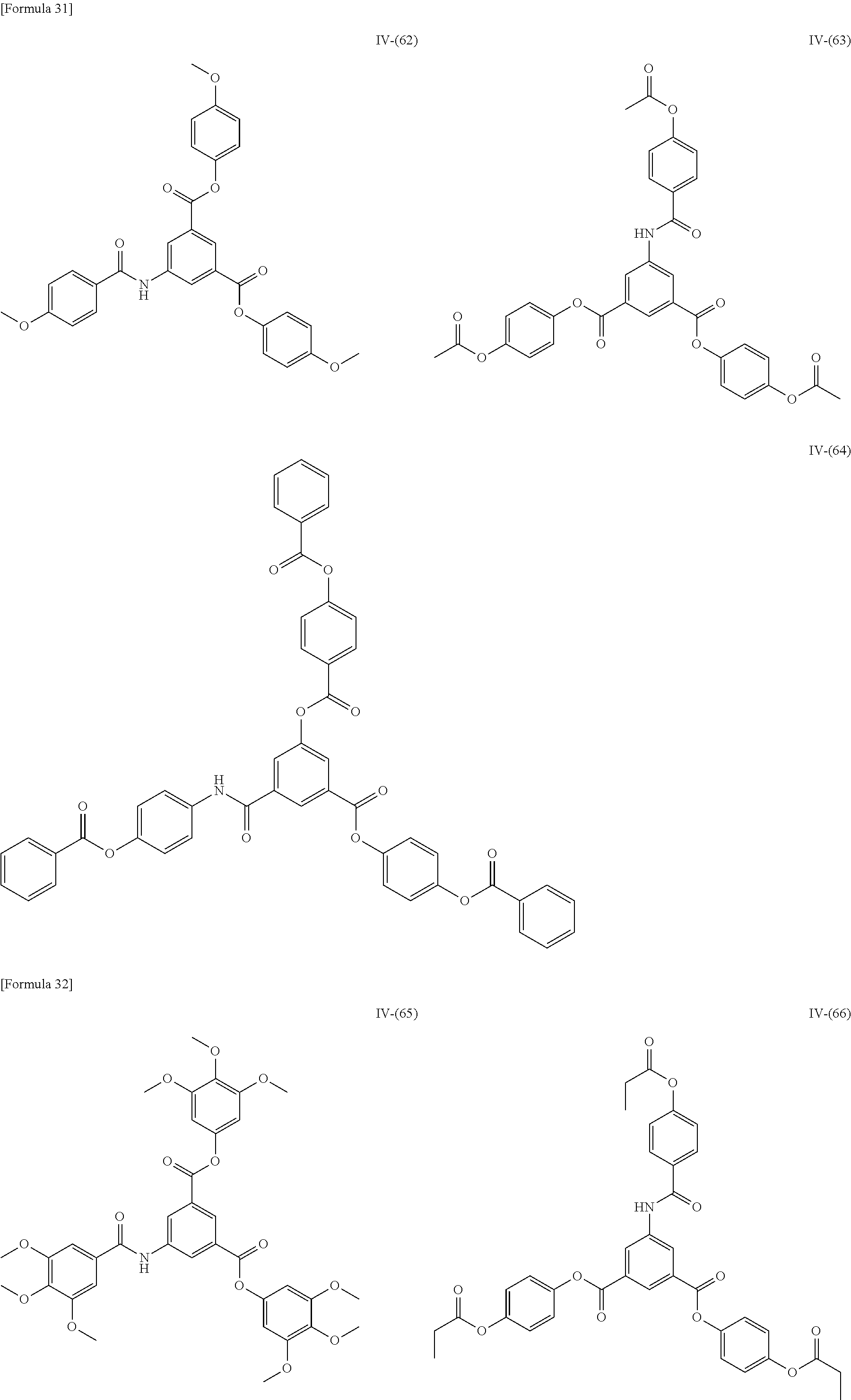

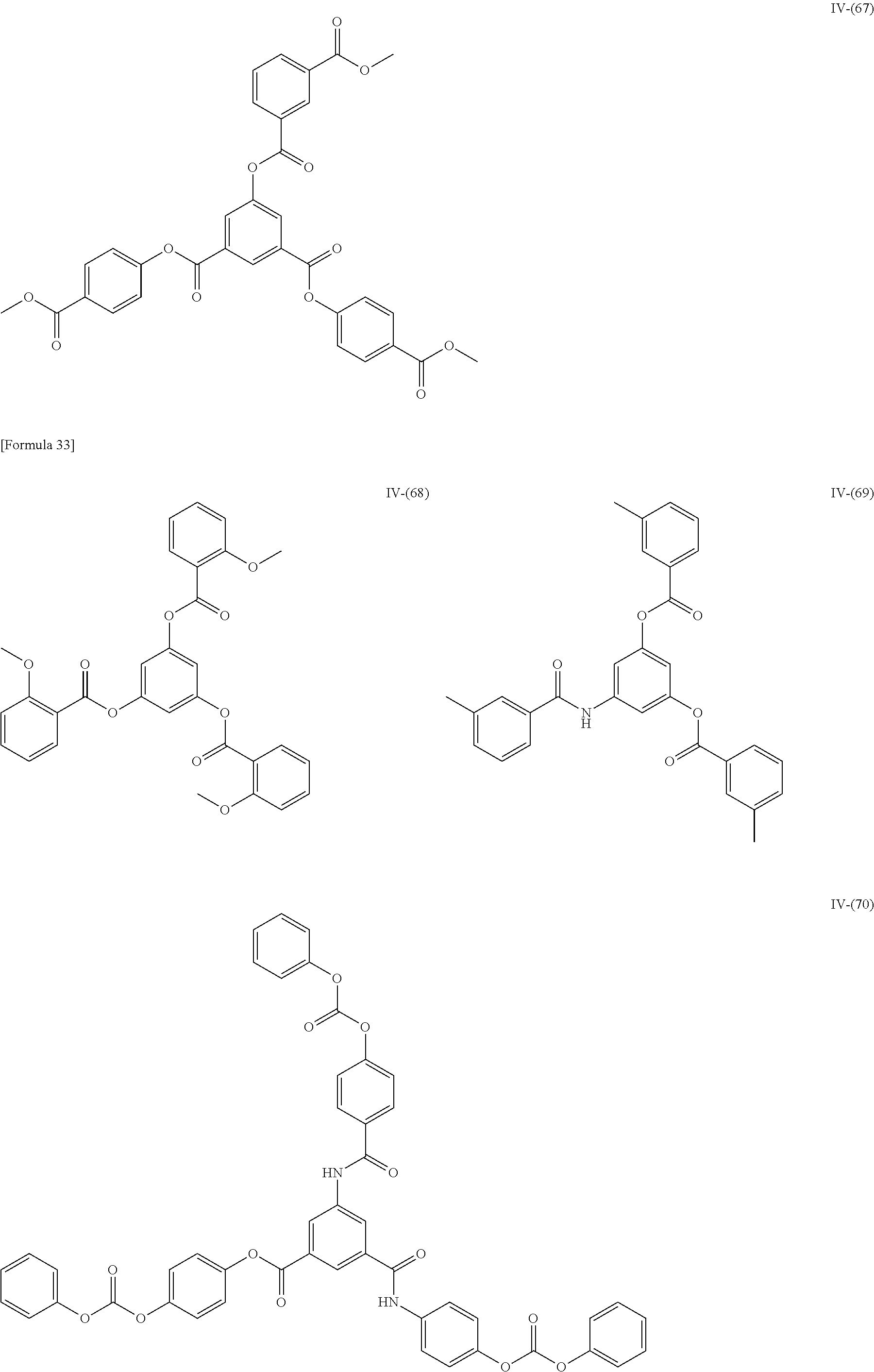

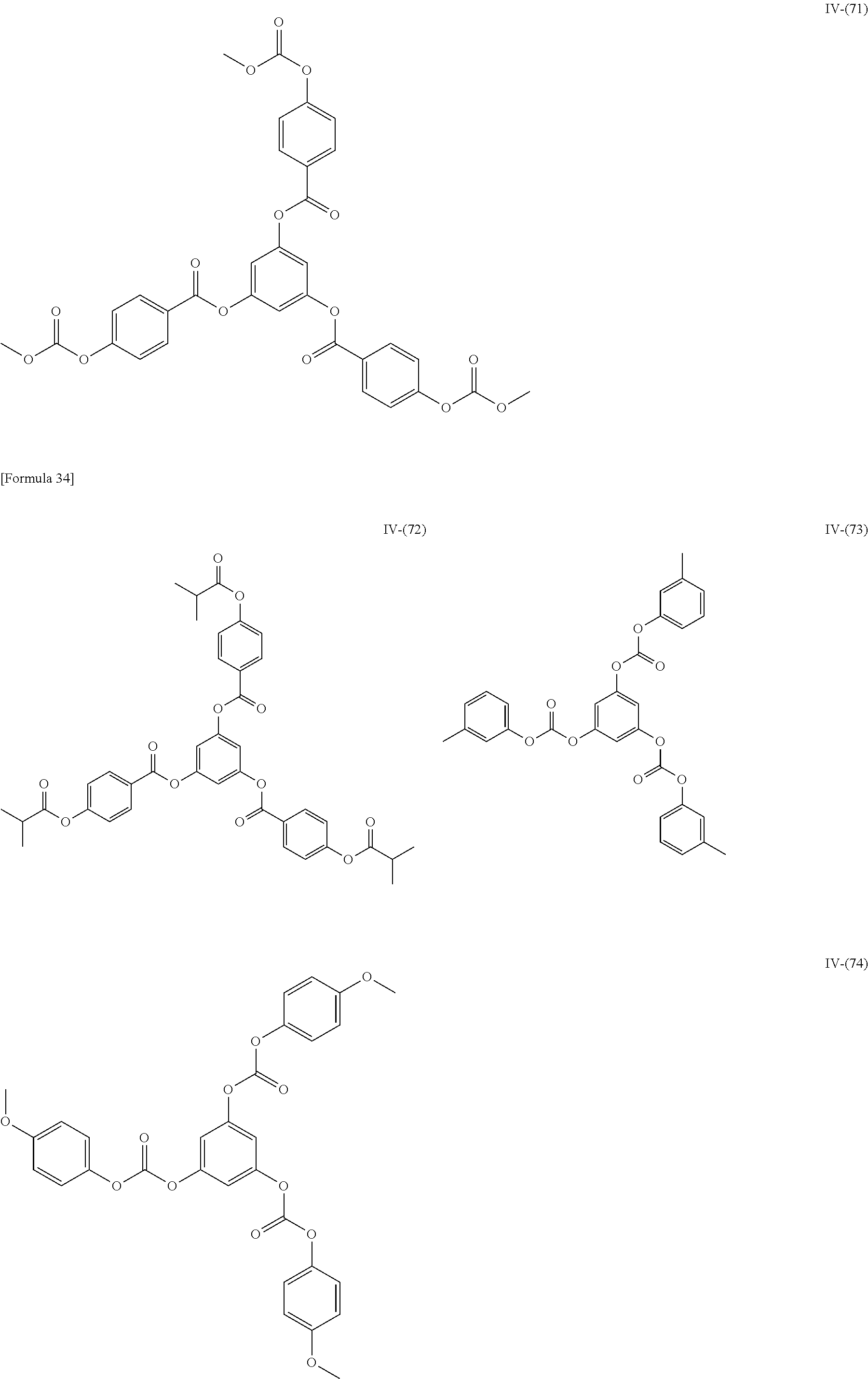

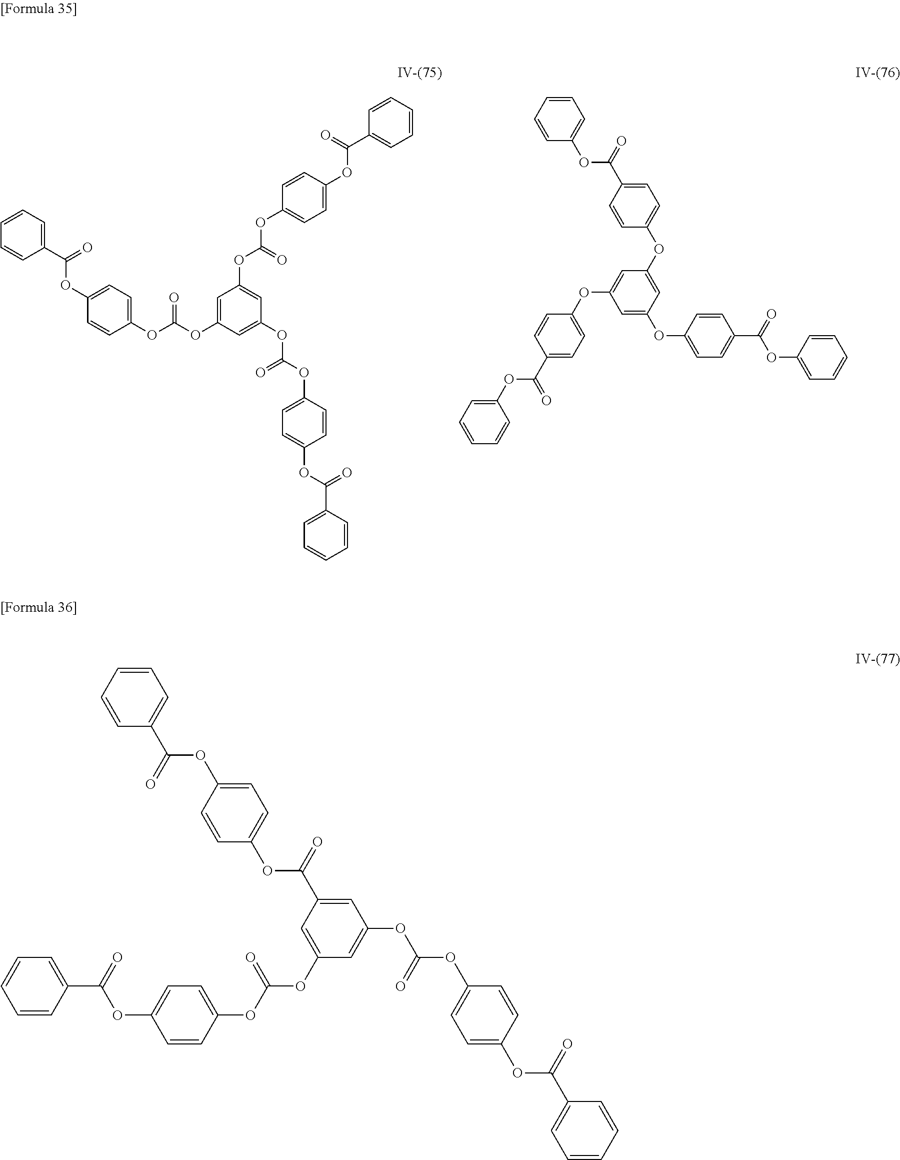 [SMILES: O=C(Oc1ccc(OC(=O)c2ccccc2)cc1)Oc1cc(OC(=O)Oc2ccc(OC(=O)c3ccccc3)cc2)cc(OC(=O)Oc2ccc(OC(=O)c3ccccc3)cc2)c1 ; O=C(Oc1ccccc1)c1ccc(Oc2cc(Oc3ccc(C(=O)Oc4ccccc4)cc3)cc(Oc3ccc(C(=O)Oc4ccccc4)cc3)c2)cc1 ; O=C(Oc1ccc(OC(=O)c2ccccc2)cc1)Oc1cc(OC(=O)Oc2ccc(OC(=O)c3ccccc3)cc2)cc(C(=O)Oc2ccc(OC(=O)c3ccccc3)cc2)c1]

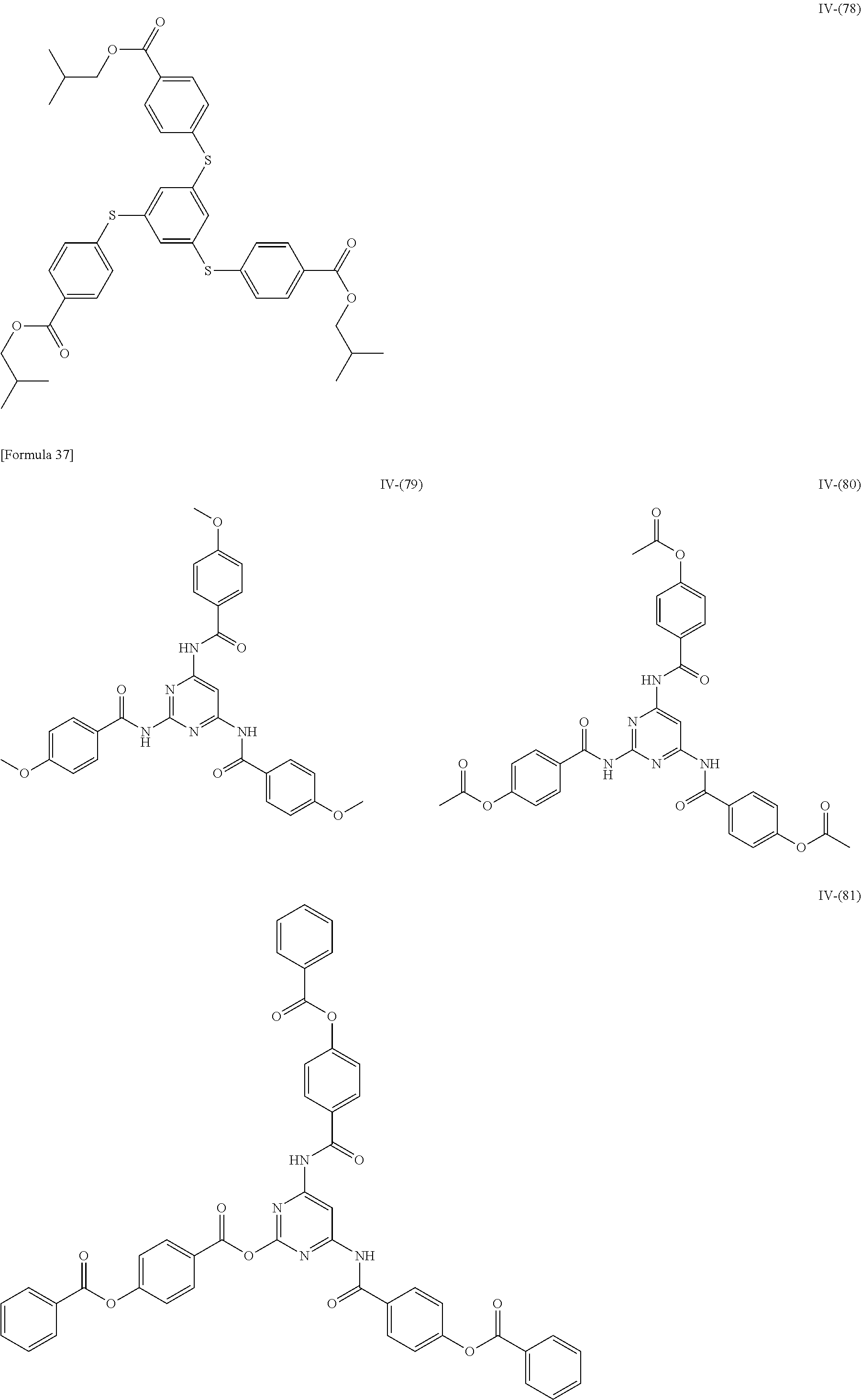

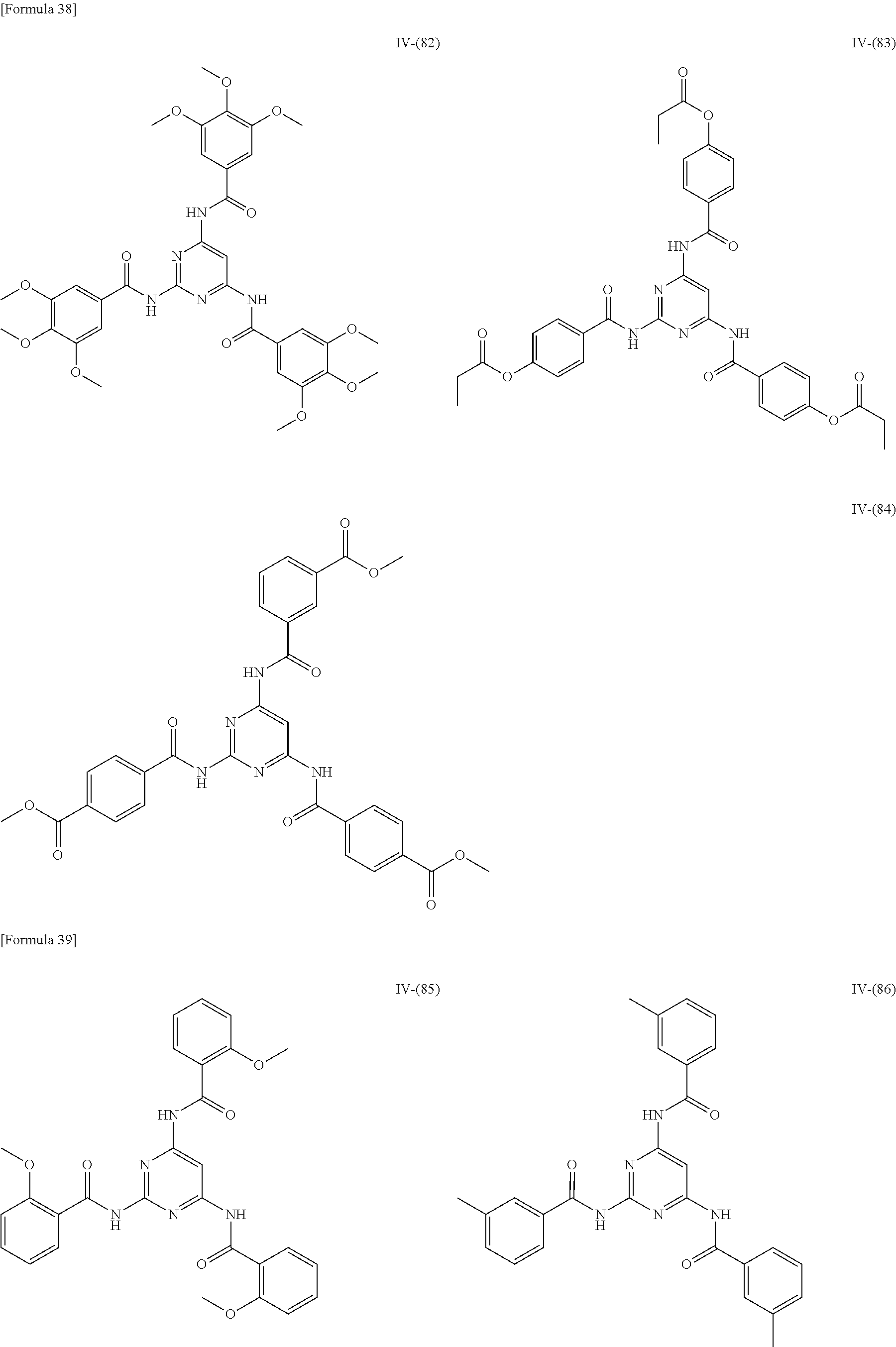

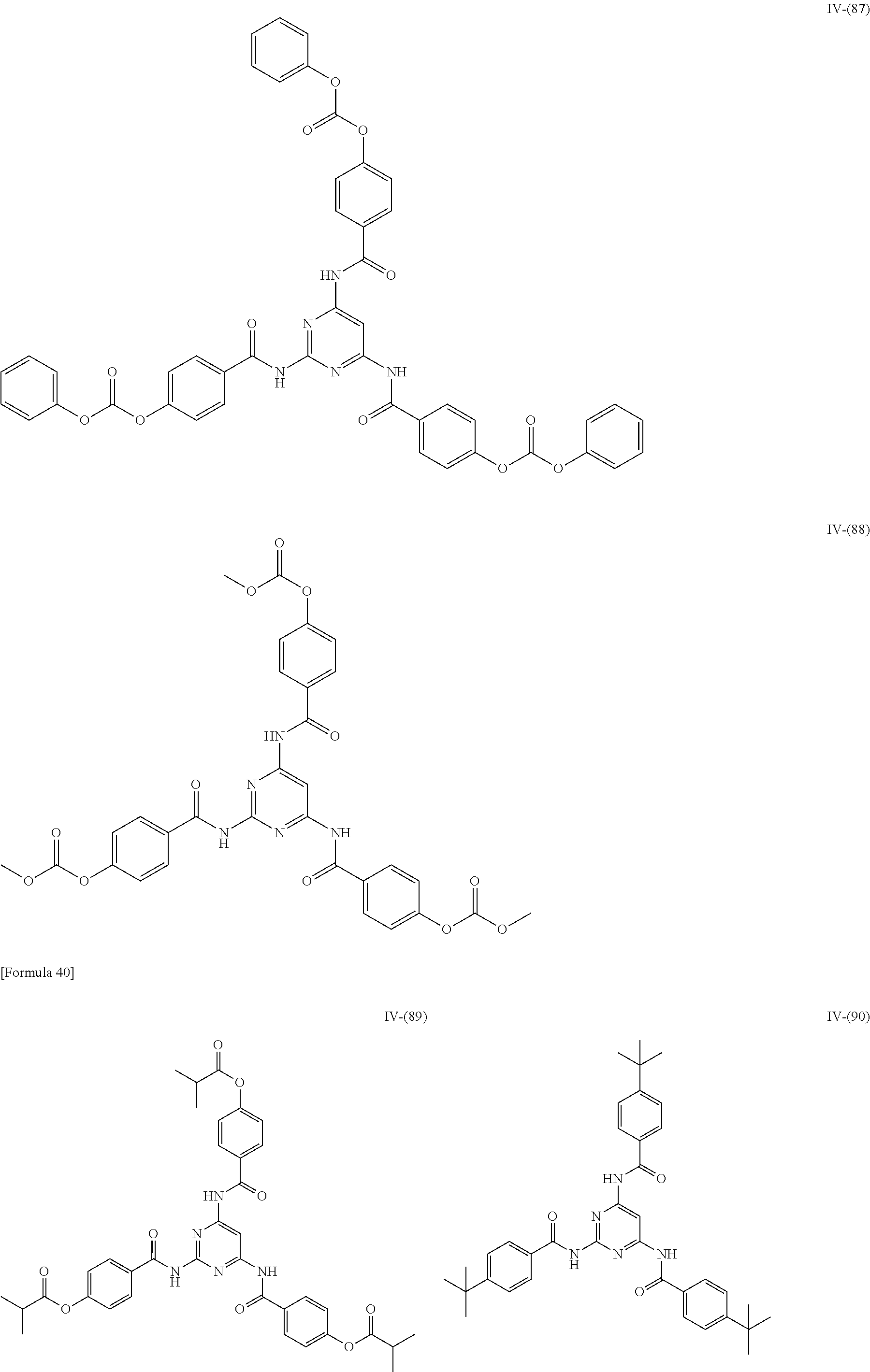

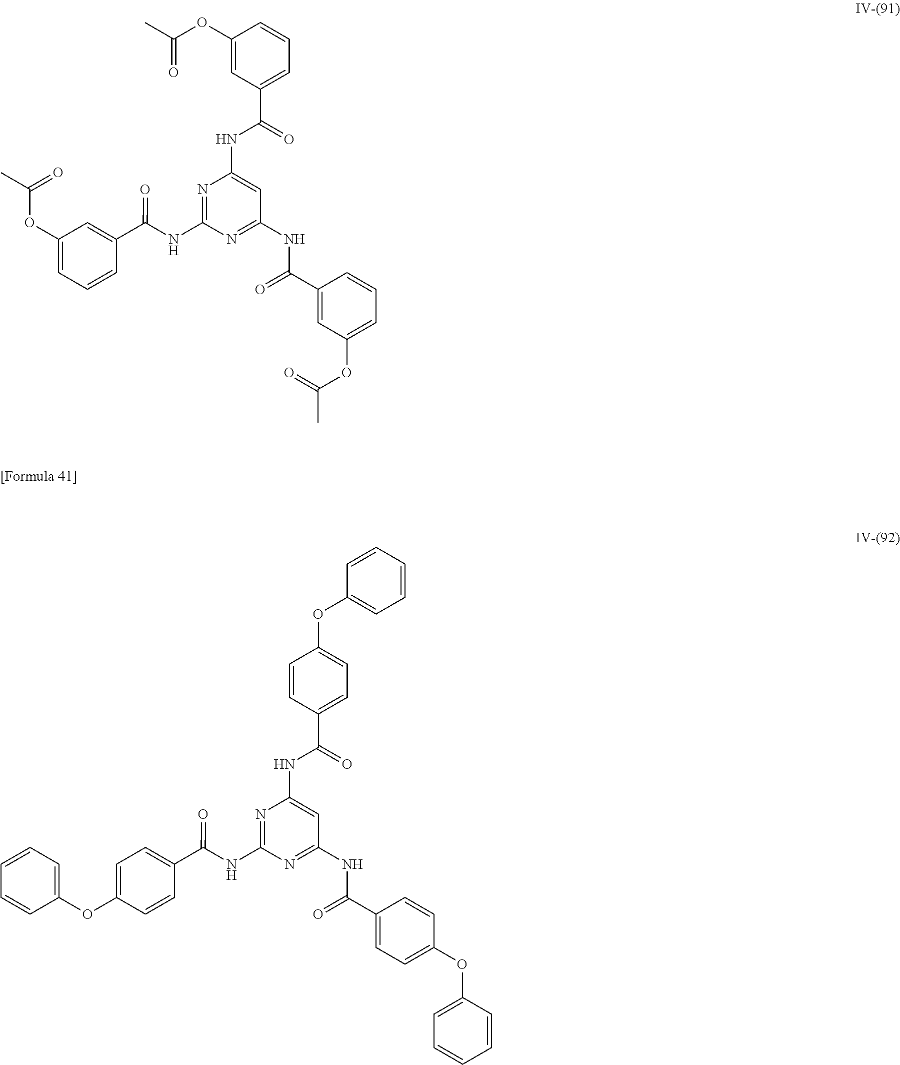 [SMILES: CC(=O)Oc1cccc(C(=O)Nc2cc(NC(=O)c3cccc(OC(C)=O)c3)nc(NC(=O)c3cccc(OC(C)=O)c3)n2)c1 ; O=C(Nc1cc(NC(=O)c2ccc(Oc3ccccc3)cc2)nc(NC(=O)c2ccc(Oc3ccccc3)cc2)n1)c1ccc(Oc2ccccc2)cc1]

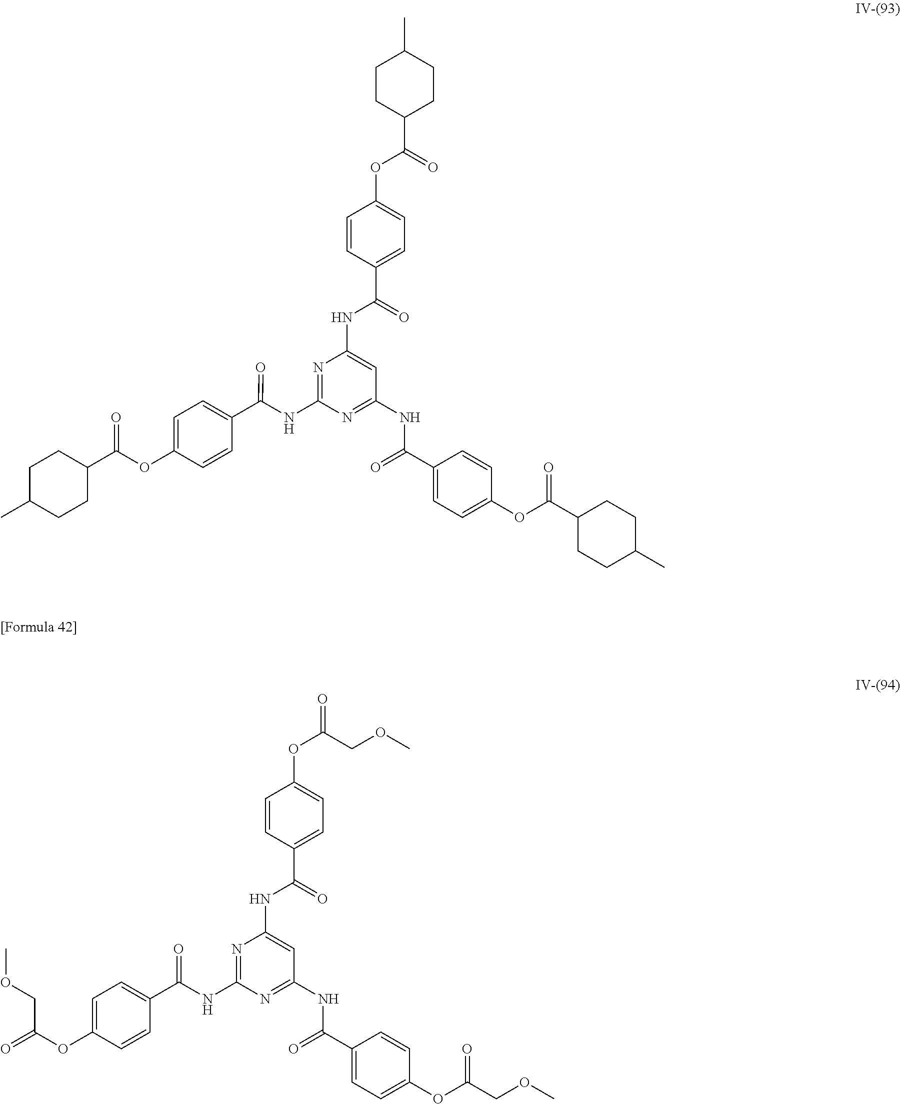

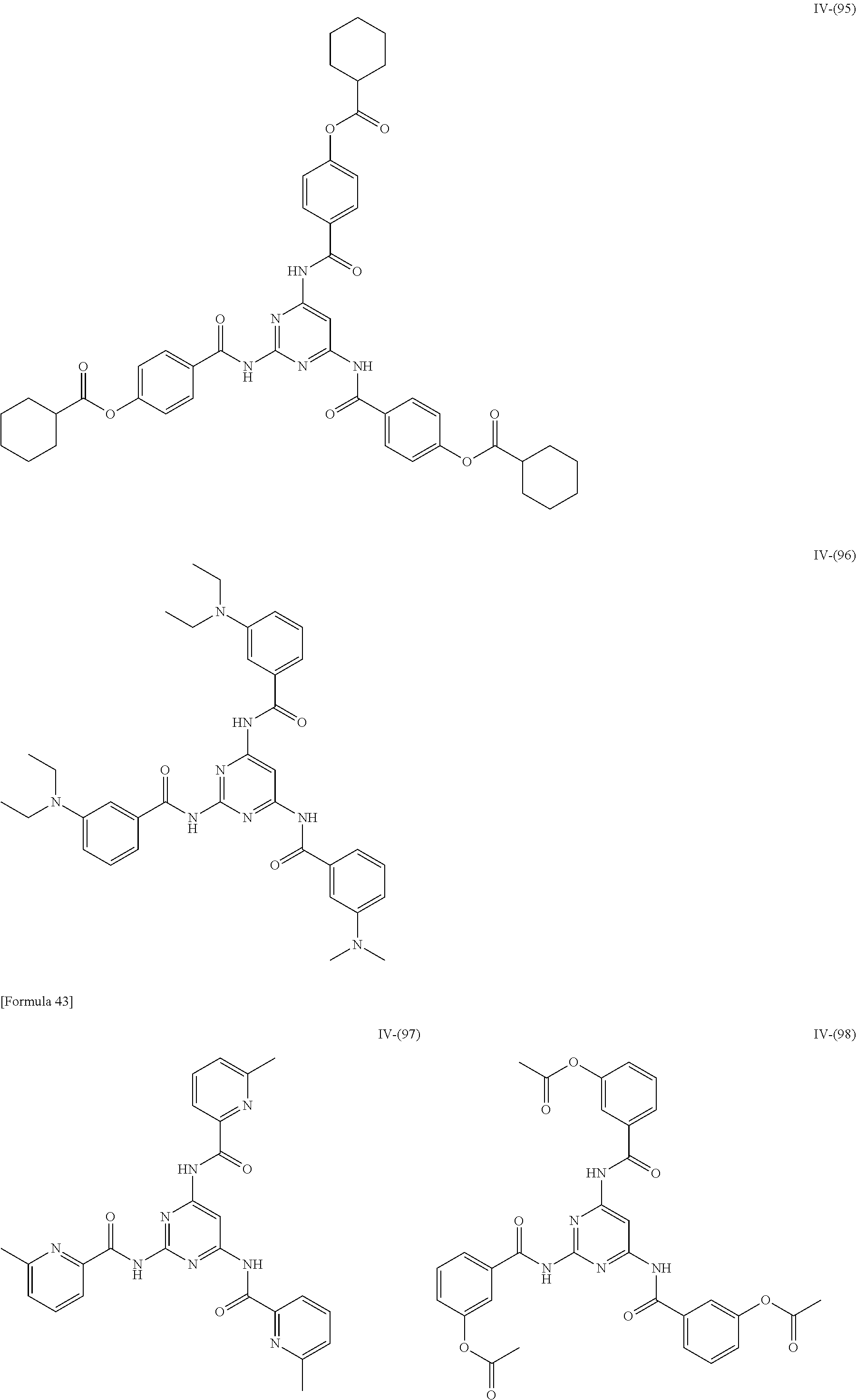 [SMILES: O=C(Nc1cc(NC(=O)c2ccc(OC(=O)C3CCCCC3)cc2)nc(NC(=O)c2ccc(OC(=O)C3CCCCC3)cc2)n1)c1ccc(OC(=O)C2CCCCC2)cc1 ; CCN(CC)c1cccc(C(=O)Nc2cc(NC(=O)c3cccc(N(C)C)c3)nc(NC(=O)c3cccc(N(CC)CC)c3)n2)c1 ; Cc1cccc(C(=O)Nc2cc(NC(=O)c3cccc(C)n3)nc(NC(=O)c3cccc(C)n3)n2)n1 ; CC(=O)Oc1cccc(C(=O)Nc2cc(NC(=O)c3cccc(OC(C)=O)c3)nc(NC(=O)c3cccc(OC(C)=O)c3)n2)c1]

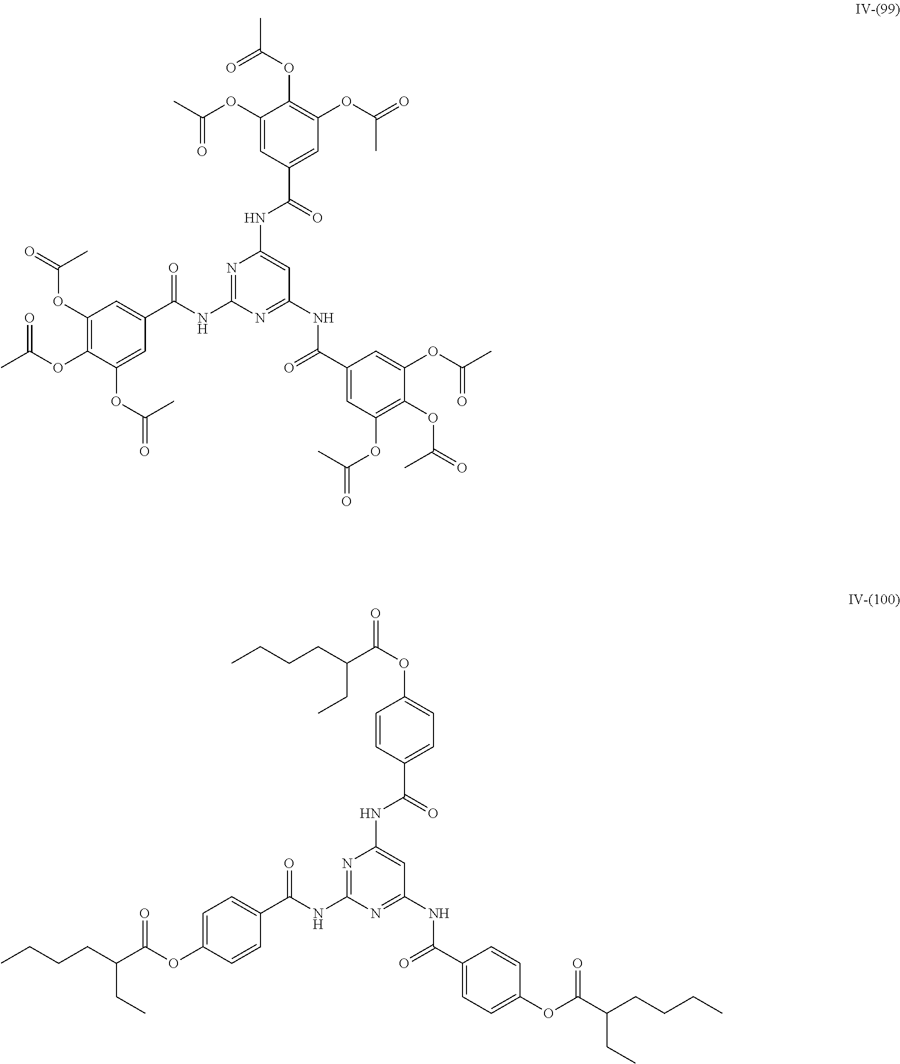

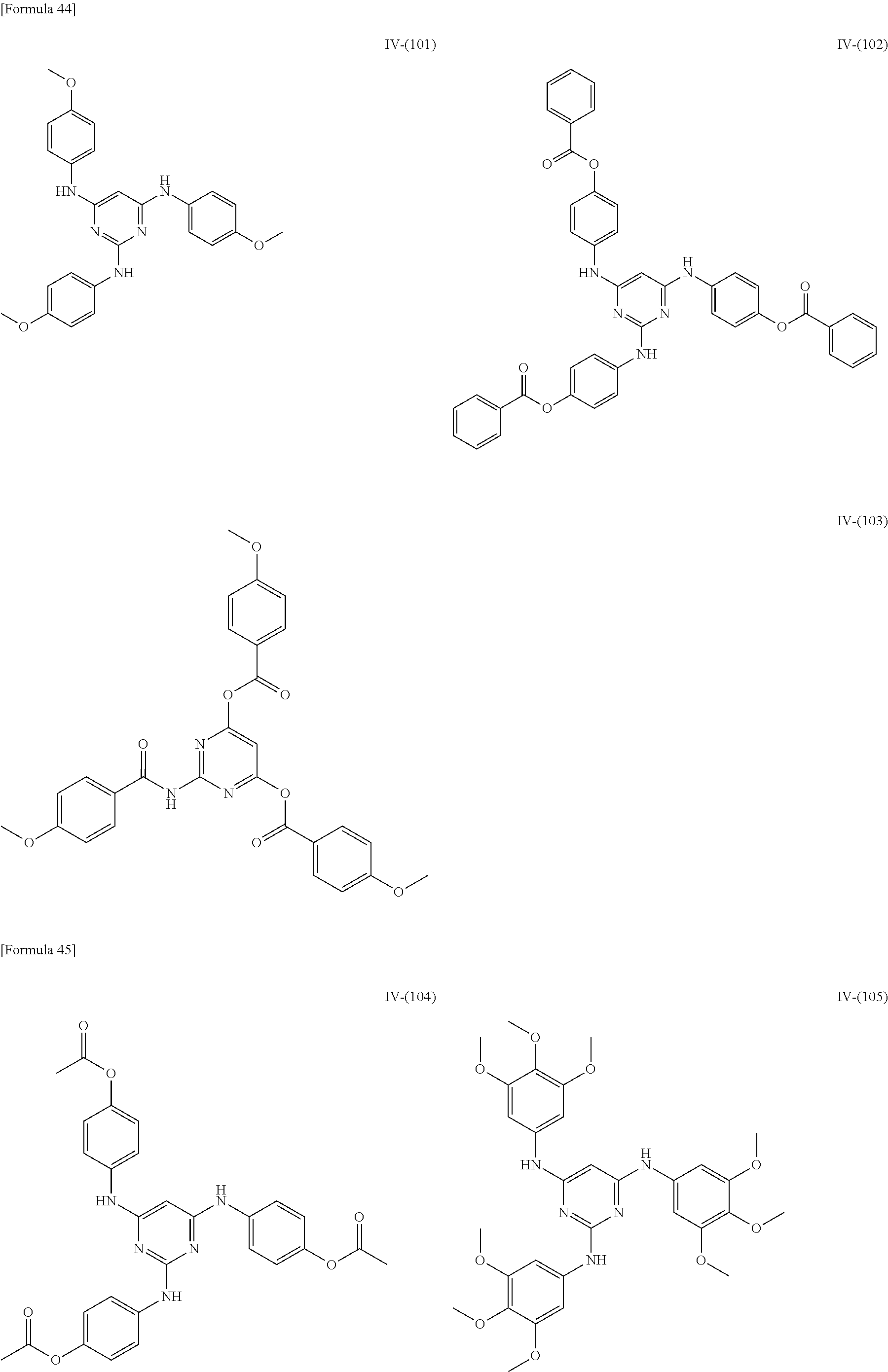

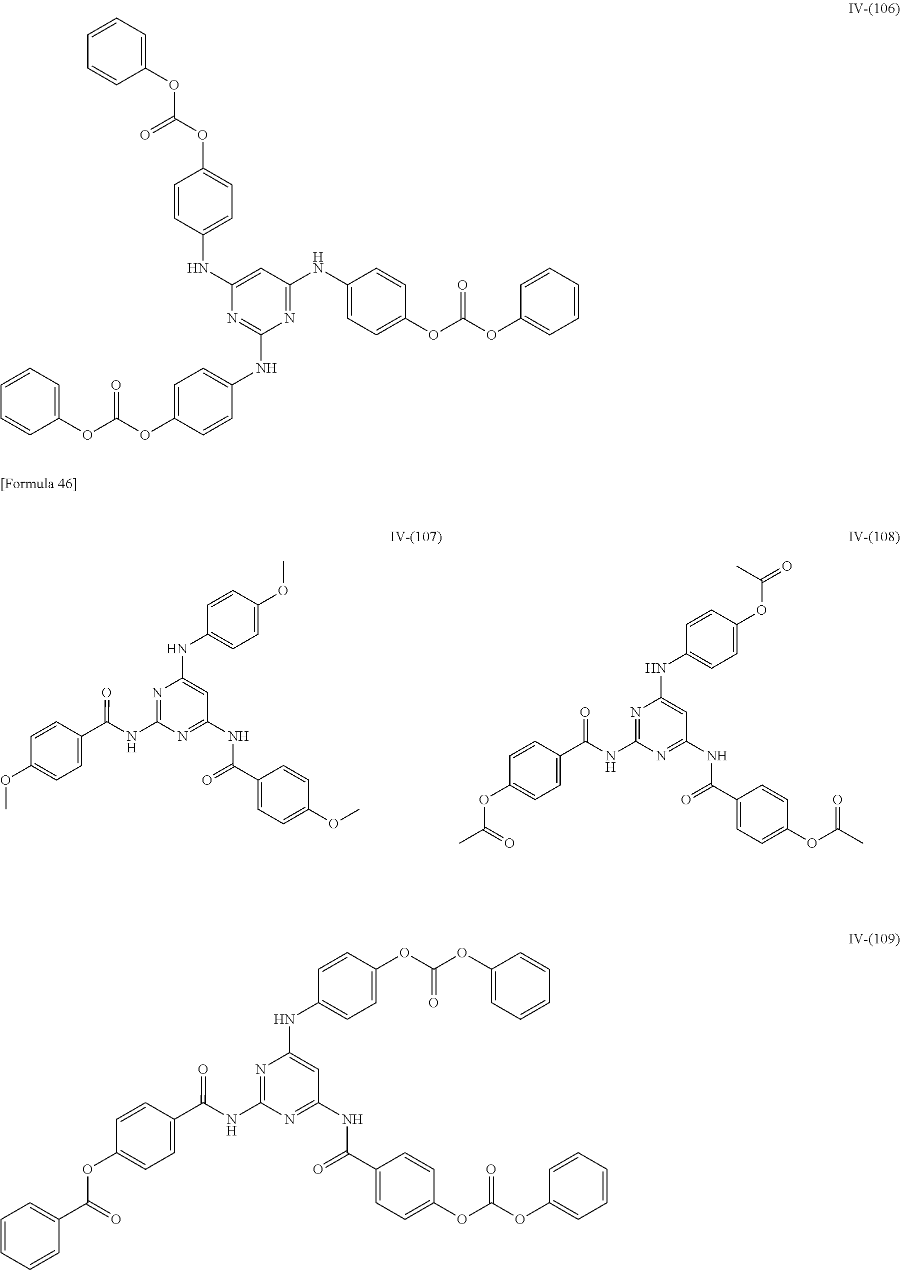 [SMILES: O=C(Oc1ccccc1)Oc1ccc(Nc2cc(Nc3ccc(OC(=O)Oc4ccccc4)cc3)nc(Nc3ccc(OC(=O)Oc4ccccc4)cc3)n2)cc1 ; COc1ccc(Nc2cc(NC(=O)c3ccc(OC)cc3)nc(NC(=O)c3ccc(OC)cc3)n2)cc1 ; CC(=O)Oc1ccc(Nc2cc(NC(=O)c3ccc(OC(C)=O)cc3)nc(NC(=O)c3ccc(OC(C)=O)cc3)n2)cc1 ; O=C(Oc1ccccc1)Oc1ccc(Nc2cc(NC(=O)c3ccc(OC(=O)Oc4ccccc4)cc3)nc(NC(=O)c3ccc(OC(=O)c4ccccc4)cc3)n2)cc1]

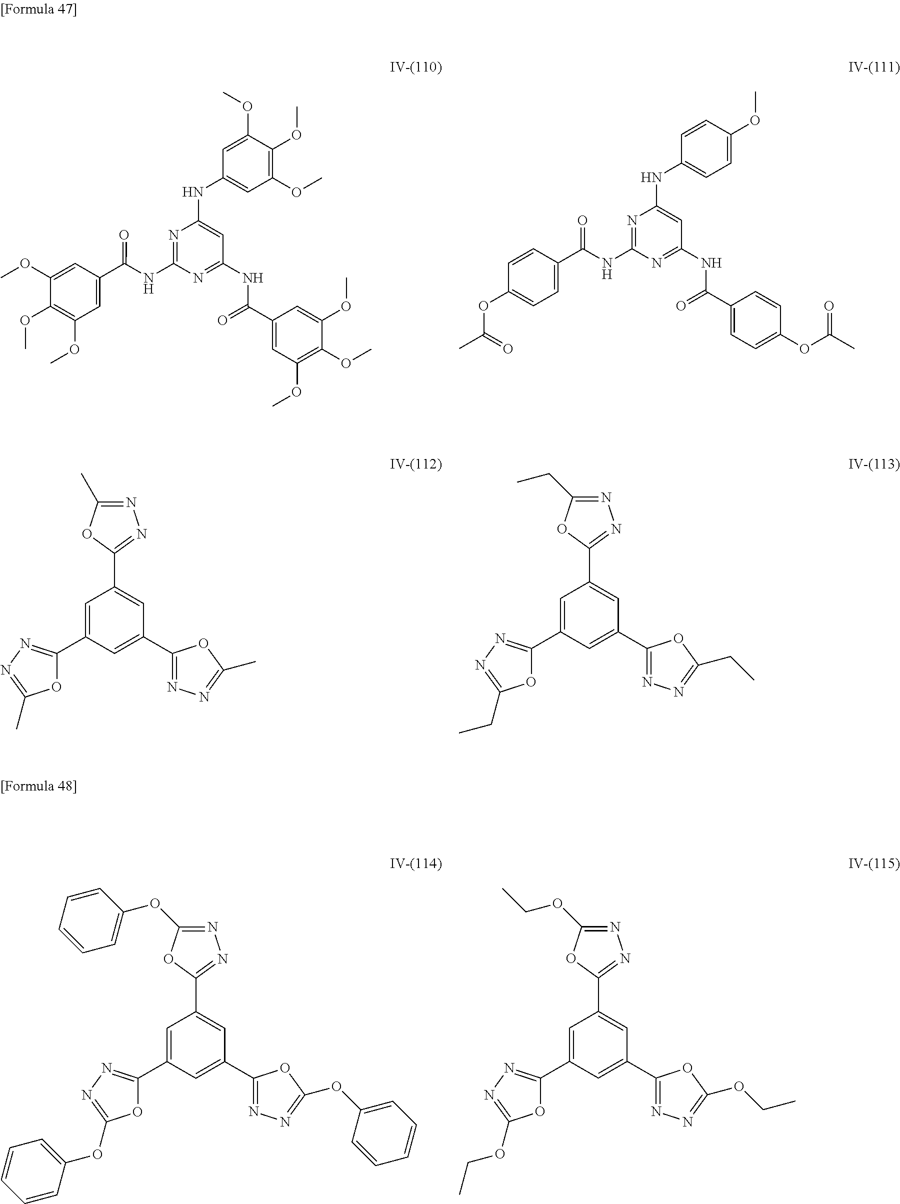

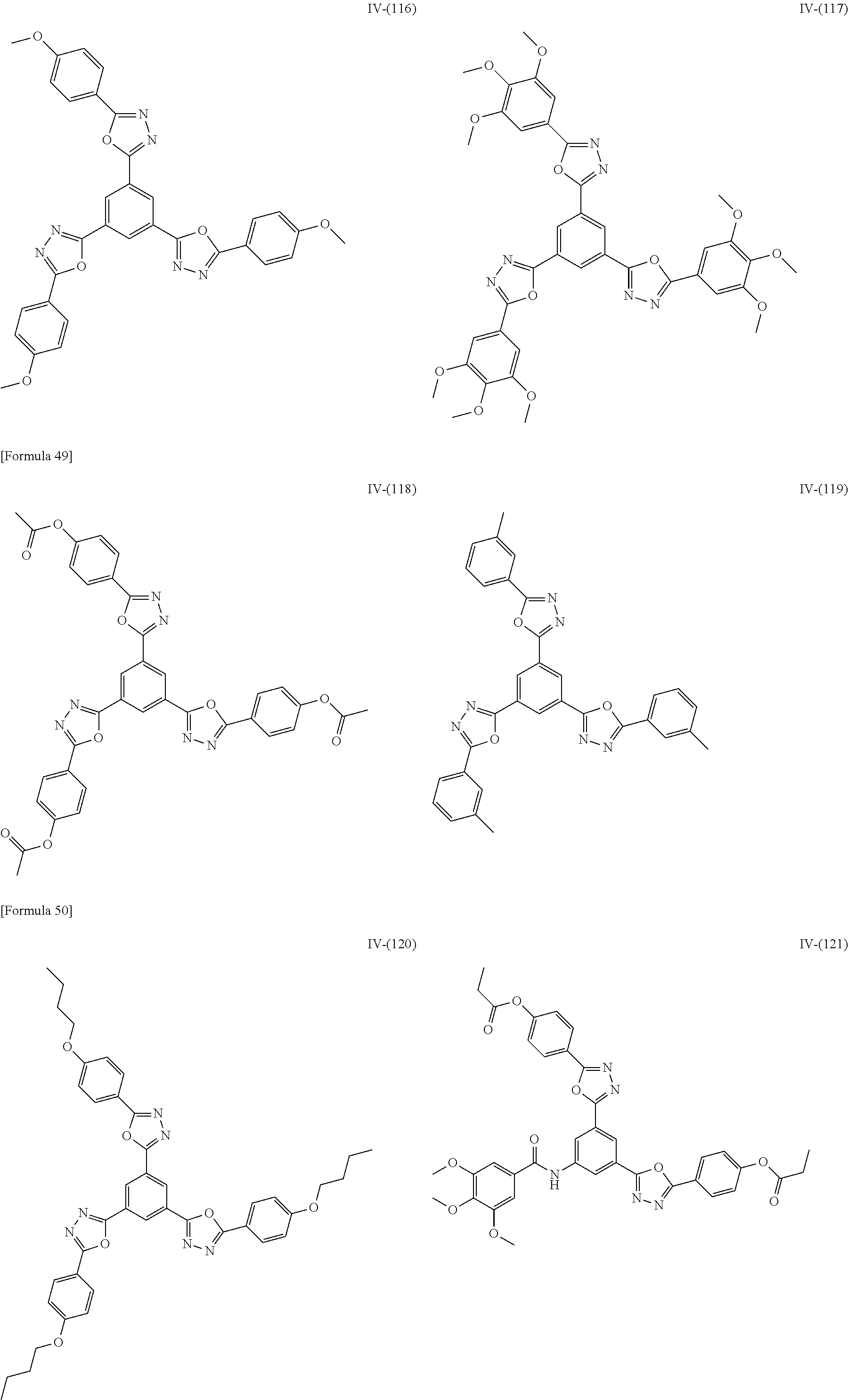

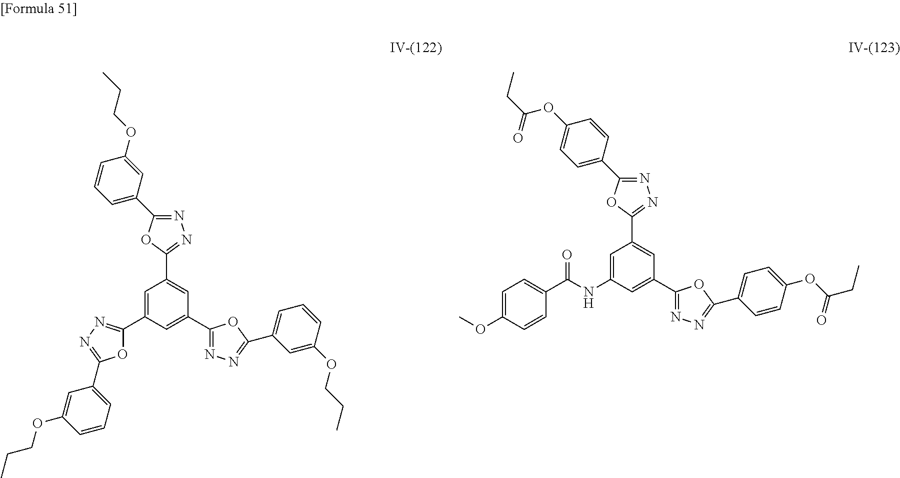 [SMILES: CCCOc1cccc(-c2nnc(-c3cc(-c4nnc(-c5cccc(OCCC)c5)o4)cc(-c4nnc(-c5cccc(OCCC)c5)o4)c3)o2)c1 ; CCC(=O)Oc1ccc(-c2nnc(-c3cc(NC(=O)c4ccc(OC)cc4)cc(-c4nnc(-c5ccc(OC(=O)CC)cc5)o4)c3)o2)cc1]

The compound represented by Formula (IV) can be prepared by any standard method. For example, the compound can be prepared by the following process.

### Synthetic Example of Exemplified Compound IV-(3)

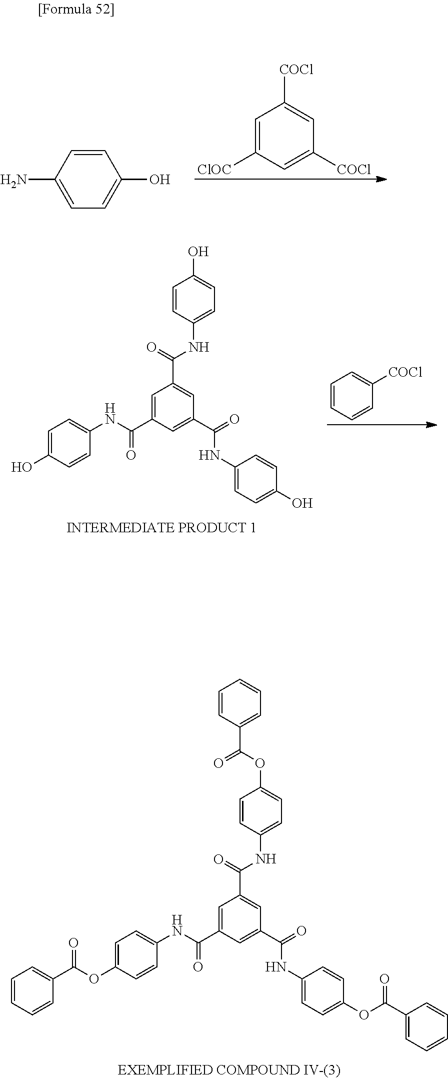

Para-aminophenol (8.57 g), pyridine (6.3 g), and dimethylacetamide (50 ml) were placed in a 200 ml eggplant-shaped flask, and were stirred at 0° C. After 1,3,5-benzenetricarbonyl trichloride (5.0 g) was added dropwise into the solution, the solution was heated to room temperature. After stirring at room temperature for three hours, pure water (40 ml) was added, followed by stirring to precipitate a solid component. The precipitated solid component was separated by filtration, was washed with methanol, and was dried to prepare Intermediate product 1 (9.21 g).

Intermediate product 1 (2.0 g), dimethylacetamide (10 ml) and pyridine (1.13 g) were placed in a 100 ml eggplant-shaped flask, and were stirred at 15° C. After benzoyl chloride (1.98 g) was added dropwise into the solution, the solution was heated to room temperature. After stirring at room temperature for one hour, the solution was heated to 80° C., and was stirred for one hour. The reaction solution was cooled to room temperature. Ethyl acetate (50 ml) and water (50 ml) were added, and were stirred. An organic layer was extracted, and was separated with 1 N hydrochloric acid, and then with pure water five times. The organic layer was condensed under reduced pressure. The condensed solution was refined by column chromatography (developing solvent:toluene/acetone=4/1) to prepare Exemplified compound IV-(3) (1.2 g), which was identified by NMR and mass spectrometry.

### Synthetic Example of Exemplified Compound IV-(101)

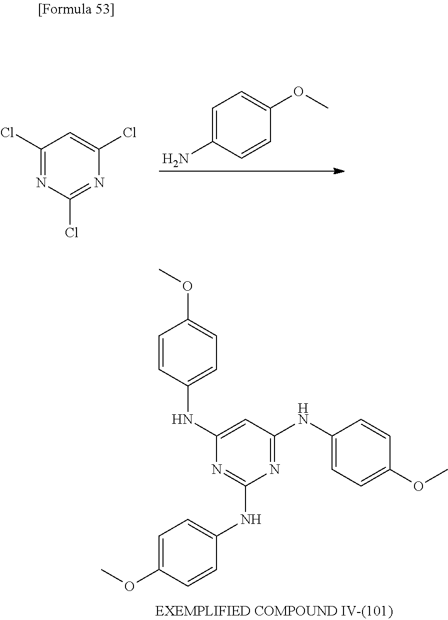

Trichloropyrimidine (2.0 g), para-anisidine (4.43 g), and sulfolane (10 ml) were placed in a 100 ml eggplant-shaped flask, and was heated to 180° C. The mixture was stirred for three hours. After the mixture was cooled to room temperature, ethyl acetate (70 ml) and pure water (40 ml) were added, and were stirred to precipitate a solid component. The precipitated solid component was separated by filtration, and was agitated to be completely dissolved in a mixture of ethyl acetate (50 ml) and an aqueous saturated sodium hydrogen carbonate solution. An organic layer was washed three times with pure water, and was condensed under reduced pressure. The condensed solution was refined by column chromatography (developing solvent:toluene/acetone=10/1) to prepare Exemplified compound IV-(101) (1.2 g), which was identified by NMR and mass spectrometry.

### Synthetic Example of Exemplified Compound IV-(117)

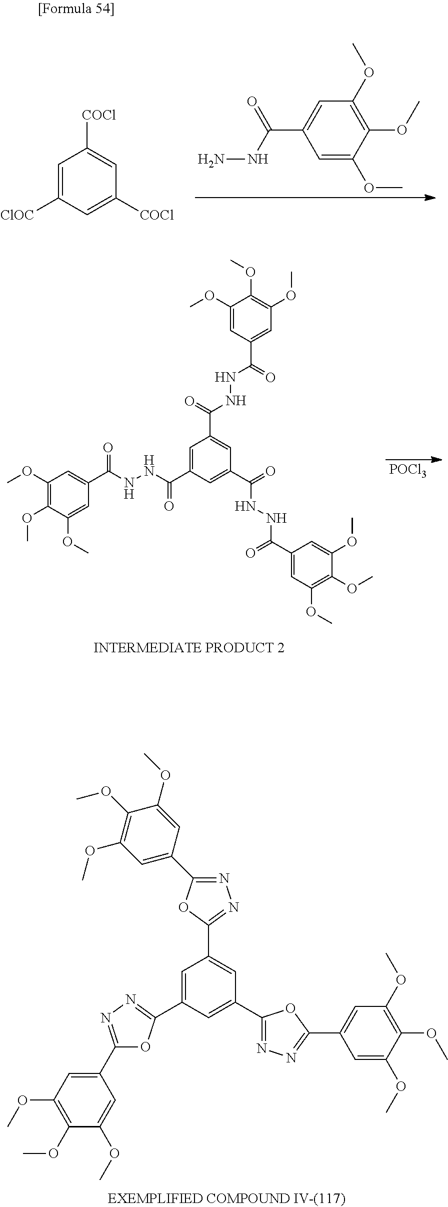

3,4,5-Trimethylbenzhydrazide (14.1 g), pyridine (10 g), and N-methylpyrrolidone (50 ml) were placed in a 200 ml eggplant-shaped flask, and were stirred at 80° C. Into the solution, 1,3,5-benzenetricarbonyl trichloride (5.0 g) was added dropwise. After stirring for three hours, the solution was cooled to room temperature. Pure water (100 ml) was added, and was stirred to precipitate a solid component. The precipitated solid component was separated by filtration, was washed with acetone, and was dried to prepare Intermediate product 2 (8.75 g).

Intermediate product 2 (3.0 g) and phosphorus oxychloride (20 ml) were placed in a 100 ml eggplant-shaped flask. The mixture was heated to 110° C., and was stirred. The reaction solution was cooled to room temperature, and was added dropwise into pure water (1 L) cooled to 0° C. The precipitated solid component was separated by filtration, and was washed with pure water. The solid component and methanol (30 ml) were placed in a 100 ml eggplant-shaped flask. The solution was heated under reflux at 70° C. for three hours, and was then cooled to room temperature. The resulting solid component was separated by filtration, and was washed with methanol to prepare Exemplified compound IV-(117) (2.43 g), which was identified by NMR and mass spectrometry.

Other compounds represented by Formula (IV) can also be prepared with reference to the disclosure in the specification and known techniques.

### <<Retardation Film>>

The retardation film according to one or more embodiments of the invention (hereinafter also referred to as the film according to embodiments of the invention) is prepared by the following production method.

The method of preparing a retardation film according to one or more embodiments of the invention is a method of preparing a retardation film comprising cellulose acetate having an average degree of acetylation of 2.0 to 2.5 and having a moisture content of 1.0 mass % or less, wherein the retardation film further comprises a compound having a Van der Waals volume of 450 to 1000 Å³, and the retardation film is prepared through at least five steps:

first step: a dope preparing step of dissolving cellulose acetate having an average degree of acetylation within the range of 2.0 to 2.5 and having a moisture content of 3.0% or more in an organic solvent containing 90 mass % or more halogen organic solvent to prepare a dope;

second step: a film product forming step of casting the dope onto a metal belt to form a film product;

third step: a film product peeling step of peeling off the film product from the metal belt;

fourth step: a drawing step of drawing the peeled film product; and

fifth step: a drying step at a drying temperature of 140° C. or more.

The retardation film prepared by the method according to one or more embodiments of the invention may have a thickness of 20 to 80 μm. The thickness may be 20 to 60 μm, or 20 to 40 μm.

The retardation film may be a multi-layered film. For example, a thin skin layer may be disposed on both surfaces of a core layer. In this case, these three layers may have the same configuration as that of the retardation film prepared by the method according to one or more embodiments of the invention. At least the main component, i.e., the core layer has the same configuration as that of the retardation film may be prepared by the method according to one or more embodiments of the present invention.

The retardation film prepared by the method according to one or more embodiments of the invention has a width of 700 to 4000 mmm. A long retardation film having a width of 700 to 3000 mm may be preferred from the viewpoint of cost reduction in accordance with one or more embodiments of the invention, specifically high punching efficiency during production of panels. The width within this range reduces the burden of conveyance of the film.

The moisture content of the retardation film prepared by the method according to one or more embodiments of the invention is a value measured at 23° C. and 55% RH within two hours after taking up of the film. The moisture content may be 1.0 mass % or less, or 0.5 to 0.9 mass %. A moisture content of more than 1.0 mass % may generate unintentional stickiness, which may not be preferred from the viewpoint of storage of a film roll.

The moisture content of the retardation film can be measured by any well-known method. For example, a sample film is dissolved in methylene chloride, and the moisture content is determined by titration according to the Karl-Fischer method.

### (Retardation Value Rt in Thickness Direction)

The retardation value Rt across the thickness of the retardation film is determined by the following equation:

Rt=[(nₓ+n_{y})/2−n_{z}]×d

where Rt is the retardation value across the thickness of the retardation film determined at 23° C. and 55% RH with light having a wavelength of 590 nm; nₓ is the refractive index of an in-plane slow axis direction of the film; n_{y} is the refractive index of an in-plane fast axis direction of the film; n_{z} is the refractive index across the thickness of the film; d is the thickness of the film.

The in-plane retardation value Ro of the retardation film is determined by the following equation:

Ro=(nₓ−n_{y})×d

The in-plane retardation value Ro is within the range of 30 to 90 nm. A retardation value Rt across the thickness within the range of 70 to 300 nm enlarges the viewing angle of VA type (multi-domain vertical alignment (MVA), PVA (patterned vertical alignment)) liquid crystal displays.

The retardation values Ro and Rt can be determined with an automatic birefringence analyzer. For example, the retardation values Ro and Rt can be determined with a KOBRA-21ADH (available from Oji Scientific Instruments Co., Ltd.) at 23° C. and 55% RH with light having a wavelength of 590 nm.

To attain desirable retardation values Ro and Rt within the ranges in one or more embodiments of the invention, a refractive index may be controlled by control of tension during the conveyance and drawing operation.

For example, the retardation value can be varied by an increase or decrease of longitudinal tension.

The retardation film prepared by the method according to one or more embodiments of the invention may have a ratio Rt(b)/Rt(a) within the range of 0.3 to 0.8, where Rt(a) is the absolute value of a difference between the retardation value Rt₁ across the thickness of the film product after the film product is left at 23° C. and 55% RH for 24 hours after the fifth step is finished and the retardation value Rt₂ across the thickness of the film product after the film product is subsequently left at 60° C. and 90% RH for 500 hours, and Rt(b) is the absolute value of a difference between the retardation value Rt₁ across the thickness of the film product after the film product is left at 23° C. and 55% RH for 24 hours after termination of the fifth step and the retardation value Rt₃ across the thickness of the film product after the film product is subsequently left at 23° C. and 55% RH for 500 hours.

The retardation film can improve fluctuations in hue and front contrast of the liquid crystal displays. A ratio Rt(b)/Rt(a) of 0.3 or more may reduce fluctuations in Rt when the film is actually used after production. A ratio of 0.8 or less generates no relaxation of orientation, does not require a high draw ratio, and does not cause a reduction in contrast, while a desired Rt value is achieved.

### <<Cellulose Acetate>>

Cellulose acetate used in accordance with one or more embodiments of the invention will now be described in detail.

Examples of raw material cellulose for the cellulose acetate according to one or more embodiments of the invention include cotton linters and wood pulp (hardwood pulp, softwood pulp). Cellulose acetate prepared from any raw material cellulose can be used, and may be a mixture in some cases.

Cellulose acetate in accordance with one or more embodiments of the invention is prepared from wood pulp from the viewpoint of bonding characteristics to a polarizer.

Cellulose is composed of β-1,4-bonded glucose units, which each have free hydroxy groups (hydroxyl groups) at 2nd-, 3rd-, and 6th-positions. These hydroxy groups (hydroxyl groups) are partially or entirely acetylated with acetyl groups to form a polymer cellulose acetate. A degree of acetylation of cellulose indicates a proportion of the acetylated hydroxy groups (hydroxyl groups) at the 2nd-, 3rd-, and 6th-positions of the glucose units (100% acetylation is the degree of acetylation of 3).

The cellulose acetate used in one or more embodiments of the invention can have any average degree of acetylation of 2.0 to 2.5. In acetylation of cellulose in one or more embodiments of the invention, an acid anhydride or an acid chloride is used as an acetylating agent, and an organic acid, such as acetic acid or methylene chloride, is used as an organic solvent, i.e., a reaction solvent.

A catalyst to be used may be a protic catalyst, such as sulfuric acid, when the acetylating agent is acid anhydride, and is a basic compound when the acetylating agent is an acid chloride (such as CH₃COCl).

In one of the most popular industrial methods of preparing a fatty acid ester of cellulose, cellulose is acylated with a mixed organic acid component containing an acetyl group and other fatty acid corresponding to an acyl group (such as acetic acid, propionic acid, or valeric acid) or acid anhydride of the above.

The cellulose acetate used in one or more embodiments of the invention is prepared by the method described in Japanese Patent Application Laid-Open No. 10-45804, for example.

The cellulose ester according to one or more embodiments of the invention has a weight-average molecular weight of 50,000 to 500,000, 100,000 to 300,000, or 150,000 to 250,000.

The ratio Mw/Mn of the weight-average molecular weight (Mw) of the cellulose acetate to the number average molecular weight (Mn) thereof may be within the range of 1.4 to 3.0.

The weight-average molecular weight Mw and the number average molecular weight Mn of the cellulose acetate can be determined by gel permeation chromatography (CPC).

Typical measuring conditions are listed below.

Solvent: methylene chloride

Columns: Shodex K806, K805, K803G (three columns available from Showa Denko K.K. connected)

Column temperature: 25° C.

Concentration of a sample: 0.1 mass %

Detector: RI Model 504 (available from GL Sciences Inc.)

Pump: L6000 (available from Hitachi, Ltd.)

Flow rate: 1.0 ml/min

Calibration curves: calibration curves derived from thirteen samples of standard polystyrenes STK (available from Tosoh Corporation) having an Mw of 1000000 to 500 are used. The thirteen samples are eluted at substantially equal intervals.

The cellulose ester used in one or more embodiments of the invention has a moisture content of 3.0% or more. The cellulose acetate can be left under a predetermined environment to adjust the moisture content. The moisture content can be adjusted, for example, by varying the time when the cellulose ester is left under an environment at 80% RH. The cellulose acetate may have a moisture content of 3.0 mass % or more when being dissolved in an organic solvent containing the halogen organic solvent in an amount of 90 mass % or more.

The moisture content can be determined by titration according to the Karl-Fischer method.

### (Average Degree of Acetylation)

When a mixture of cellulose acetates having different degrees of acetylation is used, the product of the degree of acetylation of cellulose acetate and the mass fraction thereof is determined for each cellulose acetate. The sum of these products is called the average degree of acetylation.

### <<Halogen Solvent>>

In one or more embodiments of the invention, an organic solvent containing 90 mass % or more halogen organic solvent is used as a solvent for cellulose acetate. Examples of the halogen organic solvent include dichloromethane, chloroform, and dichloroethane.

### <<Other Additives>>

To attain the effect of embodiments of the invention, the retardation film may optionally contain a plasticizer and a variety of compounds described below as additives. The film can contain, for example, a retardation demonstrating agent, an ultraviolet absorbing agent, an antioxidant, fine particles, an acid scavenger, a light stabilizer, an optical anisotropy controller, an antistatic agent, and a release agent.

### <Plasticizer>

Any plasticizer can be used, and may be selected from polyvalent carboxylic acid ester plasticizers, glycolate plasticizers, phthal acid ester plasticizers, fatty acid ester plasticizers, polyhydric alcohol ester plasticizers, ester plasticizers, and acrylic plasticizers.

In a combined use of two or more of these plasticizers, at least one of them may be a polyhydric alcohol ester plasticizer.

The polyhydric alcohol ester plasticizer is composed of an aliphatic polyhydric alcohol having a valence of 2 or more and an ester of monocarboxylic acid, and may have an aromatic ring or a cycloalkyl ring in the molecule, for example aliphatic polyhydric alcohol esters having a valence of 2 to 20.

### <Antioxidant>

An antioxidant may be contained in the retardation film to delay or prevent the decomposition of the retardation film due to halogen atoms in the residual solvent in the retardation film or phosphoric acid in a phosphoric acid plasticizer, for example.

Such an antioxidant may be a hindered phenol compound, and examples thereof can include 2,6-di-t-butyl-p-cresol, pentaerythrityl-tetrakis[3-(3,5-di-t-butyl-4-hydroxyphenyl) propionate], triethylene glycol bis[3-(3-t-butyl-5-methyl-4-hydroxyphenyl)propionate], 1,6-hexanediol bis[3-(3,5-di-t-butyl-4-hydroxyphenyl)propionate], 2,4-bis-(n-octylthio)-6-(4-hydroxy-3,5-di-t-butylanilino)-1,3,5-triazine, 2,2-thio-diethylene bis[3-(3,5-di-t-butyl-4-hydroxyphenyl)propionate], octadecyl-3-(3,5-di-t-butyl-4-hydroxyphenyl)propionate, N,N′-hexamethylene bis(3,5-di-t-butyl-4-hydroxy-hydrocinnamamide), 1,3,5-trimethyl-2,4,6-tris(3,5-di-t-butyl-4-hydroxybenzyl)benzene, and tris-(3,5-di-t-butyl-4-hydroxybenzyl) isocyanurate.

For example, 2,6-di-t-butyl-p-cresol, pentaerythrityl-tetrakis[3-(3,5-di-t-butyl-4-hydroxyphenyl) propionate], and triethylene glycol bis[3-(3-t-butyl-5-methyl-4-hydroxyphenyl)propionate] may be used. Alternatively, a hydrazine metal deactivator, such as N,N′-bis[3-(3,5-di-t-butyl-4-hydroxyphenyl)propionyl]hydrazine may be used in combination with a phosphorus process stabilizer, such as tris(2,4-di-t-butylphenyl)phosphite.

These compounds may be added in an amount of 1 ppm to 1.0%, or 10 to 1000 ppm by mass to the total mass of the cellulose ester.

### <Fine Particles>

To improve handling properties, the retardation film prepared by the method according to one or more embodiments of the invention may contain inorganic fine particles, such as silicon dioxide, titanium dioxide, aluminum oxide, zirconium oxide, calcium carbonate, kaolin, talc, calcined calcium silicate, calcium silicate hydrate, aluminum silicate, magnesium silicate, and calcium phosphate, or fine particles of a crosslinked polymer (hereinafter, also referred to as a matting agent), for example. Among these, silicon dioxide may be used, which can reduce the haze of the film.

The primary average particle size of the fine particles may be 20 nm or less, 5 to 16 nm, or 5 to 12 nm.

These fine particles may form secondary particles having a particle size of 0.1 to 5 μm to be contained in the retardation film. The average particle size may be within the range of 0.1 to 2 μm, or 0.2 to 0.6 μm. The size can provide irregularities having a height of about 0.1 to 1.0 μm on the surface of the film to give a suitable lubricious surface of the film.

### <<Process of Preparing Retardation Film>>

The method of preparing retardation film according to one or more embodiments of the invention by solution casting is conducted through the following five steps: a dope preparing step (first step) of preparing a dope, a film product forming step (second step) of casting the dope onto a metal belt to form a film product, a film product peeling step (third step) of peeling off the film product from the metal belt, a drawing step (fourth step) of drawing the peeled film product, and a drying step (fifth step).

### (First Step)

In the first step, cellulose acetate having an average degree of acetylation of 2.0 to 2.5 and having a moisture content of 3% or more is dissolved in an organic solvent containing 90 mass % or more halogen organic solvent to prepare a dope.

Cellulose acetate may be contained in the dope in a high concentration to reduce drying load after casting of the dope onto the metal support, while cellulose acetate in an excessively high concentration increases load on the filtration to reduce filtration accuracy. To attain compatibility between appropriate drying load and filtration load at the same time, the concentration of cellulose acetate may be 10 to 35 mass %, or 15 to 25 mass %.

The solvent used for the dope contains 90 mass % or more halogen organic solvent, which is a good solvent. The solvent may be composed of a single solvent or a mixture of different solvents. A mixture of a halogen organic solvent and a poor solvent for cellulose acetate may be used because of production efficiency, and a larger content of halogen organic solvent may be used because of the solubility of cellulose acetate.

For a mixing ratio of the halogen organic solvent to the poor solvent, the content of the halogen organic solvent is 90 to 100 mass %, and the content of the poor solvent is 0 to 10 mass %. A solvent which can dissolve cellulose acetate is defined as a good solvent, and a solvent which can swell cellulose acetate or cannot dissolve cellulose acetate is defined as a poor solvent.

For this reason, the good solvent to the poor solvent varies depending on the average degree of acetylation of cellulose acetate.

Any poor solvent can be used in one or more embodiments the invention. For example, methanol, ethanol, n-butanol, cyclohexane, and cyclohexanone may be used. The dope may contain 0.01 to 2 mass % water.

The solvent for dissolving cellulose acetate, which is removed from the film by drying in the film product forming step, may be recovered for reuse.

The recovered solvent may contain slight amounts of additives added to cellulose acetate, such as a plasticizer, an ultraviolet absorbing agent, and polymer and monomer components. The recovered solvent containing these additives can be reused, and may optionally be purified for reuse.

In preparation of the dope, cellulose acetate can be dissolved by any typical method. Heating under increased pressure can heat the mixture of cellulose acetate and the solvent to a temperature above the boiling point under normal pressure of the solvent.

Cellulose acetate is agitated to be dissolved while the mixture is being heated under increased pressure at a temperature above the boiling point under normal pressure of the solvent and below the boiling point under the increased pressure. This process prevents the generation of bulky undissolved products called gel or clumping.

In one or more embodiments of the invention, cellulose acetate is wetted or swollen with a poor solvent, and then a good solvent is added to dissolve cellulose acetate.

The pressure may be increased by injecting an inert gas, such as nitrogen gas, or by heating to increase the vapor pressure of the solvent. External heating may be used. For example, a jacket type heater may be used because this heater can readily control the temperature.

A higher heating temperature after addition of the solvent may be used from the viewpoint of the solubility of cellulose acetate. However, a significantly high heating temperature requires larger pressure and reduce productivity.

A heating temperature may be 45 to 120° C., 60 to 110° C., or 70 to 105° C. The pressure is adjusted so as not to boil the solvent at the setting temperature.

The cellulose acetate solution is filtered through an appropriate filtering member, such as filter paper. A filtering member may have a small absolute filtration rating to remove insoluble products, while an excessively small absolute filtration rating is prone to generate clogging in the filtering member.

For this reason, the absolute filtration rating of the filtering member may be 0.008 mm or less, 0.001 to 0.008 mm, or 0.003 to 0.006 mm.

Any material can be used for the filtering member, and typical filtering members can be used. Plastic filtering members composed of polypropylene or Teflon (Registered Trademark) and metal filtering members composed of stainless steel may be used because no fiber drops.

Impurities, particularly bright spot foreign substances contained in the raw material cellulose acetate may be removed or reduced by filtration.

The bright spot foreign substance is defined as follows: Two polarizing plates are disposed in a cross-Nicol state, and an optical film is disposed between the plates. While light is incident on one of the polarizing plates, images are observed on the other polarizing plate. Leakage of light is found at points (foreign substances) corresponding to bright spot foreign substances. The number of bright spots having a diameter of 0.01 mm or more may be 200 spots/cm² or less.

The number may be 100 spots/cm² or less, 50 spots/cm² or less, or 0 to 10 spots/cm² or less. A smaller number of bright spots having a diameter of 0.01 mm or less may be used.

The dope can be separated by a typical filtering method. The dope may be separated while the solution is being heated under increased pressure at a temperature higher than the boiling point under normal pressure of the solvent and below the boiling point under the increased pressure, because an increase in a filtration pressure before and after filtration (called differential pressure) is small.

The temperature may be 45 to 120° C., 45 to 70° C., or 45 to 55° C.

A smaller filtration pressure may be used. The filtration pressure may be 1.6 MPa or less, 1.2 MPa or less, or 1.0 MPa or less.

### (Second Step)

In the second step, the dope is cast onto a metal belt to form a film product (film product forming step).

A metal support in the casting step may have a mirror-finished surface. A metal support may be a stainless steel belt or a cast metal drum having a plated surface.

The casting width may be 1 to 4 m. In the casting step, the surface temperature of the metal support ranges from −50° C. to a temperature of less than the boiling point of the solvent. A higher temperature may be used because the film product (hereinafter, also referred to as a web) can be dried quickly. An excessively high temperature may cause bubbles in the web or impair the flatness.

The temperature of the metal support may be 0 to 55° C., or 25 to 50° C. Alternatively, the web may be cooled to gelated, and the web containing a large amount of a residual solvent may be peeled off from the drum.

The temperature of the metal support can be controlled by any method, such as by blowing of hot or cold air to the metal support or by contacting of hot water with the rear surface of the metal support. The hot water may conduct heat efficiently to attain a predetermined temperature of the metal support within a short time. Hot air at a temperature higher than the target temperature may be used.

Drying of the web on the metal support will now be described.

The control of the temperature of the metal support with dry air at an adjusted temperature can dry the film on the metal support into a residual solvent content suitable for the third step.

### (Third Step)

In the third step, the film product is peeled off from the metal belt (film product peeling step).

To attain high flatness of the retardation film, the residual solvent content in the web peeled off from the metal support may be 10 to 150 mass %, 20 to 40 mass % or 60 to 130 mass %, or 20 to 30 mass % or 70 to 120 mass %.

In one or more embodiments of the invention, the residual solvent content is defined by the following equation:

Residual solvent content (mass %)={(M−N)/N}×100 where M is the mass of a sample extracted at any time during or after production of the web or the film; N is the mass of the sample after heating the sample at 115° C. for one hour.

While both ends of the web are held with clips and the web is being drawn in the width direction (transverse direction) by a tenter method, the web may be peeled off at a peeling tension of 300 N/m or less. The solvent may be continuously dried during the peeling process and after the peeling process and before the drawing process into a residual solvent content suitable for drawing.

### (Fourth Step)

In the fourth step, the peeled film product is drawn (drawing step).

To attain a target retardation value Rt across the thickness of the film, the refractive index of the retardation film may be further controlled by control of the tension during the conveyance and drawing operation.

The retardation value can be adjusted, for example, by a decrease or increase in longitudinal tension.

The film can be successively or simultaneously drawn in the longitudinal direction (film forming direction) of the produced film and the lateral or width direction orthogonal to the longitudinal direction of the film. The film can be biaxially or uniaxially drawn.

The final draw ratios in the biaxial directions orthogonal to each other are 0.8 to 1.5 times in the casting direction and 1.1 to 2.5 times in the transverse direction, 0.8 to 1.0 times in the casting direction and 1.2 to 2.0 times in the transverse direction.

The drawing temperature may be 120 to 200° C., 150 to 200° C., or more than 150° C. and 190° C. or less.

A film containing 20 to 0%, or 15 to 0% residual solvent may be drawn.

Specifically, the film may be drawn at 155° C. at a residual solvent content of 11%, or 2%. Alternatively, the film may be drawn at 160° C. in a residual solvent content of 11% or less than 1%.

The web can be drawn by any method. Examples of the drawing method include a method of drawing a film in the longitudinal direction utilizing a difference between circumferential speeds of a plurality of rolls having different circumferential speeds; a method of fixing both ends of a web with clips or pins, and expanding the intervals between the clips or the pins in the traveling direction to draw the web in the longitudinal direction; a method of similarly expanding the intervals between the clips or the pins in the traverse direction to draw the web in the traverse direction; or a method of expanding the intervals between the clips or the pins in the traverse direction and in the longitudinal direction at the same time to draw the web in both directions. These methods may be used in combination.

In the so-called tenter method, clipped portions driven in a linear drive manner may be smoothly drawn to reduce risks, such as breakage.

In the film forming step, the retention of the width or the drawing in the traverse direction may be conducted with a tenter, which may be a pin tenter or a clip tenter.

### (Fifth Step)

The fifth step is a drying step at a drying temperature of 140° C. or more.

After drawing, the film is dried before the film is taken up. This drying step can adjust the residual solvent content suitable for subsequent manufacturing steps of a polarizing plate and a liquid crystal display.

In one or more embodiments of the invention, it is believed that the drying temperature of 140° C. or more can reduce the moisture content of the film, increase gaps between molecules, and relax the orientation of cellulose ester molecules.

A drying temperature may be within the range of 140 to 170° C. from the viewpoint of the softening point of the film. The drying temperature may be within the range of 140 to 150° C.

### <<Polarizing Plate>>

The retardation film prepared by the method according to one or more embodiments of the invention can be used in polarizing plates and liquid crystal displays including the polarizing plate(s). The polarizing plate according to embodiments of the present invention can be prepared by bonding the retardation film according to one or more embodiments of the invention to at least one surface of a polarizer.

The polarizing plate according to one or more embodiments of the invention can be prepared by any typical method. A polarizer side of the retardation film prepared by the method according to one or more embodiments of the invention is saponified with an alkali, and the alkali-saponified surface of the retardation film is bonded to at least one surface of the polarizer drawn in an iodine solution, with an aqueous completely saponified poly(vinyl alcohol) solution.

The retardation film or another film may be bonded to the other surface of the polarizer.

For example, commercially available cellulose ester films (such as Konica Minolta Tac films KC8UX, KC5UX, KC8UCR3, KC8UCR4, KC8UCR5, KC8UY, KC4UY, KC8UA, KC6UA, KC4UA, KC4UE, KC8UE, KC8UY-HA, KC8UX-RHA, KC8UXW-RHA-C, KC8UXW-RHA-NC, and KC4UXW-RHA-NC, available from Konica Minolta Advanced Layers, Inc.) may be used.

### <<Liquid Crystal Display>>

The liquid crystal display according to embodiments of the invention includes the polarizing plate according to one or more embodiments of the invention. The liquid crystal display according to one or more embodiments of the invention can be prepared by bonding the polarizing plate according to one or more embodiments of the invention to at least one liquid crystal cell surface of the liquid crystal display with an adhesive layer. A liquid crystal display having excellent contrasts can be attained if the liquid crystal display includes the polarizing plate comprising the retardation film according to one or more embodiments of the invention.

The retardation film according to one or more embodiments of the present invention can be used in liquid crystal displays of a variety of driving systems, such as super twisted nematic (STN), twisted nematic (TN), optically compensated bend (OCB), hybrid aligned nematic (HAN), VA (MVA, PVA), and in-plane switching (IPS) systems. For example, VA (MVA, PVA) liquid crystal displays may be used.

### EXAMPLES

Embodiments of the invention will now be described in further detail by way of non-limiting Examples. In Examples, “parts” and “%” are on the mass basis, unless otherwise specified.

### Compounds Used in Examples

The structures of the compounds represented by Formulae (I) to (III) according to one or more embodiments of the present invention and used in Examples are as follows:

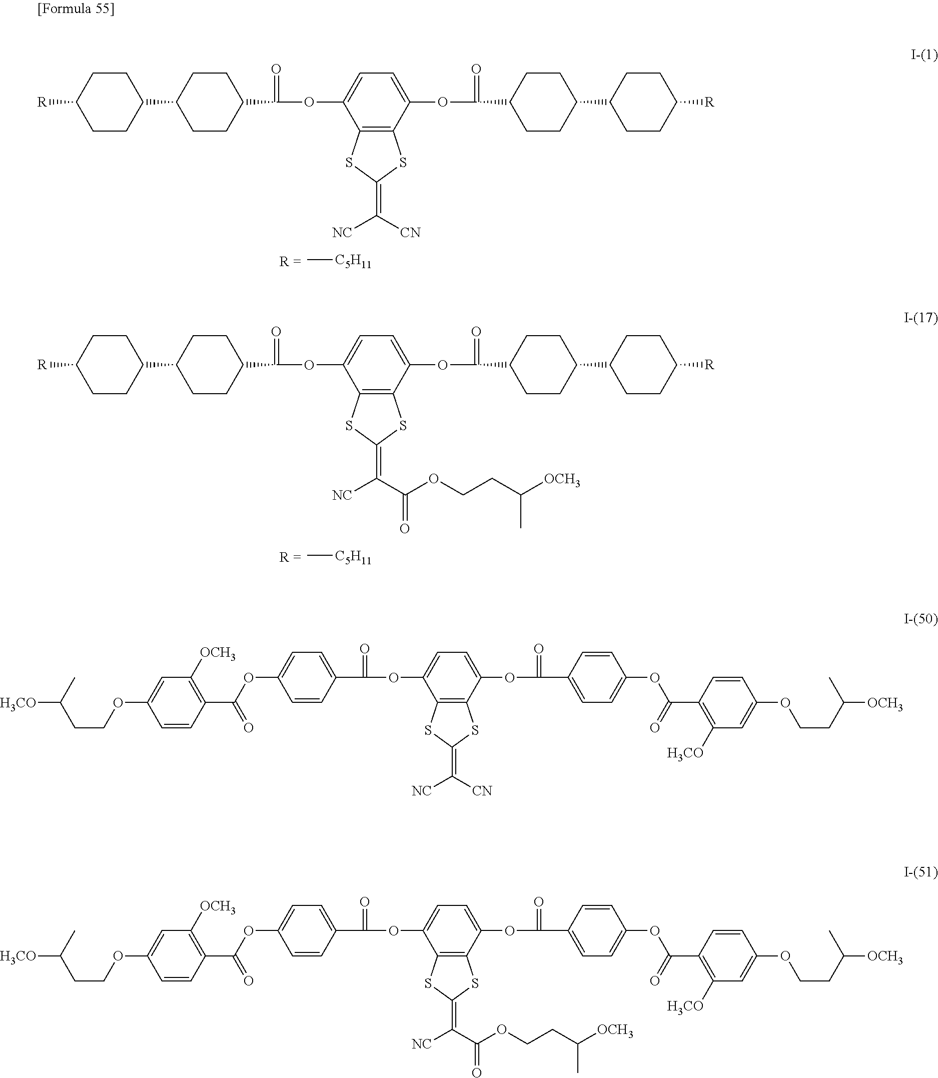

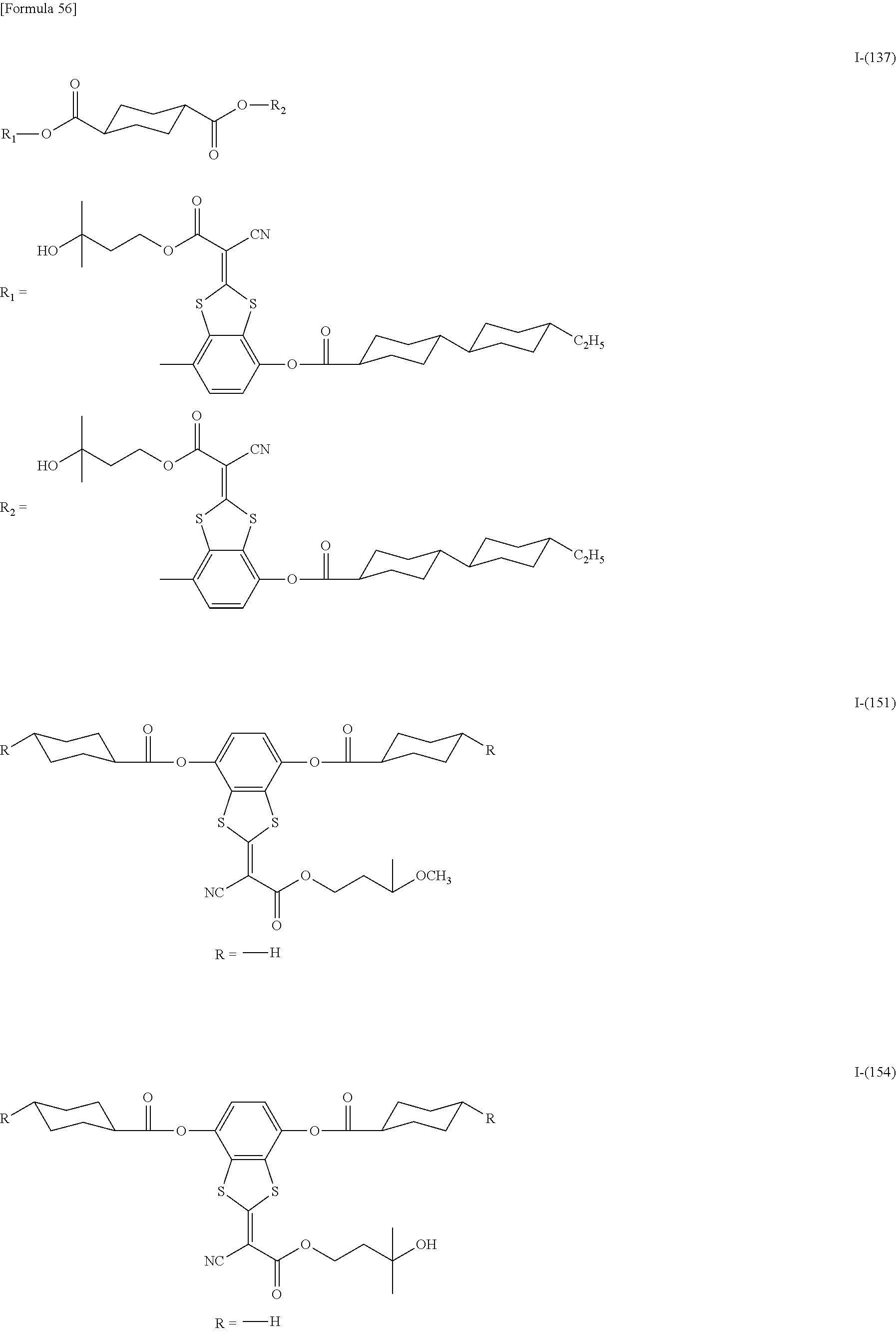

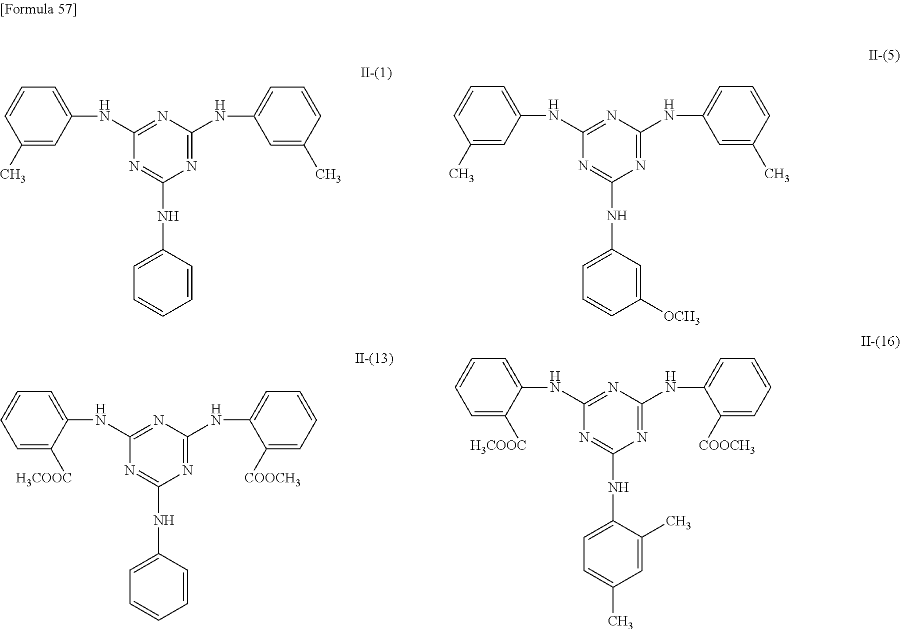

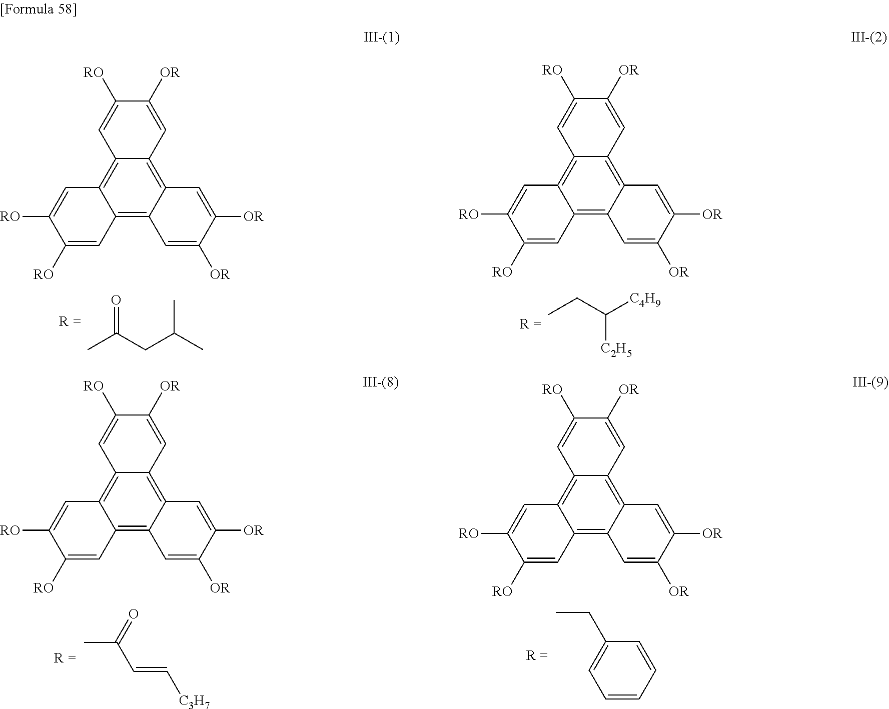

### Example 1

### Preparation of Retardation Film 101

### [Dope Preparing Step]

### <Fine Particle Dispersion 1>

| | |
|---|---|
| Fine particle (Aerosil R812V available from | 11 parts by mass |
| Nippon Aerosil Co., Ltd.) | |
| Ethanol | 89 parts by mass |

These were mixed by stirring with a dissolver for 50 minutes, and were dispersed with a Manton-Gaulin homogenizer.

### <Fine Particle-Containing Solution 1>

Fine particle dispersion 1 was slowly added into a dissolution tank containing methylene chloride while the solution was being stirred. The solution was further dispersed with an attritor such that secondary particles had a predetermined particle size. The solution was separated through a FINE MET NE available from Nippon seisen Co., Ltd. to prepare Fine particle-containing solution 1.

| | |
|---|---|
| Methylene chloride | 99 parts by mass |
| Fine particle dispersion liquid 1 | 5 parts by mass |

A dope having the following composition was prepared. Methylene chloride and ethanol were placed in a pressurized dissolution tank. Cellulose acetate, Compound having a Van der Waals volume of 450 to 1000 Å³, Compound A, Compound D, and Fine particle-containing solution 1 were placed into the pressurized dissolution tank containing the mixed solvent while the mixed solvent was being stirred. The mixture was heated, and was agitated to be completely dissolved. The solution was filtered through an AZUMI FILTER PAPER No. 244 available from AZUMI FILTER PAPER CO., LTD. to prepare a dope.

### <Composition of Dope>

| | | |
|---|---|---|
| Methylene chloride | 420.0 | parts by mass |
| Ethanol | 36.0 | parts by mass |
| Cellulose acetate A (moisture content | 100.0 | parts by mass |
| 3.9%) | | |
| Compound I-(51) having Van der Waals | 5.0 | parts by mass |
| volume of 450 to 1000 Å³ | | |
| Compound A (Plasticizer) | 3.0 | parts by mass |
| Compound D (Plasticizer) | 2.0 | parts by mass |
| Fine particle-containing solution 1 | 1.0 | part by mass |

### (Plasticizer)

The following plasticizers were used in Examples.

Compound A: dioctyl phthalate
Compound B: triphenyl phosphate
Compound C: bisphenylbiphenyl phosphate
Compound D: ethyl phthalylethyl glycolate

### [Film Product Forming Step]

The temperature of the dope was set at 33° C. The dope was uniformly cast onto a stainless steel belt support of an endless belt casting apparatus at 33° C. and 1500 mm in width. The temperature of the stainless steel belt was controlled to be 30° C.

The solvent was evaporated until the residual solvent content in the cast film on the stainless steel belt support reached 75 mass %.

### [Film Product Peeling Step]

The film was peeled off from the stainless steel belt support at a peeling tension of 200 N/m.

### [Drawing Step]

The peeled cellulose acetate film was 37% drawn in the transverse direction with a tenter while the film was being heated to 155° C. The residual solvent content was 10% at the start of drawing.

### [Drying Step]

The film was completely dried while the film was being conveyed through several rolls in a drying zone. The drying temperature was 140° C., and the tension during the conveyance was 100 N/m.

Retardation film 101 having a dry thickness of 45 μm was prepared in accordance with one or more embodiments of the invention.

### <Preparation of Retardation Films 102 to 122>

Retardation films 102 to 122 were prepared as in Retardation film 101 except that the type and moisture content of cellulose acetate and the type and content of Plasticizers and Compound having a Van der Waals volume of 450 to 1000 Å³ were varied as shown in Table 2.

The degree of acetylation and the weight-average molecular weight of each cellulose acetate shown in Table 2 are shown in Table 1.

The moisture contents of Cellulose acetates A to E were adjusted by varying the time to leave each cellulose acetate at 40° C. and 80% RH.

### <<Evaluation>>

### [Determination of Rt]

### Normal Condition

In each of Retardation films 101 to 122, the retardation value across the thickness of the film was measured with light having a wavelength of 590 nm with KOBRA-21ADH (available from Oji Scientific Instruments Co., Ltd.) twice, i.e., after the film was left at 23° C. and 55% RH for 24 hours after the fifth step (drying step) and after the film was subsequently left at 23° C. and 55% RH for 500 hours. The retardation value Rt₁ (after 24 hours) and the retardation value Rt₃ (after 500 hours) were determined. The difference between the determined retardation value Rt₁ of the retardation film (after the film was left for 24 hours after the fifth step (drying step)) and the determined retardation value Rt₃ of the retardation film (after the film was subsequently left at 23° C. and 55% RH for 500 hours) was determined, and the absolute value |Rt₁−Rt₃| of the difference is denoted by Rt(b) in Table 2.

### Endurance Condition

In each of Retardation films 101 to 122, the retardation value across the thickness was measured with light having a wavelength of 590 nm with KOBRA-21ADH (available from Oji Scientific Instruments Co., Ltd.) twice, i.e., after the film was left for 24 hours after the fifth step (drying step) and after the film was subsequently left at 60° C. and 90% RH for 500 hours. The retardation value Rt₁ (after 24 hours) and the retardation value Rt₂ (after 500 hours) were determined. The difference between the determined retardation value Rt₁ of the retardation film (after the film was left for 24 hours after the fifth step (drying step)) and the determined retardation value Rt₂ of the retardation film (after the film was subsequently left at 60° C. and 90% RH for 500 hours) was determined, and the absolute value |Rt₁−Rt₂| of the difference is denoted by Rt(a) in Table 2.

### [Determination of Moisture Content]

The moisture content of the retardation film was determined by the following Karl-Fischer method. The experimental instruments used were an aquameter CA-03 and a sample dryer VA-05 both available from Mitsubishi Chemical Corporation. Karl-Fischer reagents AKS and CKS available from Mitsubishi Chemical Corporation were used. The retardation film was measured at 23° C. and 55% RH within two hours after taking up of the film.

The moisture contents of cellulose acetates (pellets) were similarly measured with the Karl-Fischer aquameter.

The weight-average molecular weights of cellulose acetates were determined by gel permeation chromatography, and are shown in Table 1.

TABLE 1

| | | WEIGHT-AVERAGE |
|---|---|---|
| | DEGREE OF | MOLECULAR |
| NAME OF POLYMER | ACETYLATION | WEIGHT (Mw) |
| CELLULOSE ACETATE A | 2.4 | 185,000 |
| CELLULOSE ACETATE B | 2.0 | 170,000 |
| CELLULOSE ACETATE C | 2.5 | 190,000 |
| CELLULOSE ACETATE D | 1.9 | 160,000 |
| CELLULOSE ACETATE E | 2.6 | 200,000 |

TABLE 2

| | | | | | | | COMPOUND HAVING VAN | | |
|---|---|---|---|---|---|---|---|---|---|
| | | | | | | | DER WAALS VOLUME OF | | |
| | | | | | | | 450 TO 1000 Å³ | | |
| | | | PLASTICIZER 1 | | PLASTICIZER 2 | | | VAN DER | |
| | | | | AMOUNT | | AMOUNT | | WAALS | AMOUNT |
| RETARDATION | CELLULOSE | | | (PARTS | | (PARTS | | VOLUME | (PARTS |
| FILM No. | ACETATE | *1 | COMPOUND | BY MASS) | COMPOUND | BY MASS) | COMPOUND | (Å³) | BY MASS) |
| 101 | A | 3.9 | A | 3.0 | D | 2.0 | I-(51) | 958 | 5.0 |
| 102 | A | 3.8 | A | 3.0 | D | 3.0 | I-(1) | 695 | 3.0 |
| 103 | A | 4.3 | A | 3.0 | D | 2.0 | I-(1) | 695 | 5.0 |
| 104 | A | 3.5 | A | 3.0 | B | 2.0 | I-(151) | 529 | 5.0 |
| 105 | A | 4.3 | B | 2.0 | — | — | II-(5) | 453 | 10.0 |
| 106 | C | 4.1 | B | 5.0 | — | — | II-(13) | 516 | 5.0 |
| 107 | B | 4.8 | B | 5.0 | — | — | II-(16) | 549 | 5.0 |
| 108 | A | 3.8 | B | 7.0 | — | — | III-(2) | 989 | 3.0 |
| 109 | C | 4.1 | A | 3.0 | B | 2.0 | III-(8) | 765 | 5.0 |
| 110 | B | 4.7 | A | 3.0 | B | 2.0 | III-(1) | 704 | 5.0 |
| 111 | A | 3.8 | A | 3.0 | B | 2.0 | IV-(99) | 869 | 5.0 |
| 112 | A | 4.1 | A | 3.0 | B | 2.0 | IV-(9) | 759 | 5.0 |
| 113 | A | 4.2 | A | 3.0 | B | 3.0 | IV-(9) | 759 | 3.0 |
| 114 | A | 3.8 | — | — | — | — | IV-(2) | 548 | 11.0 |
| 115 | A | 3.3 | A | 3.0 | D | 3.0 | II-(1) | 420 | 3.0 |
| 116 | A | 4.2 | A | 3.0 | — | — | I-(17) | 788 | 7.0 |
| 117 | A | 2.5 | A | 2.0 | B | 4.0 | III-(9) | 734 | 5.0 |
| 118 | E | 3.2 | B | 3.0 | C | 3.0 | I-(154) | 504 | 3.0 |
| 119 | D | 4.1 | B | 3.0 | C | 2.0 | I-(51) | 958 | 5.0 |
| 120 | B | 4.5 | B | 6.0 | C | 4.0 | — | — | — |
| 121 | B | 4.1 | C | 6.0 | D | 4.0 | I-(137) | 1154 | 3.0 |
| 122 | A | 4.8 | — | — | — | — | I-(50) | 864 | 11.0 |

| | MOISTURE | | | | | | |
|---|---|---|---|---|---|---|---|
| | CONTENT | DRYING | | Rt | | | |
| RETARDATION | OF FILM | TEMPERATURE | THICKNESS | Rt (b) | Rt (a) | Rt (b)/ | |
| FILM No. | (MASS %) | (° C.) | (μm) | (nm) | (nm) | Rt (a) | NOTES |
| 101 | 0.8 | 140 | 45 | 3.0 | 6.0 | 0.5 | *2 |
| 102 | 0.8 | 140 | 45 | 3.0 | 7.0 | 0.4 | *2 |
| 103 | 0.8 | 140 | 45 | 3.0 | 8.0 | 0.4 | *2 |
| 104 | 0.8 | 140 | 45 | 3.0 | 9.0 | 0.3 | *2 |
| 105 | 0.8 | 140 | 45 | 4.0 | 6.0 | 0.7 | *2 |
| 106 | 0.9 | 145 | 50 | 5.0 | 7.0 | 0.8 | *2 |
| 107 | 0.8 | 140 | 40 | 5.0 | 8.0 | 0.6 | *2 |
| 108 | 0.8 | 145 | 45 | 5.0 | 9.0 | 0.6 | *2 |
| 109 | 0.8 | 150 | 50 | 4.0 | 8.0 | 0.5 | *2 |
| 110 | 0.8 | 140 | 40 | 4.0 | 8.5 | 0.5 | *2 |
| 111 | 0.8 | 140 | 45 | 4.0 | 7.5 | 0.5 | *2 |
| 112 | 0.8 | 140 | 45 | 4.0 | 6.5 | 0.6 | *2 |
| 113 | 0.8 | 140 | 45 | 3.0 | 6.5 | 0.5 | *2 |
| 114 | 0.8 | 140 | 45 | 3.5 | 7.0 | 0.5 | *2 |
| 115 | 0.9 | 140 | 45 | 1.5 | 6.5 | 0.2 | *3 |
| 116 | 1.2 | 130 | 45 | 1.5 | 7.0 | 0.9 | *3 |
| 117 | 0.9 | 140 | 45 | 3.5 | 7.0 | 0.3 | *3 |
| 118 | 1.0 | 140 | 50 | 6.0 | 8.0 | 0.3 | *3 |
| 119 | 0.9 | 140 | 40 | 1.5 | 8.0 | 0.2 | *3 |
| 120 | 0.9 | 140 | 40 | 1.5 | 7.5 | 0.1 | *3 |
| 121 | 0.9 | 140 | 40 | 6.0 | 8.0 | 0.3 | *3 |
| 122 | 0.9 | 130 | 45 | 6.0 | 7.5 | 1.0 | *3 |

*1: MOISTURE CONTENT OF CELLULOSE ACETATE (MASS %)
*2: EXAMPLE
*3: COMPARATIVE EXAMPLE

The results in Table 2 evidently show that the retardation films according to one or more embodiments of the invention comprising compounds having a Van der Waals volume of 450 to 1000 Å³ and prepared from cellulose acetates having a moisture content of 3.0% or more attain a variation in Rt within the desired range. The retardation films according to one or more embodiments of the invention causes no fluctuation in Rt due to rapid environmental changes during transportation after the production, and have improved optical performance.

### Example 2

### Preparation of Hard Coated Film 1

Cellulose acetate film F was prepared as in Retardation film 101 except that a different composition was employed for the dope as follows.

### (Composition of Dope)

| | | |
|---|---|---|
| Methylene chloride | 420.0 | parts by mass |
| Ethanol | 36.0 | parts by mass |
| Cellulose acetate F (degree of acetylation: | 100.0 | parts by mass |
| 2.9, weight-average molecular weight; 190000) | | |
| Compound B (Plasticizer) | 5.0 | parts by mass |
| Compound D (Plasticizer) | 5.0 | parts by mass |
| Fine particle-containing solution 1 | 1.0 | part by mass |

### (Deposition of Hard Coat Layer)

The composition for a hard coat layer was separated through a polypropylene filter having a pore diameter of 0.4 μm to prepare a coating solution for a hard coat layer. The coating solution was applied onto Cellulose acetate film F with a microgravure coater, and was dried at 80° C. The coat layer was cured with an ultraviolet light lamp at an irradiance of 80 mW/cm² and an irradiation intensity of 80 mJ/cm² in an irradiated portion to deposit Hard coat layer 1 having a dry thickness of 9 μm. The product was taken up into a roll of Hard coated film 1.

### (Composition for Hard Coat Layer)

The following materials were mixed by stirring to prepare a composition for a hard coat layer.

| | | |
|---|---|---|
| Vylon UR1350 (polyester urethane resin, | 6.0 | parts by mass |
| available from TOYOBO CO., LTD., solid | | |
| content: 33% (toluene/methyl ethyl ketone: | | |
| 65/35)) | | |
| Pentaerythritol triacrylate | 30.0 | parts by mass |
| Pentaerythritol tetraacrylate | 30.0 | parts by mass |
| IRGACURE 184 (available from BASF Japan | 3.0 | parts by mass |
| Ltd., photopolymerization initiator) | | |
| IRGACURE 907 (available from BASF Japan | 1.0 | parts by mass |
| Ltd., photopolymerization initiator) | | |
| Polyether-modified polydimethylsiloxane | 2.0 | parts by mass |
| (BYK-UV3510, available from BYK Japan K.K.) | | |
| Propylene glycol monomethyl ether | 150.0 | parts by mass |
| Methyl ethyl ketone | 150.0 | parts by mass |

### <Preparation of Polarizing Plate 201>

(Saponification with Alkali)

Hard coated film 1 and Retardation film 101 were used as protective films for a polarizing plate to prepare Polarizing plate 201 by the following step.

### (Preparation of Polarizer)

Poly(vinyl alcohol) (hereinafter abbreviated to PVA) having a degree of saponification of 99.95 mol % and a degree of polymerization of 2400 (100 parts by mass) was impregnated with glycerol (10 parts by mass) and water (170 parts by mass). The product was melt kneaded, was defoamed, and was melt extruded through a T-die onto a metal roll to form a film. The film was dried and heated to prepare a PVA film.

The PVA film had an average thickness of 25 μm, a moisture content of 4.4%, and a width of 3 m. The PVA film was then successively subjected to preparatory swelling, dyeing, uniaxial drawing by a wet process, fixing, drying, and heating, in this order, to prepare a polarizer. Specifically, the PVA film was dipped in water at 30° C. for 30 seconds to be preliminarily swollen, and was swollen in an aqueous solution of 0.4 g/L iodine and 40 g/L potassium iodide at 35° C. for 3 minutes. The swollen PVA film was uniaxially drawn at a stretch ratio of 6 times in an aqueous solution of 4% boric acid at 50° C. and a tension to the film of 700 N/m. The drawn film was immersed in an aqueous solution of 40 g/L potassium iodide, 40 g/L boric acid, and 10 g/L zinc chloride at 30° C. for 5 minutes to be fixed. The fixed PVA film was taken out and dried in hot air at 40° C., and was heated at 100° C. for 5 minutes. The resulting polarizer had an average thickness of 13 μm. The polarizer had the following performance, the transmittance was 43.0%, the degree of polarization was 99.5%, and the dichroic ratio was 40.1.

### (Bonding)

The polarizer, Retardation film 101, and Hard coated film 1 were bonded by Steps (a) to (e).

Step (a): The polarizer was dipped in a poly(vinyl alcohol) adhesive solution (solid content: 2 mass %) in a storage tank for 1 to 2 seconds.

Step (b): Retardation film 101 and Hard coated film 1 were saponified with an alkali on the following condition, was washed by water, was neutralized, was washed by water again, in this order, and was dried at 100° C. An excessive adhesive adhering to the polarizer dipped in the poly(vinyl alcohol) adhesive solution in Step (a) was slightly removed. The polarizer was interposed between Retardation film 101 and Hard coated film 1 to form a laminate.

(Saponification with Alkali)

| | | | |
|---|---|---|---|
| Saponifying step | 1.5M KOH | 50° C. | 45 seconds |
| Water washing step | water | 30° C. | 60 seconds |
| Neutralization step | 10 parts by | 30° C. | 45 seconds |
| | mass HCl | | |
| Water washing step | water | 30° C. | 60 seconds |

Step (c): The laminate was bonded through two rotating rolls at a pressure of 20 to 30 N/cm² at about 2 m/min. At this time, the bonding was carefully conducted to avoid trap of air bubbles.

Step (d): The sample prepared in Step (c) was dried in a dryer at 80° C. for 5 minutes to prepare Polarizing plate 201.

Step (e): A commercially available acrylic adhesive was applied onto the surface of Retardation film 101 in Polarizing plate 201 prepared in Step (d) into a dry thickness of 25 μm, and was dried in an oven at 110° C. for 5 minutes to form an adhesive layer. A releasable protective film was attached to the adhesive layer. The polarizing plate was cut into 576 by 324 mm (punched) to prepare a laminate of Polarizing plate 201 and the adhesive layer. Polarizing plate 201 is used as a polarizing plate on a viewer side.

### <Preparation of Polarizing Plates 202 to 222>

Polarizing plates 202 to 222 were prepared as in Polarizing plate 201 except that Retardation films 102 to 122 were used in place of Retardation film 101. Polarizing plates 202 to 222 are also used as polarizing plates on a viewer side like Polarizing plate 201.

### <Preparation of Polarizing Plate 223>

Polarizing plate 223 was prepared as in Polarizing plate 201 except that Cellulose acetate film F was used in place of Hard coated film 1. Polarizing plate 223 is used as a polarizing plate adjacent to a backlight.

### <Preparation of Polarizing Plates 224 to 244>

Polarizing plates 224 to 244 were prepared as in Polarizing plate 223 except that Retardation films 102 to 122 were used in place of Retardation film 101. Polarizing plates 224 to 244 are used as polarizing plates adjacent to a backlight like Polarizing plate 223.

### <<Evaluation>>

### [Evaluation of Amount of Leaked Light]

Two polarizing plates prepared were disposed in a cross-Nicol state, and the transmittance (T1) at 590 nm was measured with a spectrophotometer U3100 available from Hitachi, Ltd. The transmittance (T1) was defined as the amount of leaked light. Two polarizing plates were processed at 60° C. and 90% for 500 hours, and were also disposed in a cross-Nicol state to measure the transmittance (T2). From T1 and T2, a change in the transmittance before and after thermal treatment was examined. The change in transmittance was determined by the following equation, and was defined as the change in the amount of leaked light (Δ%). The amount of leaked light is an index of contrast. A large amount indicates low contrast, resulting in poor display quality in dark (black) portions in particular.

Amount of leaked light (change in transmittance) (%)=T2(%)−T1(%)

An amount of leaked light of 0 to 5% is in a practically usable level without problems. The amount of leaked light may be 0 to 4(%), 0 to 3(%), or 0 to 1(%).

The results of evaluation are shown in Tables 3 and 4.

TABLE 3

| POLARIZING PLATE | RETARDATION FILM | AMOUNT OF | CHANGE IN AMOUNT | |
|---|---|---|---|---|
| ON VIEWER | ON SIDE OF LIQUID | LEAKED | OF LEAKED | |
| SIDE No. | CRYSTAL CELL No. | LIGHT (%) | LIGHT (Δ%) | NOTES |
| 201 | 101 | 0.7 | 0.8 | EXAMPLE |
| 202 | 102 | 1.2 | 1.5 | EXAMPLE |
| 203 | 103 | 1.4 | 1.6 | EXAMPLE |
| 204 | 104 | 0.6 | 0.8 | EXAMPLE |
| 205 | 105 | 0.9 | 1.0 | EXAMPLE |
| 206 | 106 | 0.7 | 1.0 | EXAMPLE |
| 207 | 107 | 1.1 | 1.4 | EXAMPLE |
| 208 | 108 | 0.7 | 0.9 | EXAMPLE |
| 209 | 109 | 1.3 | 1.5 | EXAMPLE |
| 210 | 110 | 1.6 | 1.8 | EXAMPLE |
| 211 | 111 | 1.4 | 1.5 | EXAMPLE |
| 212 | 112 | 1.1 | 1.1 | EXAMPLE |
| 213 | 113 | 1.3 | 1.6 | EXAMPLE |
| 214 | 114 | 1.4 | 1.7 | EXAMPLE |
| 215 | 115 | 1.2 | 3.1 | COMPARATIVE EXAMPLE |
| 216 | 116 | 1.4 | 5.3 | COMPARATIVE EXAMPLE |
| 217 | 117 | 1.8 | 5.2 | COMPARATIVE EXAMPLE |
| 218 | 118 | 2.1 | 3.8 | COMPARATIVE EXAMPLE |
| 219 | 119 | 1.9 | 5.5 | COMPARATIVE EXAMPLE |
| 220 | 120 | 1.4 | 3.7 | COMPARATIVE EXAMPLE |
| 221 | 121 | 2.2 | 6.1 | COMPARATIVE EXAMPLE |
| 222 | 122 | 2.0 | 5.8 | COMPARATIVE EXAMPLE |

TABLE 4

| POLARIZING PLATE | RETARDATION FILM | AMOUNT OF | CHANGE IN AMOUNT | |
|---|---|---|---|---|
| ON BACKLIGHT | ON SIDE OF LIQUID | LEAKED | OF LEAKED | |
| SIDE No. | CRYSTAL CELL No. | LIGHT (%) | LIGHT (Δ%) | NOTES |
| 223 | 101 | 0.6 | 0.7 | EXAMPLE |
| 224 | 102 | 1.1 | 1.4 | EXAMPLE |
| 225 | 103 | 1.2 | 1.4 | EXAMPLE |
| 226 | 104 | 0.7 | 0.9 | EXAMPLE |
| 227 | 105 | 0.8 | 0.9 | EXAMPLE |
| 228 | 106 | 0.5 | 0.8 | EXAMPLE |
| 229 | 107 | 0.9 | 1.2 | EXAMPLE |
| 230 | 108 | 0.6 | 0.8 | EXAMPLE |
| 231 | 109 | 1.2 | 1.4 | EXAMPLE |
| 232 | 110 | 1.5 | 1.7 | EXAMPLE |
| 233 | 111 | 1.3 | 1.4 | EXAMPLE |
| 234 | 112 | 0.9 | 0.9 | EXAMPLE |
| 235 | 113 | 1.2 | 1.5 | EXAMPLE |
| 236 | 114 | 1.4 | 1.7 | EXAMPLE |
| 237 | 115 | 1.4 | 3.4 | COMPARATIVE EXAMPLE |
| 238 | 116 | 1.5 | 4.8 | COMPARATIVE EXAMPLE |
| 239 | 117 | 0.9 | 4.7 | COMPARATIVE EXAMPLE |
| 240 | 118 | 1.2 | 3.5 | COMPARATIVE EXAMPLE |
| 241 | 119 | 1.5 | 5.2 | COMPARATIVE EXAMPLE |
| 242 | 120 | 1.4 | 3.5 | COMPARATIVE EXAMPLE |
| 243 | 121 | 2.0 | 5.5 | COMPARATIVE EXAMPLE |
| 244 | 122 | 2.0 | 5.8 | COMPARATIVE EXAMPLE |

The results in Tables 3 and 4 evidently show that the polarizing plates according to one or more embodiments of the invention have a reduced amount of leaked light and high contrast.

### Example 3

### Preparation of Liquid Crystal Display 401

Polarizing plates were removed from the liquid crystal panel of a 40-inch display KDL-40V5 available from SONY Corporation. As a polarizing plate on the viewer side, Polarizing plate 201 prepared above was bonded onto a glass surface on the viewer side of the liquid crystal cell with the adhesive layer such that the hard coat layer faced the viewer side. Polarizing plate 223 was bonded onto a glass surface, adjacent to the backlight, of the liquid crystal cell with the adhesive to prepare Liquid crystal panel 301. Liquid crystal panel 301 was mounted on a liquid crystal television set to prepare Liquid crystal display 401.

### <Preparation of Liquid Crystal Displays 402 to 422>

Liquid crystal displays 402 to 422 were prepared as in Liquid crystal display 401 except that Polarizing plates 202 to 222 were used in place of Polarizing plate 201 on the viewer side and Polarizing plates 224 to 244 were used in place of Polarizing plate 223 adjacent to the backlight, as shown in Table 5.

### (Liquid Crystal Display)

### [Fluctuation in Hue]

Fluctuations in hue of Liquid crystal displays 401 to 422 prepared above were measured with an analyzer (EZ-Contrast 160D, available from ELDIM S.A.). Hues were measured in vertical directions (80° upward and 80° downward from the normal line of display) at intervals of 2° in accordance with the UCS coordinates in the CIE 1976 color space. Among ranges of fluctuation in hue determined from the following equation, the largest range of fluctuation in hue found in the measured angles was defined as a maximum fluctuation in hue. The results of evaluation based on the following criteria are shown as “Fluctuation in hue” in Table 5.

Range of fluctuation in hue=[(Δu*)²+(Δv*)²]^{1/2}

where Δu* is the difference between u*'s measured at two angles; Δv* is the difference between v*'s measured at two angles.

### [Front Contrast]

A group of liquid crystal displays was left at 23° C. and 55% RH, and another group of liquid crystal displays was left at 60° C. and 90% RH for 500 hours, and then was left at 23° C. and 55% RH. In these liquid crystal displays, the backlight was continuously driven for one week, and the front contrast was measured. The luminance of a screen with white display and the luminance of a screen with black display were measured from the normal direction of the liquid crystal display with an EZ-Contrast 160D available from ELDIM S.A., and the ratio was defined as the front contrast.

Front contrast=(luminance of screen with white display measured from normal direction of display)/(luminance of screen with black display measured from normal direction of display)

The results of evaluation are shown in Table 5.

TABLE 5

| LIQUID | POLARIZING | POLARIZING | FLUCTUATION IN HUE | | FRONT CONTRAST | | |
|---|---|---|---|---|---|---|---|
| CRYSTAL | PLATE ON | PLATE ON | | AFTER 500 | | AFTER 500 | |
| DISPLAY | VIEWER SIDE | BACKLIGHT | 23° C. | HOURS AT 60° C. | 23° C. | HOURS AT 60° C. | |
| No. | No. | SIDE No. | 55% | AND 90% | 55% | AND 90% | NOTES |
| 401 | 201 | 223 | 0.06 | 0.06 | 1170 | 1160 | *1 |
| 402 | 202 | 224 | 0.08 | 0.10 | 1150 | 1120 | *1 |
| 403 | 203 | 225 | 0.07 | 0.08 | 1120 | 1100 | *1 |
| 404 | 204 | 226 | 0.08 | 0.09 | 1180 | 1160 | *1 |
| 405 | 205 | 227 | 0.07 | 0.07 | 1130 | 1120 | *1 |
| 406 | 206 | 228 | 0.05 | 0.07 | 1170 | 1140 | *1 |
| 407 | 207 | 229 | 0.05 | 0.07 | 1140 | 1110 | *1 |
| 408 | 208 | 230 | 0.06 | 0.07 | 1120 | 1100 | *1 |
| 409 | 209 | 231 | 0.06 | 0.07 | 1110 | 1090 | *1 |
| 410 | 210 | 232 | 0.06 | 0.07 | 1150 | 1130 | *1 |
| 411 | 211 | 233 | 0.06 | 0.06 | 1150 | 1140 | *1 |
| 412 | 212 | 234 | 0.07 | 0.07 | 1150 | 1150 | *1 |
| 413 | 213 | 235 | 0.08 | 0.10 | 1150 | 1120 | *1 |
| 414 | 214 | 236 | 0.07 | 0.07 | 1110 | 1110 | *1 |
| 415 | 215 | 237 | 0.11 | 0.17 | 1080 | 940 | *2 |
| 416 | 216 | 238 | 0.09 | 0.16 | 1090 | 890 | *2 |
| 417 | 217 | 239 | 0.10 | 0.17 | 1100 | 870 | *2 |
| 418 | 218 | 240 | 0.11 | 0.18 | 1090 | 950 | *2 |
| 419 | 219 | 241 | 0.12 | 0.19 | 1140 | 830 | *2 |
| 420 | 220 | 242 | 0.13 | 0.18 | 1100 | 970 | *2 |
| 421 | 221 | 243 | 0.11 | 0.23 | 1100 | 880 | *2 |
| 422 | 222 | 244 | 0.11 | 0.22 | 1070 | 870 | *2 |

*1: EXAMPLE
*2: COMPARATIVE EXAMPLE

The results in Table 5 evidently show that the liquid crystal displays including the polarizing plate according to one or more embodiments of the present invention reduce the range of fluctuation in hue and do not impair the front contrast even in change of environment.

### INDUSTRIAL APPLICABILITY

The retardation film prepared by the method according to one or more embodiments of the invention has superior retardation characteristics and high moisture resistance, and can be suitably used in polarizing plates. The retardation film can also be used in liquid crystal displays having small color shift and high contrast.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A method of preparing a retardation film comprising cellulose acetate having an average degree of acetylation of 2.0 to 2.5 and having a moisture content of 1.0 mass % or less, wherein the retardation film further comprises a compound having a Van der Waals volume of 450 to 1000 Å3, and the retardation film is prepared through at least five steps:
first step: a dope preparing step of dissolving cellulose acetate having an average degree of acetylation within the range of 2.0 to 2.5 to prepare a dope and having a moisture content of 3.0% or more in an organic solvent containing 90 mass % or more halogen organic solvent;
second step: a film product forming step of casting the dope onto a metal belt to form a film product;
third step: a film product peeling step of peeling off the film product from the metal belt;
fourth step: a drawing step of drawing the peeled film product; and
fifth step: a drying step at a drying temperature of 140° C. or more.

2. The method of preparing a retardation film according to claim 1, wherein the retardation film has a ratio Rt(b)/Rt(a) within the range of 0.3 to 0.8, where Rt(a) is the absolute value of a difference between a retardation value Rt1 across a thickness of the film product after the film product is left at 23° C. and 55% RH for 24 hours after the fifth step ends and a retardation value Rt2 across the thickness of the film product after the film product is subsequently left at 60° C. and 90% RH for 500 hours, and Rt(b) is the absolute value of a difference between the retardation value Rt1 across the thickness of the film product after the film product is left at 23° C. and 55% RH for 24 hours after the fifth step ends and a retardation value Rt3 across the thickness of the film product after the film product is subsequently left at 23° C. and 55% RH for 500 hours.

3. The method of preparing a retardation film according to claim 1, wherein the retardation film contains 5 to 10 mass % compound having a Van der Waals volume of 450 to 1000 Å3 relative to the cellulose acetate.

4. The method of preparing a retardation film according to claim 1, wherein the compound having a Van der Waals volume of 450 to 1000 Å3 is at least one compound represented by Formulae (I) to (IV): 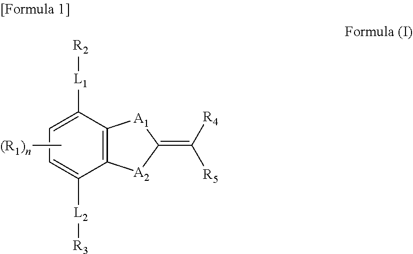
where L1 and L2 each represent a single bond or a divalent linking group; A1 and A2 represent a group each independently selected from —O—, —NR— (where R represents a hydrogen atom or a substituent), —S—, and —CO—; R1, R2, R3, R4, and R5 each represent a substituent; n represents an integer of 0 to 2; 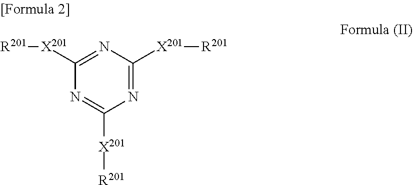
where three R201's each independently represent an aromatic ring or heterocycle having a substituent at at least one of ortho-, meta-, and para-positions; three X201's each independently represent a single bond or NR202-; three R202's each independently represent a hydrogen atom, a substituted or unsubstituted alkyl, alkenyl, aryl, or heterocyclic group; 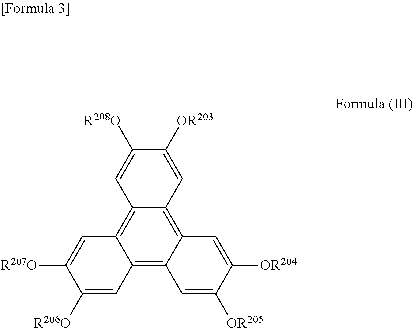
where R203 to R208 each independently represent a hydrogen atom or a substituent; and 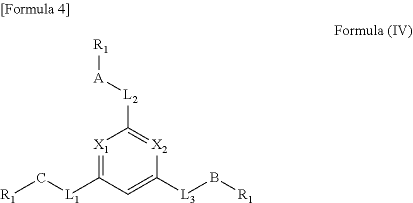
where A, B, and C represent an aromatic or heteroaromatic ring; L1, L2, and L3 represent a bond or a divalent linking group selected from an alkylene group, —COO—, —NR2-, —OCO—, —OCOO—, —O—, —S—, —NHCO—, and —CONH—; X1 and X2 represent a carbon atom or a nitrogen atom; R1 represents a substituent; R2 represents a hydrogen atom or a substituent.

5. The method of preparing a retardation film according to claim 1, wherein the retardation film is a long retardation film having a width of 700 to 3000 mm.

6. A polarizing plate comprising a retardation film prepared by the method according to claim 1.

7. A liquid crystal display comprising a retardation film prepared by the method according to claim 1.
